(19) United States
(12) Patent Application Publication
(10) Pub. No.: US 2024/0228324 A1
(43) Pub. Date: Jul. 11, 2024

(54) COMPOSITIONS AND METHODS FOR MAKING LITHIUM-TRANSITION METAL OXIDE COMPOUNDS INCLUDING NIOBIUM

(71) Applicant: The Research Foundation for the State University of New York, Albany, NY (US)

(72) Inventors: M. Whittingham, Vestal, NY (US); Fengxia Xin, Vestal, NY (US)

(21) Appl. No.: 18/030,868

(22) PCT Filed: Oct. 16, 2021
(86) PCT No.: PCT/US2021/055328

§ 371 Date: Apr. 7, 2023

Related U.S. Application Data
(60) Provisional application No. 63/092,755, filed on Oct. 16, 2020.

(51) Int. Cl. C01G 53/00; H01M 4/02; H01M 4/36; H01M 4/38; H01M 4/505; H01M 4/525

(52) U.S. Cl. CPC C01G 53/50; H01M 4/366; H01M 4/38; H01M 4/505; H01M 4/525; C01P 2002/72; C01P 2002/88; C01P 2004/03; C01P 2004/84; C01P 2006/40; H01M 2004/028

(57) ABSTRACT

The present disclosure relates to compositions and methods for making lithium-transition metal oxide compounds suitable for use in lithium-ion cathodes for batteries. Further, the present disclosure relates to lithium-ion battery cathodes and an efficient method of preparing the materials and tuning electrochemical characteristics thereof. For example, the present disclosure relates to a process for making lithium-transition metal oxide compounds, including: forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a modified lithium nickel manganese cobalt composition including niobium or a modified lithium nickel cobalt aluminum composition including niobium. In embodiments, the niobium compound is an oxide characterized as substantially lithium free, or a composition characterized as substantially lithium free.

### CROSS-REFERENCE TO RELATED APPLICATIONS

The present disclosure claims priority or the benefit under 35 U.S.C. § 119 of U.S. provisional application No. 63/092,755 filed 16 Oct. 2020, herein entirely incorporated by reference.

### GOVERNMENT INTERESTS

This invention was made with government support under grant no. DE-EE0007765 awarded by The U.S. Department of Energy. The government has certain rights in the invention.

### FIELD OF THE INVENTION

The present disclosure relates to compositions and methods for making lithium-transition metal oxide compounds including nickel, cobalt, manganese, and niobium or nickel, cobalt, aluminum, and niobium suitable for use in lithium-ion cathodes for batteries. Further, the present disclosure relates to lithium-ion battery cathodes and an efficient method of preparing the materials thereof and tuning the electrochemical characteristics thereof.

### BACKGROUND

The electric vehicle (EV) market is rapidly expanding and is regarded as an effective pathway to diminish air pollution from on-street vehicles and to strengthen energy security. However, compared with internal combustion engine (ICE) vehicles, the driving range and high price of EVs problematically limits mass deployment, and puts forward higher requirements for lithium-ion batteries (LIBs), the energy conversion and storage systems for EV propulsion. Since cathode material is a limiting factor of energy density and price in Li-ion batteries, developing alternative cathode materials with a higher lithium utilization/specific energy density at a lower price point are needed.

Layered metal oxides are important cathode materials in LIB's since lithium cobalt oxide (LiCoO₂) was initially reported. LiCoO₂ still dominates the market of portable communication electronics due to good cycle stability, rate capability, and tap density. However, the inventors have found that LiCoO₂ is not suitable for electric vehicles because of the relatively low capacity (135 mAh/g) and high price. Layered ternary cathode materials LiNiₓCo_{y}Mn_{z}O₂ (NMC) and LiNiₓCo_{y}Al_{z}O₂ (NCA) have been considered as a promising cathode material to replace LiCoO₂. The commercial NMC has developed from NMC111 (discharge capacity: 154 mAh/g at 0.1 C) to NMC442 to NMC622, and now NMC811 (discharge capacity: >185 mAh/g at 0.1 C).

Further, to address practical demands for high energy density EVs, high nickel (greater than or equal to 80%) cathodes have received people's attention. However, the inventors have found high nickel cathodes lack stability and problematically induce, among other things, lithium/nickel cation mixing, inter/intragranular cracks, phase transition, and accumulation of an insulating Ni—O impurity phase with oxygen loss, resulting in structural degradation and deterioration of the cycling and thermal stability. Further, interfacial and structural instability causes capacity and voltage fading, potentially blocking their commercialization. Thus, high nickel cathodes remain deficient for having problematically high surface reactivity and/or structural instability.

Prior art of interest includes U.S. Patent Publication No. 2021/0028448 entitled One-Pot Synthesis forLiNBO₃ Coated Spinel and U.S. Pat. No. 10,189,719 entitled Process for the manufacture of lithium metal oxide cathode materials (both of which are herein incorporated entirely by reference). However, the disclosures do not show cathodes formed in accordance with the present disclosure or use of lithium free niobium precursors of the present disclosure.

Nanopowders of layered lithium mixed metal oxides for battery applications are also known, see, e.g., U.S. Pat. No. 10,283,763 herein incorporated entirely by reference.

What are needed are methods of manufacturing lithium-ion cathodes and tuning electrochemical characteristics thereof. For example, there is a need for improved cathodes including high nickel embodiments with a high capacity, low surface reactivity, and structural stability.

### SUMMARY

It is an object of this disclosure to provide an improved method of preparing a cathode material and/or cathode for lithium-ion batteries.

It is an object of the present disclosure to provide an improved method for forming a niobium containing coating disposed upon a preselected cathode powder suitable for use in a lithium metal oxide cathode.

It is an object of the present disclosure to provide an improved method for forming lithium-ion batteries including a transition metal-based cathode such as NMC and NCA modified to include niobium.

A particular feature of the present disclosure is the ability to manufacture lithium-ion metal oxide cathodes formed of NMC and NCA modified to include niobium.

Another embodiment includes the incorporation of a stabilizing coating on the surface of the cathode material wherein the coating inhibits degradation.

The present disclosure relates to compositions and methods for making lithium-transition metal oxide compounds. In embodiments, the present disclosure relates to a process for making lithium-transition metal oxide compounds, including: forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a modified lithium nickel manganese cobalt composition including niobium or a modified lithium nickel cobalt aluminum composition including niobium.

In some embodiments, the present disclosure relates to a method of forming a lithium ion cathode, including forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; removing the solvent to form a modified lithium nickel manganese cobalt composition including niobium or a modified lithium nickel cobalt aluminum composition including niobium; and forming the modified lithium nickel manganese cobalt composition including niobium or a modified lithium nickel cobalt aluminum composition including niobium into a cathode.

In some embodiments, the present disclosure relates to a cathode, or battery including a cathode, wherein the cathode includes a modified lithium nickel manganese cobalt composition including niobium or a modified lithium nickel cobalt aluminum composition including niobium, wherein niobium is present in a molar ratio of 0.01% to 5.0%.

In embodiments, the present disclosure includes a method of forming a lithium-ion cathode material including: mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a coated composition including a niobium containing coating disposed upon the lithium nickel manganese cobalt composition or the lithium nickel cobalt aluminum composition. In embodiments, the niobium compound is characterized as substantially lithium free, lithium free, or devoid of lithium. In embodiments, the niobium containing coating is characterized as continuous and/or conformal.

In embodiments, the present disclosure includes a cathode including: a niobium modified lithium nickel manganese cobalt composition, or a niobium modified lithium nickel cobalt aluminum composition, wherein niobium is present in a molar ratio of 0.01% to 5.0%. In embodiments, the cathode is formed of lithium-ion cathode material formed by a process sequence including: mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a coated composition including a niobium containing coating disposed upon the lithium nickel manganese cobalt composition or the lithium nickel cobalt aluminum composition. In embodiments, the niobium compound is characterized as substantially lithium free or devoid of lithium.

In embodiments, the present disclosure includes an electrochemical cell, including: a cathode of the present disclosure, or a cathode formed of material of the present disclosure, or a cathode formed by a process of the present disclosure.

In embodiments, the present disclosure includes a method of altering a high-Ni NMC material and/or high-Ni NCA material, including: providing a high-Ni NMC substrate or high-Ni NCA substrate, wherein the high-Ni NMC substrate or high-Ni NCA substrate include one or more lithium residuals exposed on a top surface, and coating the top surface with niobium oxide in an amount sufficient to contact the niobium oxide and the one or more lithium residuals. In embodiments, coating further includes: mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a coated high-Ni NMC substrate or coated high-Ni NCA substrate.

In embodiments, the present disclosure includes a method of coating a parent high-Ni NMC material or parent high-Ni NCA material, including: contacting a parent high-Ni NMC material or parent high-Ni NCA material with niobium compound characterized as substantially free of lithium under conditions suitable for forming a coating atop the parent material. In embodiments, the methods further include sintering a coating atop the parent material to distribute niobium into the parent material to form an altered material, wherein the altered material has different structural/electrochemical properties than the parent material.

In embodiments the present disclosure includes a cathode including a niobium coated and/or substituted lithium nickel manganese cobalt composition or a niobium coated and/or substituted lithium nickel cobalt aluminum composition including niobium wherein niobium is present in a molar ratio of 0.01% to 5.0%.

In embodiments the present disclosure includes a cathode including a niobium coated and/or niobium substituted lithium nickel manganese cobalt composition or a niobium coated and/or niobium substituted lithium nickel cobalt aluminum composition, wherein niobium is present in a molar ratio of 0.01% to 5.0%.

The illustrative aspects of the present disclosure are designed to solve the problems herein described and/or other problems not discussed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and other features of this disclosure will be more readily understood from the following detailed description of the various aspects of the disclosure taken in conjunction with the accompanying drawings that depict various embodiments of the disclosure, in which:

FIG. 1 depicts a flow diagram illustrating a process for making lithium-transition metal oxide compounds according to some embodiments of the present disclosure.

FIGS. 2A, 2B, and 2C show a schematic diagram of a cathode, according to embodiments of the present disclosure.

FIG. 3A depicts XRD patterns of 0.7% Nb modified NMC 811 heated at different temperatures. Inset depicts impurity peak, ♥ is LiNbO₃ and [symbol] Li₃NbO₄. FIGS. 3B and 3C depict data in an enlarged view in 26 degree.

FIG. 4A depicts Synchrotron XRD patterns of 1.4% Nb modified NMC 811 heated in different temperature, [symbol] is LiNbO₃, ♥ is Li₃NbO₄. FIGS. 4B-4C depict data in an enlarged view in 26 degree. FIG. 4D depicts data in an enlarged view of XRD patterns 1.4% Nb modified NMC 811 and NMC 811 heated from 400 to 500° C. FIG. 4E depicts an enlarged view of XRD patterns 1.4% Nb modified NMC 811 and NMC 811 heated from 600 to 800° C.

FIG. 5A depicts XRD patterns of market NMC 811 heated in different temperature from 400 to 800° C., and FIG. 5B depicts enlarged synchrotron XRD patterns of market NMC 811 heated at different temperature from 400 to 800° C.

FIGS. 6A, 6B, and 6C depict increase lattice parameters in 1.4% Nb modified NMC 811 heated from 400 to 800° C. compared with pure NMC 811.

FIG. 7A depicts the high-resolution neutron diffraction pattern along with Rietveld refinement of 0.7% Nb modified NMC 811, and FIG. 7B depicts the magnified view of the region with dashed rectangle showing the evolution of the characteristic peaks of NMC 811 and the precipitate “Li₃NbO₄” upon different amounts of Nb modification sintered at 800° C.

FIG. 8A depicts the refined Nb occupancy fraction when Nb substitutes Mn, Ni or Co in NMC 811; and FIG. 8B depicts the Li—Ni exchanging between Li-site and TM-site are promoted by Nb modification with a nearly linear dependence while Nb substituting Mn at TM-site increases under a nonlinear trend.

FIGS. 9A-9H depict SEM images of (FIG. 9A) Nb modified NMC 811 sintered at 500° C., (FIG. 9B) Nb modified NMC 811 sintered at 700° C., inset shows the magnified second particle; HAADF STEM images of a cross-sectioned Nb modified NMC 811 sintered at (FIG. 9C) 500° C. and (d) 700° C. by FIB displaying the internal submorphology of the primary spherical particle; EDS mapping of Ni, Mn, Co, Nb of Nb modified NMC 811 sintered at (FIG. 9E) 500° C. and (FIG. 9F) 700° C.; HR-TEM and corresponding FFT images of Nb modified NMC 811 sintered at (FIG. 9G) 500° C. and (FIG. 9H) 700° C.

FIGS. 10A and 10B depict SEM images of pure NMC 811, and example of a powder, substrate, or parent material suitable for use in embodiments of the present disclosure.

FIGS. 11A and 11B depict XPS spectra of (FIG. 11A) Nb 3d and (FIG. 11B) O 1s for 0.7% Nb modified NMC 811.

FIGS. 12A and 12B depict XRD patterns of Nb compound and Li₂CO₃ mixed with a molar ratio 1:0.5 (a) and 1:1.5 (b) and sintered from 400 to 800° C. for 3 h in O₂.

FIGS. 13A and 13B depict (FIG. 13A) Nb K-edge XANES and (FIG. 13B) EXAFS of 0.7% Nb modified NMC.

FIGS. 14A and 14B depict (FIG. 14A) field cooled (solid symbols) and zero-field cooled (open symbols) of Nb—O modified 811 samples and pure NMC sintered at 400, 600 and 800° C. (FIG. 14B) Magnified view of zero-field cooled (ZFC) susceptibilities near the ordering transitions of Nb—O modified 811 samples. Inset shows ZFC of pure NMC sintered in 400° C., 600° C. and 800° C.

FIGS. 15A-15E depict electrochemical behavior of pure and Nb modified NMC 811 in voltage range 2.8-4.6V (FIG. 15A) 1st charge/discharge profiles; (FIG. 15B) rate behavior; and (FIG. 15C) cycling performance; and for 2.8-4.4 V cycling (FIG. 15D) capacity and (FIG. 15E) capacity retention. The first 3 cycles are at a C/10 rate.

FIGS. 16A-16C depict dQ/dV vs V curves of (FIG. 16A) NMC811, (FIG. 16B) Nb modified NMC 811 heated at 500° C. and (FIG. 16C) Nb modified NMC 811 heated at 700° C. for cycles 10, 25, 50, 100, 150, 200 and 250.

FIGS. 17A-17C depict (FIG. 17A) GITT curves in lower voltage range of discharge process; (FIG. 17B) calculated lithium-ion diffusion coefficients; (c) EIS of Nb modified NMC 811 at 500° C., 700° C. and pure NMC 811.

FIGS. 18A and 18B depict DSC profiles of NMC 811 and Nb modified NMC 811 heated at 500° C. and 700° C. charged at 4.4 V vs. Li+/Li.

FIG. 19 depicts a flow diagram illustrating a process for making a cathode, according to some embodiments of the present disclosure.

FIG. 20 depicts an electrochemical cell including a cathode of the present disclosure.

FIGS. 21A-21C depict real-time tracking of structural evolution in the Nb-coated NMC 811. FIG. 21 A depicts In situ synchrotron XRD patterns of 1.4% Nb-coated NMC 811 at different stages, being illustrated using different colors, namely, initial materials (Black line), during holding at destination temperatures 475° C. (Blue line (bottom)), 520° C. (Cyan line (second from bottom)), 560° C. (Olive line (third from bottom)), 600° C. (Green line (fourth from bottom), 645° C. (Orange line (fifth from bottom)), 690° C. (Yellow line (sixth from bottom)), 730° C. (Pink line (seventh from bottom)), 770° C. (LT Magenta line (eight from bottom)), 815° C. (Red line (top)) and final cooling down (Dark yellow line). Inset: heating profile. FIG. 21B depicts a zoom-in view of the diffraction patterns to show the formation of minor Nb-containing phases, as indicated by ♥ for LiNbO₃, [symbol] for Li₃NbO₄. FIG. 21C depicts quantitative analysis on the LiNbO₃ and Li₃NbO₄ as a function of time and temperature. Formation of LiAlO₂, arising from Li interaction with cell components at high temperatures (>730° C.), was also provided.

FIG. 22 depicts TGA-MS of 1.4% Nb-modified NMC 811. FIG. 22 depicts TGA-MS of 1.4% Nb modified NMC 811 with mass spectrum peaks corresponding to hydroxide (red (oval), 17 g mol⁻¹), water (green (moon), 18 g mol⁻¹), and carbon dioxide (blue (triangle), 44 g mol⁻¹).

FIGS. 23A-23C depict data for in situ synchrotron XRD of samples holding at destination temperatures 475° C. (17 min), 520° C. (58 min), 560° C. (120 min), 600° C. (172 min), 645° C. (224 min), 690° C. (275 min), 730° C. (327 min), 770° C. (379 min), 815° C. (430 min).

FIG. 24 depicts refinement details such as representative fitting results for some temperatures.

FIGS. 25A-25D depict structural change in the bulk of the layered phase, by enlarged view of the selected XRD diffraction peaks: (FIG. 25A) 003; (FIG. 25B) 101, 102, 006; (FIG. 25C) 104 peak; (FIG. 25D) 108, 110, 113. The XRD patterns of the initial and after heat treatment (labelled as “initial”, and “final”, respectively) were also provided for comparison.

FIGS. 26A-26F depict quantitative analysis of the kinetics of structural change in the Bulk. FIG. 26A depicts intensity ratio of the characteristic peaks, I(003)/I(104); FIGS. 26B-26D depict evolution of the lattice parameters a, c and their ratio c/a during holding (for ˜50 minutes) at destination temperatures (475, 520, 560, 600, 645, 690, 730, 770, 815° C.); FIG. 26E depicts Ni occupancy on Li site; FIG. 26F depicts particle size (P-size).

FIGS. 27A-27D depict strong temperature dependence of the thermo-driven structural change in the Bulk. (FIG. 27A) Fitting to the lattice parameters a, c obtained at 475° C. using y=Ax²+Bx+C. FIGS. 27C and 27D the fitted B, A values, from a (black), c (red), respectively.

FIG. 28 depicts the calculated Ni occupancy on Li sites in pure NMC 811 heated to 800° C. Ni occupancy in pure NMC 811 by refinement of the XRD patterns taken from ex situ experiments, at different temperatures, from room temperature up to 800° C.

FIG. 29 depicts process conditions, compositions and data relating embodiments of the present disclosure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

The present disclosure is based, at least in part, on the discovery that a lithium free niobium oxide treatment removes surface impurities forming a LiNbO₃/Li₃NbO₄ surface coating, reducing the 1^{st} capacity loss and improving the rate performance. Surprisingly, the inclusion of a niobium compound substantially free or devoid of lithium, such as one or more of niobium ethoxide, niobium pentoxide, niobium dioxide, niobium monoxide, niobium chloride, niobium fluoride, ammonium niobium oxalate hydrate, or niobium oxalate provides an improved surface coating providing one or more cathodes with significantly reduced first capacity loss and improved rate performance.

In embodiments, the present disclosure provides compositions and methods for making lithium-transition metal oxide compounds. For example, embodiments of the present disclosure generally provide compositions, and methods for making lithium-transition metal oxide compounds including nickel cobalt, manganese, and niobium or nickel, cobalt, aluminum, and niobium suitable for use in lithium-ion cathodes for batteries. Further, the present disclosure relates to lithium-ion battery cathode apparatuses and an efficient method of preparing the materials and tuning electrochemical characteristics thereof.

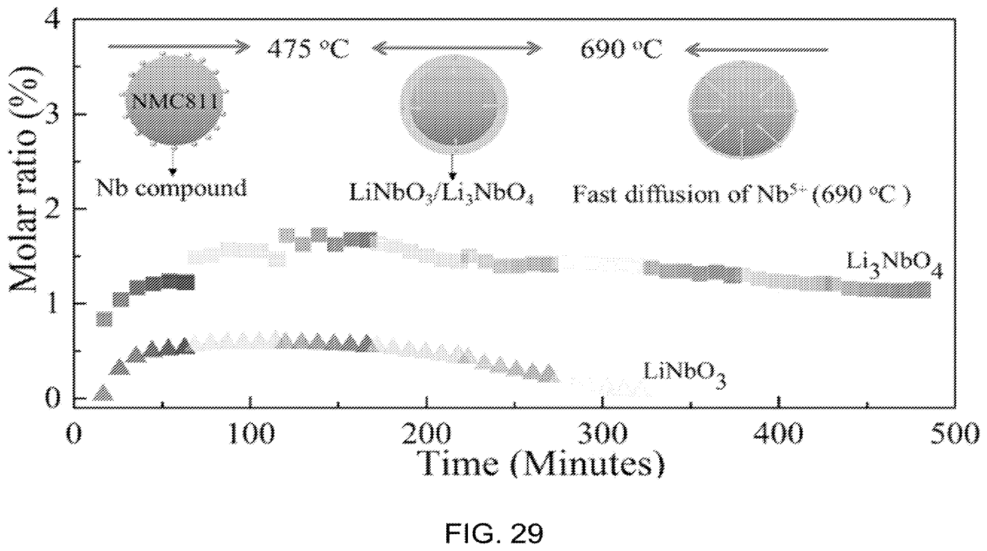

In embodiments, layered ternary cathode materials LiNiₓCo_{y}Mn_{z}O₂ (NMC) and LiNiₓCo_{y}Al_{z}O₂ (NCA), each having a high nickel content, i.e., greater than or equal to 80%, is coated and/or doped with niobium composition to make a modified material suitable for use in forming a stable high nickel cathode. In embodiments, the niobium composition is coated via wet chemistry using a niobium composition substantially free or devoid of lithium. In embodiments, LiNbO₃/Li₃NbO₄ is formed atop the substrate. Subsequent heating may reduce the amount of LiNbO₃, and/or drive Nb into the substrate materials depending upon process conditions and temperature. See e.g., FIG. 29 showing Nb compound atop the high nickel parent material or substrate, the LiNbO3/Li3NbO4 coating material disposed atop the substrate, and diffusion of Nb⁵⁺ at high temperature. Arrows show Nb⁵⁺ diffusion from the coating into the substrate material and towards a core of the substrate material. Still referring to FIG. 29, the LiNbO3/Li3NbO4 coating is shown in a cross-sectional view as a continuous coating extending entirely around the substrate particle. In embodiment, the LiNbO3/Li3NbO4 coating is characterized as conformal.

### Definitions

As used in the present specification, the following words and phrases are generally intended to have the meanings as set forth below, except to the extent that the context in which they are used indicates otherwise.

As used herein, the singular forms “a”, “an”, and “the” include plural references unless the context clearly dictates otherwise. Thus, for example, references to “a compound” include the use of one or more compound(s). “A step” of a method means at least one step, and it could be one, two, three, four, five or even more method steps.

As used herein the terms “about,” “approximately,” and the like, when used in connection with a numerical variable, generally refers to the value of the variable and to all values of the variable that are within the experimental error (e.g., within the 95% confidence interval [CI 95%] for the mean) or within ±10% of the indicated value, whichever is greater.

As used herein, the term “forming a mixture” or “forming a slurry” refers to the process of bringing into contact at least two distinct species such that they mix together and interact. “Forming a reaction mixture” and “contacting” refer to the process of bringing into contact at least two distinct species such that they mix together and can react, either modifying one of the initial reactants or forming a third, distinct, species, a product. It should be appreciated, however, the resulting reaction product can be produced directly from a reaction between the added reagents or from an intermediate from one or more of the added reagents which can be produced in the reaction mixture. “Conversion” and “converting” refer to a process including one or more steps wherein a species is transformed into a distinct product.

The term “substantially free,” as used herein, refers to a component of interest that may be substantially or essentially free of other components which normally accompany or interact with the component of interest. For example, a component of interest may be “substantially free” of lithium when the component of interest contains less than about 10%, less than about 5%, less than about 4%, less than about 3%, less than about 2%, or less than about 1% (by dry weight) of contaminating lithium component(s). Thus, a “substantially free” component of interest may have a purity level of about 90%, about 95%, about 96%, about 97%, about 98%, about 99% or greater.

Before embodiments are further described, it is to be understood that this disclosure is not limited to particular embodiments described, as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications mentioned herein are incorporated herein by reference to disclose and describe the methods and/or materials in connection with which the publications are cited.

### DETAILED DESCRIPTION OF CERTAIN EMBODIMENTS

In embodiments, the methods of the present disclosure include a process for making lithium-transition metal oxide compounds, including: forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a modified lithium nickel manganese cobalt composition including niobium or a modified lithium nickel cobalt aluminum composition including niobium. In embodiments, the electrochemical characteristics of the compositions and/or cathodes formed from compositions of the present disclosure can be altered or tuned. For example, depending upon pre-selected conditions, niobium may be deposited as a coating directly atop the materials of the present disclosure, or may penetrate the materials of the present disclosure by thermal processing to alter or tune the electrochemical characteristics thereof. By performing a thermal process after the coating process, the thermal energy provided from the thermal process may efficiently diffuse niobium (such as Nb⁵⁺) into the composition and/or crystal structure thereof. In some embodiments, by controlling the thermal process and amount of niobium in the coating and/or diffused into the cathode material, electrochemical characteristics of the cathode material may be altered, tuned, or preselected for use in a cathode. Thus, the compositions and methods of the present disclosure advantageously provide improved lithium-transition metal oxide compounds including: nickel cobalt, manganese, and niobium; or nickel, cobalt, aluminum, and niobium, both of which are suitable for use in lithium-ion cathodes for batteries which may include a surface coating. The surface coating may advantageously inhibit degradation caused by liquid-based electrolytes. In some embodiments, niobium penetration may further promote excellent storage capacity, battery life, recharge time, and storage stability.

In some embodiments, the present disclosure provides for enhanced electrochemical performance of Ni-rich material LiNi_{0.8}Co_{0.1}Mn_{0.1}O₂ (NMC811) modified by niobium (Nb). For example, in embodiments, a coating layer of LiNbO₃ and/or Li₃NbO₄ may be disposed atop a cathode composition, such as a cathode powder substrate) with optional Nb penetration of the cathode composition controlled by a thermal process such as sintering. In some embodiments, a coating layer of LiNbO₃ and/or Li₃NbO₄ with Nb penetration is created by annealing in low temperature (400° C., 500° C., or 400° C. to 500° C.). Subsequently, Nb substitution with Li₃NbO₄ layer may be formed by high temperature heating (600° C., 700° C. and 800° C., or 600° C. to 800° C.). In some embodiments, a first discharge capacity and rate performance may be significantly improved in Nb modified NMC 811 with lower sintering temperature. Nb substituted NMC 811 in high annealing temperature may also have a long cycling stability, providing 178.6 mAh/g (700° C.) vs 174.6 mAh/g (500° C.) and 162.9 mAh/g (Pure NMC 811) with capacity retention 93.2% (700° C.) vs. 88.2% (500° C.) and 83.4% (Pure NMC 811) after 250 cycles.

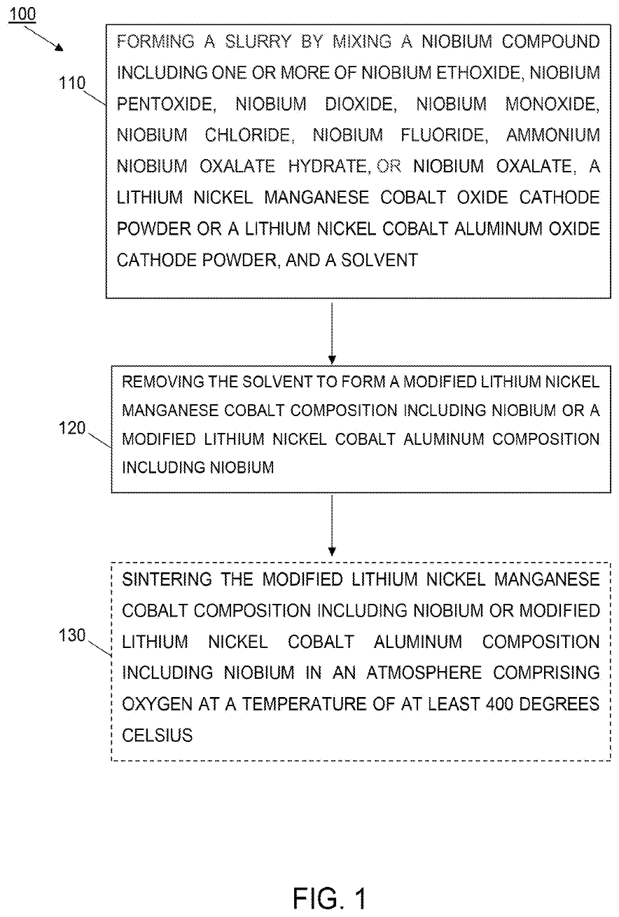

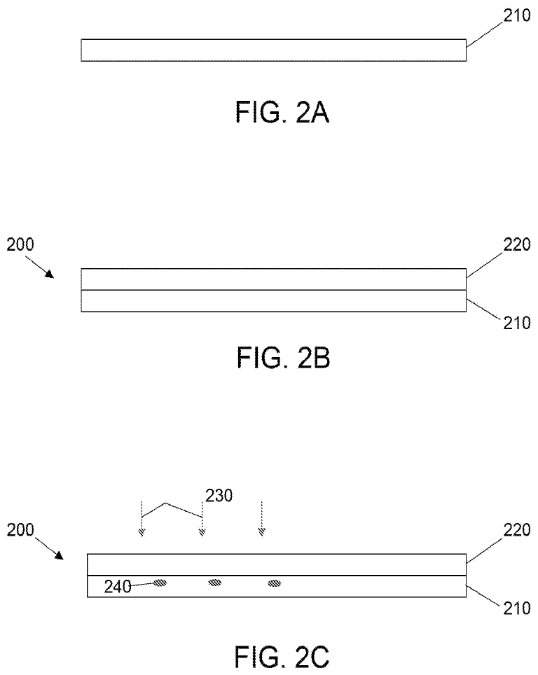

FIG. 1 depicts a flow diagram illustrating a process 100 for manufacturing materials suitable for cathode manufacturing, which corresponds to FIGS. 2A-2C illustrating schematic cross-sectional views of a cathode 200 at different stages of cathode fabrication. In some embodiments, process 100 is a process flow, and operations 110, 120, and optionally 110, 120 and 130 are individual processes. The process 100 is configured to be performed in a cathode manufacturing facility using equipment suitable for mixing a slurry of cathode powders and thermal processing.

In embodiments, the process 100 may begin at operation 110 by forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent. In embodiments, the niobium compound is provided in an amount sufficient to form the compositions of the present disclosure such as cathode 200. For example, in embodiments, niobium compound may be provided in an amount to provide compositions of the present disclosure with a molar ratio between 0.001% and 5% niobium. In some embodiments, the niobium compound may be one or more of niobium ethoxide, niobium pentoxide, niobium dioxide, niobium monoxide, niobium chloride, niobium fluoride, ammonium niobium oxalate hydrate, or niobium oxalate. In some embodiments, the niobium compound comprises or consist of niobium ethoxide.

In embodiments, the process 100 may begin at operation 110 by forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder, and a solvent. In embodiments, the niobium compound is selected from a group consisting of niobium ethoxide, niobium pentoxide, niobium dioxide, niobium monoxide, niobium chloride, niobium fluoride, ammonium niobium oxalate hydrate, niobium oxalate, and combinations thereof. In embodiments, the niobium compound is substantially free or devoid of lithium. In embodiments, the niobium compound is niobium ethoxide characterized as substantially free of lithium.

In embodiments, the process 100 may begin at operation 110 by forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel cobalt aluminum oxide cathode powder, and a solvent. In embodiments, the niobium compound is selected from a group consisting of niobium ethoxide, niobium pentoxide, niobium dioxide, niobium monoxide, niobium chloride, niobium fluoride, ammonium niobium oxalate hydrate, niobium oxalate, and combinations thereof. In embodiments, the niobium compound is substantially free or devoid of lithium. In embodiments, the niobium compound is niobium ethoxide characterized as substantially free of lithium.

In embodiments, a substrate 210 is provided in the form of lithium nickel manganese cobalt oxide cathode powder or a lithium nickel cobalt aluminum oxide cathode powder and in an amount sufficient to form compositions of the present disclosure such as cathode 200. In some embodiments, suitable lithium nickel manganese cobalt oxide cathode powder includes lithium nickel manganese cobalt oxide (NMC), a class of electrode material suitable for use in the fabrication of lithium-ion batteries. In some embodiments, suitable lithium nickel manganese cobalt oxide cathode powder includes a preselected amount of lithium nickel manganese and/or cobalt. In some embodiments, nickel is selected in an amount of greater than or equal to 80%, greater than or equal to 85%, greater than or equal to 90% of the total lithium nickel manganese cobalt oxide cathode powder. In embodiments, % refers to the weight percent of the total composition. In some embodiments, the lithium nickel manganese cobalt oxide cathode powder is characterized as LiNiₓCo_{y}Mn_{1-x-y}O₂, wherein x is 0.8-1, y is 0-0.2, and 1-x-y is 0-0.2, or in embodiments, LiNiₓCo_{y}Mn_{1-x-y}O₂ (x≥0.8). In some embodiments, suitable lithium nickel manganese cobalt oxide cathode powder includes a preselected amount of lithium nickel manganese cobalt. In embodiments, the nickel manganese cobalt oxide cathode powder has an average particle size of less than 0.05 micrometers throughout greater than 98% of the total powder. In some embodiments, the nickel manganese cobalt oxide cathode powder is provided in a form that does not include niobium (Nb), thus e.g., in embodiments, lithium containing niobium compounds are not a suitable starting substrate material for use in accordance with the present disclosure.

In some embodiments, suitable lithium nickel cobalt aluminum oxide cathode powder includes lithium nickel cobalt aluminum oxide (NCA), a class of electrode material suitable for use in the fabrication of lithium-ion batteries. In some embodiments, suitable lithium nickel cobalt aluminum oxide cathode powder includes a preselected amount of lithium, nickel, cobalt, and aluminum. In some embodiments, nickel is selected in an amount of greater than or equal to 80%, greater than or equal to 85%, greater than or equal to 90% of the lithium nickel cobalt aluminum oxide cathode powder. In embodiments, % refers to the weight percent of the total composition. In some embodiments, the lithium nickel cobalt aluminum oxide cathode powder is characterized as LiNi_{0.8}, Co_{0.15}Al_{0.05}O₂. In some embodiments, the lithium nickel cobalt aluminum oxide cathode powder is characterized as LiNiₓCo_{y}Al_{1-x-y}O₂, wherein x is 0.8-1, y is 0-0.2, and 1-x-y is 0-0.2. In embodiments, the lithium nickel cobalt aluminum oxide cathode powder has an average particle size of less than 0.05 micrometers throughout greater than 98% of the total powder. In some embodiments, the lithium nickel cobalt aluminum oxide cathode powder is initially provided in a form that does not include niobium (Nb), thus e.g., in embodiments, lithium containing niobium compounds are not a suitable starting substrate material for use in accordance with the present disclosure.

In some embodiments, solvent is provided in an amount sufficient to dissolve, solubilize, or slurry one or more niobium compounds and one or more cathode powders described above to form an admixture. Non-limiting examples of suitable solvents include one or more of methanol, ethanol, ethylene glycol, and/or tetraethylene glycol ethanol. In embodiments, ethanol is a suitable solvent.

Referring to FIG. 1, process 100 includes at process sequence 120 removing the solvent to form a modified lithium nickel manganese cobalt composition including niobium or a modified lithium nickel cobalt aluminum composition including niobium. In embodiments, removing the solvent may be performed by any method known in the art including heating the mixture under conditions sufficient to evaporate the solvent. For example, the mixture may be heated at or above the boiling point of the solvent disposed within a slurry. For example, where the solvent is ethanol, the mixture can be heated above 78.4 degrees Celsius for a duration and/or under conditions sufficient to evaporate the ethanol from the mixture or slurry. In some embodiments, removing the solvent may include evaporating the solvent at over 65 degrees Celsius for at least 5 hours. In some embodiments, removing the solvent includes evaporating one or more of methanol, ethanol, ethylene glycol, or tetraethylene glycol ethanol at over 65 degrees Celsius (such as at the boiling point of a particular solvent) for at least 5 hours. In embodiments, after evaporation, a coating layer 220 including Nb is formed and disposed atop substrate 210, as shown in FIG. 2B such as wherein the substrate is formed of a preselected cathode powder as described above.

In some embodiments, and depending upon needs, the solvent is removed under conditions which permit the formation of 1) a modified lithium nickel manganese cobalt composition including niobium; or 2) a modified lithium nickel cobalt aluminum composition including niobium. Non-limiting examples of suitable modified lithium nickel manganese cobalt composition including niobium includes niobium in a molar ratio of 0-5%, 0.01 to 5%, 0.01 to 3%, 0.01 to 2%, or 0.01 to 1%. In some embodiments, a modified lithium nickel manganese cobalt composition includes niobium in a molar ratio of 0.7% to 1.4%, or a molar ratio of 0.7% and 1.4%. In some embodiments, the modified lithium nickel manganese cobalt composition including niobium is characterized by a first formula LiNiₓCo_{y}Mn_{z}Nb_{w}O₂, wherein (x+y+z+w=1), and wherein x is 0.8-1, y is 0-0.2, z is −0.2, and w is 0-0.2, or a second formula Li_{w}Nb_{1-w}NiₓCo_{y}Mn_{1-x-y}O₂, wherein x is 0.8-1, y is 0-0.2, w is 0-0.2, and 1-x-y is 0-0.2.

Non-limiting examples of suitable modified lithium nickel cobalt aluminum composition includes niobium in a molar ratio of 0-5%, 0.01 to 5%, 0.01 to 3%, 0.01 to 2%, or 0.01 to 1%. In some embodiments, a modified lithium nickel cobalt aluminum composition includes niobium in a molar ratio of 0.7% to 1.4%, or a molar ratio of 0.7% and 1.4%. In embodiments, a modified composition includes a coated composition in accordance with the present disclosure.

Referring back to FIG. 1, process 100 at process sequence 130 optionally includes sintering the modified lithium nickel manganese cobalt composition including niobium or modified lithium nickel cobalt aluminum composition including niobium in an atmosphere including or consisting of oxygen at a temperature of at least 400 degrees Celsius. In embodiments, the modified lithium nickel manganese cobalt composition including niobium or modified lithium nickel cobalt aluminum composition including niobium is sintered until a powdered material form coalesces into a solid or porous mass by heating it. In embodiments, a thermal process or anneal is applied under conditions suitable to penetrate niobium into the lithium nickel manganese cobalt composition substrate or crystal structure thereof or into the modified lithium nickel cobalt aluminum composition substrate or crystal structure thereof. For example, referring to FIG. 2C, heat (shown as arrows 230) is applied in an amount and under conditions to drive niobium 240 (such as Nb⁵⁺) from coating layer 220 into the substrate 210. In some embodiments, sintering the modified lithium nickel manganese cobalt composition including niobium or modified lithium nickel cobalt aluminum composition including niobium in an atmosphere including oxygen or consisting of oxygen is performed at a temperature of at least 400 degrees Celsius, at least 500 degrees Celsius, at least 600 degrees Celsius, at least 700 degrees Celsius, at least 800 degrees Celsius, a temperature between 400 degrees Celsius and 800 degrees Celsius, a temperature between 400 degrees Celsius and 500 degrees Celsius, a temperature between 500 degrees Celsius and 600 degrees Celsius, a temperature between 600 degrees Celsius and 700 degrees Celsius, or a temperature between 700 degrees Celsius and 800 degrees Celsius. In some embodiments, the atmosphere including oxygen consists of oxygen. In some embodiments, sintering is for a duration between 2-5 hours, 3 hours, or about 3 hours. In some embodiments, sintering the modified lithium nickel manganese cobalt composition including niobium or modified lithium nickel cobalt aluminum composition including niobium further includes one or more of sintering modified lithium nickel manganese cobalt composition including niobium or a modified lithium nickel cobalt aluminum composition including niobium each comprising a molar ratio of 0.01-5% niobium.

In some embodiments, after coating, or sintering the modified lithium nickel manganese cobalt composition including niobium or modified lithium nickel cobalt aluminum composition including niobium each comprise niobium in a molar ratio of 0.01 to 5%, 0.01 to 3%, 0.01 to 2%, or 0.01 to 1%, 0.7% to 1.4%, 0.7%, or 1.4%. In some embodiments, the sintering is performed under conditions suitable to form a doped and/or a substituted modified lithium nickel manganese cobalt composition including niobium, or a doped and/or a substituted modified lithium nickel cobalt aluminum composition including niobium. In embodiments, a doping process introduces a dopant such as Nb or Nb⁵⁺ into the crystal lattice of a NMC or NCA materials of the present disclosure. In embodiments, a thermal process drives the dopant to a controlled depth in the underlying substrate such as NMC or NCA. In embodiments, the NMC and NCA are characterized as high nickel compositions, e.g., greater than or equal to 80% nickel.

As shown in FIG. 2B, the present disclosure includes a cathode 200 including: a modified lithium nickel manganese cobalt composition including niobium or a modified lithium nickel cobalt aluminum composition including niobium wherein niobium is present in a molar ratio of 0.7% to 1.4%. In embodiments, the composition includes coating layer 220 and substrate 210, wherein the coating layer is disposed directly atop the substrate 210. In embodiments, the present disclosure includes a composition including a niobium coating as shown in FIG. 2B, or niobium 240 disposed within the substrate as shown in FIG. 2C, or combinations thereof.

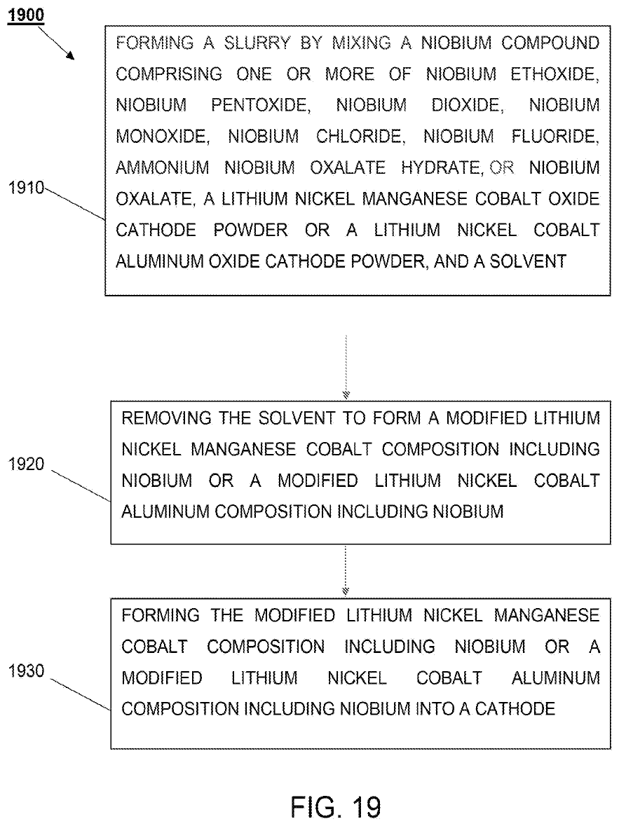

Referring now to FIG. 19, some embodiments of the present disclosure include method 1900 of forming a lithium-ion cathode. In some embodiments, the present disclosure includes one or more cathodes formed in accordance with the process sequences of the present disclosure. In embodiments, method 1900 includes at process sequence 1910 forming a slurry by mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent. In some embodiments, method 1900 at process sequence 1920 includes removing the solvent to form a modified lithium nickel manganese cobalt composition including niobium or a modified lithium nickel cobalt aluminum composition including niobium. In some embodiments, at process sequence 1930 the method includes forming the modified lithium nickel manganese cobalt composition including niobium or a modified lithium nickel cobalt aluminum composition including niobium into a cathode. In some embodiments, the method includes removing the solvent by evaporating the solvent at over 65 degrees Celsius for at least 5 hours. In some embodiments, the modified lithium nickel manganese cobalt composition including niobium or the modified lithium nickel cobalt aluminum composition including niobium comprises niobium in a preselected molar ratio. In some embodiments, the method may optionally include sintering the modified lithium nickel manganese cobalt composition including niobium or the modified lithium nickel cobalt aluminum composition including niobium in an atmosphere comprising oxygen at a preselected temperature suitable for forming a coating layer or changing a depth of niobium penetration. In some embodiments, sintering is for a duration between 2-5 hours, 3 hours, or about 3 hours. In some embodiments, sintering may be performed at a high temperature greater than 500 degrees Celsius under conditions sufficient to penetrate niobium substantially throughout the substrate material. In some embodiments, such as where niobium is coated atop the substrate, the coating process may be performed at a temperature of about 400 degrees Celsius to 500 degrees Celsius, which is a temperature sufficient to coat the substrate material or provide slight penetration such as to depth of 10 nanometers, 100, nanometers, 200 nanometers or between about 10 and 250 nanometers without substantially penetrating the entirety of the substrate material. In some embodiments, the cathode materials formed in accordance with the present disclosure are formed into a cathode and inserted into an electrochemical cell.

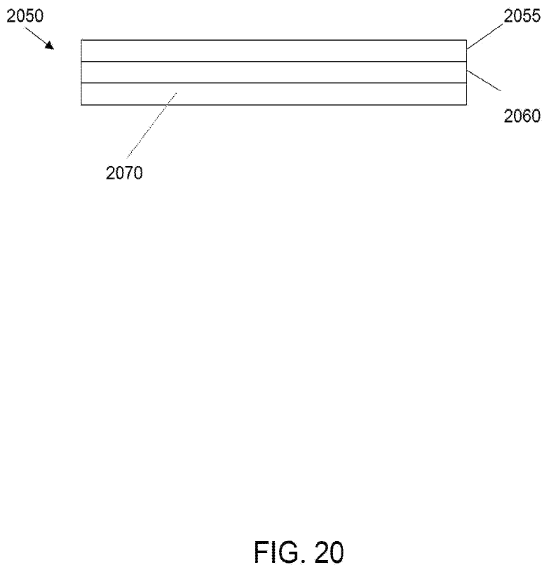

In some embodiments, the present disclosure relates to one or more lithium-ion batteries including one or more anode(s), one or more cathode(s), and electrolyte with a charge-discharge cycle. FIG. 20 depicts an embodiment of an electrochemical cell including a cathode of the present disclosure. In embodiments, the cathode is a cathode of the present disclosure disposed within or atop the one or more lithium-ion batteries. In some embodiments, an electrochemical cell 2050 includes one or more of cathode 2055, which may be any cathode in accordance with the present disclosure, made by a process in accordance with the present disclosure, or made of cathode materials such as powders of the present disclosure. For example, cathode 2055 may include a cathode including: a modified lithium nickel manganese cobalt composition including niobium or a modified lithium nickel cobalt aluminum composition including niobium wherein niobium is present in a molar ratio of 0.01% to 5.0%. In some embodiments, one or more anodes are provided such as anode 2070. In embodiments, an electrolyte or electrolyte layer 2060 may be disposed between the cathode 2055 and the anode 2070. In embodiments, an electrolyte or electrolyte layer 2060 may be in fluid communication or electrical communication with the anode 2070 and cathode 2055. In embodiments, electrochemical cell 2050 includes a cathode formed by the methods of the present disclosure or formed from materials that are formed from the methods of the present disclosure.

In embodiments, the present disclosure includes a method of forming a lithium-ion cathode material including: mixing a niobium compound including one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a coated composition including a niobium containing coating disposed upon the lithium nickel manganese cobalt composition or the lithium nickel cobalt aluminum composition. In embodiments, the niobium compound is characterized as lithium free. In embodiments, the niobium containing coating is characterized as continuous, thus continuous over and around a substrate upon which it is disposed. In embodiments, the niobium containing coating is characterized as conformal. In embodiments, the niobium containing coating has a thickness between 1 to 100 nanometers. In embodiments, the niobium containing coating comprises or consists of LINBO₃, Li₃NBO₄, or combinations thereof. In embodiments, the lithium nickel manganese cobalt oxide cathode powder is characterized as LiNi_{0.8}Co_{0.10}Mn_{0.10}O₂ (Ni:Mn:Co=8:1:1). In embodiments, the lithium nickel cobalt aluminum oxide cathode powder is characterized as LiNiₓCo_{y}Al_{1-x-y}O₂, wherein x is 0.8-1, y is 0-0.2, and 1-x-y is 0-0.2. In embodiments, the lithium nickel manganese cobalt oxide cathode powder is characterized as LiNi_{X}Co_{y}Mn_{1-x-y}O₂, wherein x is 0.8-1, y is 0-0.2, and 1-x-y is 0-0.2. In embodiments, the coated composition comprises 0.001-5 wt. % niobium. In embodiments, the methods of the present disclosure further include sintering the coated composition under conditions sufficient to drive a niobium disposed with the coating into the lithium nickel manganese cobalt composition or the lithium nickel cobalt aluminum composition to form a modified lithium nickel manganese cobalt composition or a modified lithium nickel cobalt aluminum composition. In embodiments, niobium characterized as Nb⁵⁺ is driven into the lithium nickel manganese cobalt composition or the lithium nickel cobalt aluminum composition a distance of 1 to 300 nanometers. In embodiments, the modified lithium nickel manganese cobalt composition or the modified lithium nickel cobalt aluminum composition comprise niobium in a molar ratio of 0.7% to 1.4%. In embodiments, the modified lithium nickel manganese cobalt composition or the modified lithium nickel cobalt aluminum composition comprise 0.001-5.0 wt. % niobium. In embodiments, the modified lithium nickel manganese cobalt composition is characterized by a first formula LiNiₓCo_{y}Mn_{z}Nb_{w}O₂, wherein (x+y+z+w=1), and wherein x is 0.8-1.0, y is 0-0.2, z is 0-0.2, and w is 0-0.2, or a second formula Li_{w}Nb_{1-w}NiₓCo_{y}Mn_{1-x-y}O₂, wherein x is 0.8-1, y is 0-0.2, w is 0-0.2, and 1-x-y is 0-0.2.

In embodiments, removing the solvent includes evaporating the solvent at over 65 degrees Celsius for at least 5 hours. In embodiments, the solvent is one or more of methanol, ethanol, ethylene glycol, or tetraethylene glycol ethanol.

In embodiments, the sintering is performed in an atmosphere comprising oxygen at a temperature of at least 400 degrees Celsius, at least 500 degrees Celsius, at least 600 degrees Celsius, at least 700 degrees Celsius, at least 800 degrees Celsius, a temperature between 400 degrees Celsius and 800 degrees Celsius, a temperature between 400 degrees Celsius and 500 degrees Celsius, a temperature between 500 degrees Celsius and 600 degrees Celsius, a temperature between 600 degrees Celsius and 700 degrees Celsius, or a temperature between 700 degrees Celsius and 800 degrees Celsius. In embodiments, the atmosphere including oxygen consists of oxygen. In embodiments, sintering is for a duration between 2-5 hours, 3 hours, or about 3 hours.

In embodiments, the present disclosure includes a cathode including: a niobium modified lithium nickel manganese cobalt composition or a niobium modified lithium nickel cobalt aluminum composition including niobium wherein niobium is present in a molar ratio of 0.01% to 5.0%. In embodiments, the cathode is formed by or formed of the methods and materials of the present disclosure. In embodiments, the cathode is formed of lithium-ion cathode material formed by a process sequence including: mixing a niobium compound comprising one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a coated composition comprising a niobium containing coating disposed upon the lithium nickel manganese cobalt composition or the lithium nickel cobalt aluminum composition. In embodiments, the niobium compound is characterized as substantially lithium free or devoid of lithium.

In embodiments, the present disclosure includes an electrochemical cell, including: a cathode as described herein, or a cathode formed of modified cathode powders having a high nickel content as described herein.

In embodiments, the present disclosure includes a method of altering a high-Ni NMC material and/or high-Ni NCA material, including: providing a high-Ni NMC substrate or high-Ni NCA substrate, wherein the high-Ni NMC substrate or high-Ni NCA substrate comprises one or more lithium residuals exposed on a top surface, and coating the top surface with niobium oxide in an amount sufficient to contact the niobium oxide and the one or more lithium residuals. In embodiments, coating further includes: mixing a niobium compound comprising one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and removing the solvent to form a coated high-Ni NMC substrate or coated high-Ni NCA substrate. In embodiments, the niobium compound is characterized as substantially free of lithium. In embodiments, the high-Ni NMC material and/or high-Ni NCA materials each have nickel in the amount of 80% or more, such as 85%, 90%, 95%, 99%, or between 80% and 85%, between 80% and 90%, between 85% and 90%, or between 80% and 99%.

In embodiments, the methods further include sintering at a low temperature for a duration sufficient to form LiₓNbO_{y} phases at the top surface. Referring to FIG. 29, sintering at a low temperature forms LiNbO₃/Li₃NBO₄ atop the substrate or parent material. In embodiments, the low temperature is 300 to 600 degrees Celsius. In embodiments, the high-NMC material is a cathode, and wherein LiₓNbO_{y} phases at the top surface reduces 1^{st}-cycle capacity loss. In embodiments, methods further include sintering at a high temperature for a duration sufficient to penetrate an Nb⁵⁺ species into the substrate to provide improved cycling performance. In embodiments, the high temperature is 600 to 750 degrees Celsius. In embodiments, the high-Ni NMC is an NMC material having 80% or more nickel such as LiNi_{0.8}Co_{0.1}Mn_{0.1}O₂; 811. In embodiments, the high-Ni NMC is LiNi_{1-y-z}Mn_{y}Co_{z}O₂, wherein y+z is less than or equal to 0.2. In embodiments, the high-Ni NCA material is LiNi_{1-y-z}Co_{y}Al_{z}O₂, wherein y+z is less than or equal to 0.2. In embodiments, FIG. 29 shows suitable temperatures and ranges suitable for use in the process sequences of the present disclosure.

In embodiments, the present disclosure includes a method of coating a parent high-Ni NMC material or parent high-Ni NCA material, including: contacting a parent high-Ni NMC material or parent high-Ni NCA material with niobium compound characterized as substantially free of lithium under conditions suitable for forming a coating atop the parent material. In embodiments, the methods further include sintering the coating atop the parent material to distribute niobium into the parent material to form an altered material, wherein herein the altered material has different structural/electrochemical properties than the parent material. In embodiments, FIG. 29 shows suitable temperatures, temperature ranges, and process conditions suitable for use in the process sequences of the present disclosure.

### EXAMPLES

### Experimental Section

Preparation of Nb coated and doped/substituted NMC 811. LiNi_{0.8}Co_{0.1}Mn_{0.1}O₂ materials were obtained from Ecopro Company. Niobium ethoxide (Sigma Aldrich) was used as precursor. Ecopro NMC 811 powders were mixed with niobium ethoxide in a flask and ethanol was added to the mixture. They were stirred overnight, then ethanol was evaporated at 80° C. Pristine NMC 811, 0.7% and 1.4%, 2.1% and 3.5% Nb (molar ratio) modified NMC 811 were sintered in pure oxygen atmosphere for 3 h from 400 to 800° C. and cooled down with a cooling rate of 5.0° C./min. Here, 0.7% Nb modified NMC 811 heated from 400 to 800° C. as NMC811-0.7Nb-400° C., NMC811-0.7Nb-500° C., NMC811-0.7Nb-600° C., NMC811-0.7Nb-700° C. and NMC811-0.7Nb-800° C. However, the high temperature treatment samples are no longer NMC 811 due to Nb modification.

### Structural Characterization.

X-ray powder diffraction (XRD) patterns of 0.7% Nb modified NMC 811 samples heated in different temperature was scanned with a BRUKER diffractometer (D8 Advance) equipped with Cu K_{α} source (λ=1.54178 Å) with spinning. The synchrotron XRD pattern of pristine NMC 811 and 1.4% Nb modified NMC 811 were performed at sector 28-ID-2 of National Synchrotron Light Source II (NSLS-II) at Brookhaven National Laboratory. The wavelength of the X-ray was 0.18266 Å. The neutron diffraction (ND) patterns of the pure NMC 811 and the Nb modified NMC 811 samples were measured at the VULCAN instrument (See e.g., An, K.; Skorpenske, H. D.; Stoica, A. D.; Ma, D.; Wang, X.-L.; Cakmak, E. First in situ Lattice Strains Measurements under Load at VULCAN. Metall. Mater. Trans. 2011, 42, 95-99), at the Spallation Neutron Source, Oak Ridge National Laboratory. The neutron data were processed using VDRIVE software (See e.g., An, K. VDRIVE-Data reduction and Interactive Visualization Software for Event Mode Neutron Diffraction. ORNL Report No. ORNL-TM-2012-621 2012), and Rietveld refinement was carried out using GSAS software and EXPGUI interface (See e.g., Larson, A.; Von Dreele, R. General Structure Analysis System (GSAS) (Report LAUR 86-748). Report LAUR 86-748 2004, and Toby, B. H. EXPGUI, a Graphical User Interface for GSAS. J. Appl. Crystallogr. 2001, 34, 210-213) to calculate the phase fractions, lattice parameters and site occupancy fractions. X-ray Photoemission Spectroscopy (XPS) was performed using a Phi VersaProbe 5000 system with a monochromated Al K_{α} source and hemispherical analyzer at the Analytical and Diagnostics Laboratory (ADL) at Binghamton University. All samples were mixed with graphite to be used as reference. The core-levels (O 1s, Ni 2p, Nb 3d) were measured with a pass energy of 23.5 eV, corresponding to an instrumental resolution of 0.5 eV from analyzing both the Au 4f7/2 and Fermi edge of the Au foil. A flood gun was used to neutralize any charge build up during measurements. Samples for X-ray absorption near edge structure (XANES) and Extended X-ray absorption fine structure (EXAFS) were prepared by mixing ˜10 mg of materials with graphite and pressed in the form of pellets. Nb K-edge XANES and EXAFS for 0.7% Nb modified NMC 811 samples heated from 400 to 800° C. were tested using a fluorescence detector and calibrated using Nb reference foil in beamline 20 BM in Advanced Photon Source, Argonne National Lab. The samples morphology was determined using a Zeiss SUPRA 55 VP field emission scanning electron microscopy (SEM) at an operating voltage of 5 kV. High-angle annular dark-field (HAADF) scanning transition electron microscopy (STEM), energy-dispersive X-ray spectroscopy (EDS), High resolution transition electron microscopy (HR-TEM) images were collected using a FEI Talos F200X (200 keV) at the Center for Functional Nanomaterials in Brookhaven National Lab. The magnetic properties were tested by a Quantum Design SQUID magnetometer (MPMS XL-5). Field-cooled (FC) and zero-field-cooled (ZFC) magnetizations were measured from 298 to 2 K in magnetic fields of 10 Oe. The thermal stability tests were performed via differential scanning calorimetry (DSC) (Q200, TA) at the scan rate of 2.5° C./min. The test cathodes were charged to 4.4V versus lithium in 2032-type coin cells and disassembled in the glovebox. After washing with Dimethyl carbonate (DMC) to remove the residues, the electrode was cut into a small piece of 5 mg and sealed in a gold-capped stainless-steel crucible with 3 μL electrolyte (1 M LiPF₆ in EC/DMC) to do the DSC test.

### Electrochemical Measurement.

Nb modified NMC 811, heated from 400 to 800° C. and pristine NMC 811 samples were mixed with acetylene black and polyvinylidene fluoride (PVDF) powders with a weight ratio of 90:5:5 in 1-methyl-2-pyrrolidinone (NMP) solvent to form a slurry. Then the slurry was cast onto an aluminum (Al) foil using doctor blade and dried in vacuum oven at 80° C. for overnight. The average mass loading of the electrode was 13-15 mg/cm² and was calendared to 3.0 g/cm³. All of this was done in our dry room (Temperature: 20-21° C.; Dew point: <−50). For the coin cells, Li foil was used as a counter/reference electrode, a Celgard 3501 membrane as a separator and 1.0 M LiPF₆ dissolved in ethylene carbonate/dimethyl carbonate (EC/DMC, 1:1 in volume) as the electrolyte solution. For the first cycle test of the electrode, a current density of C/10 (1 C=200 mAh/g) was used between 2.8 and 4.6 V. Different rate performance (C/10, C/5, C/2, C, and 2C) was also tested. The cycling was set in the current density of C/3 charge and C/3 discharge. For long cycling, we set 2.8 to 4.4 V for the first two cycles in the current density of C/10, then C/10 charge, hold at 4.4 V for 1 h or the current drop down to C/60 and C/3 discharge for the following cycles. These data were obtained on a multichannel Biologic system.

### Magnetic Susceptibility Study

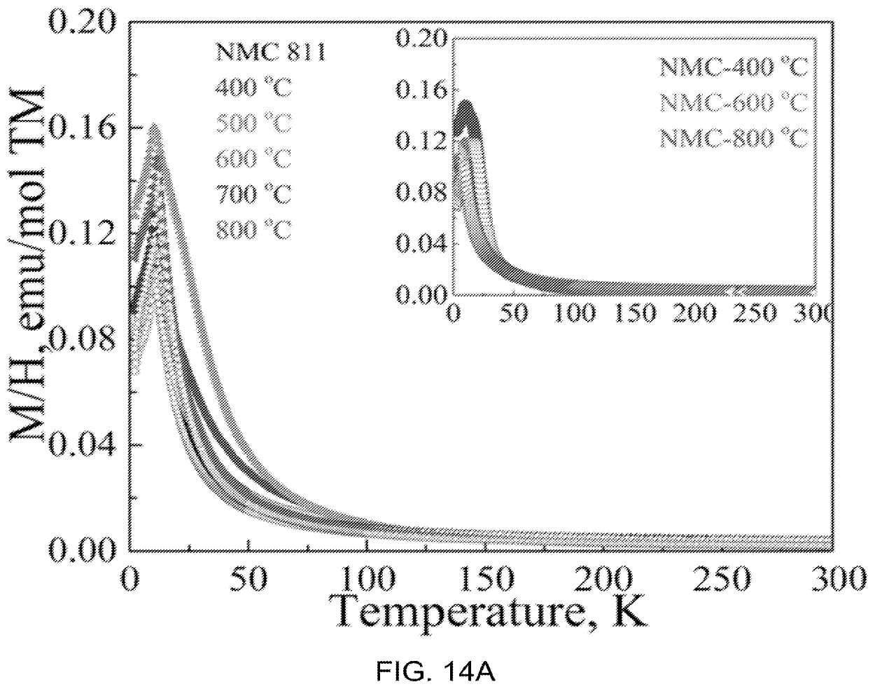

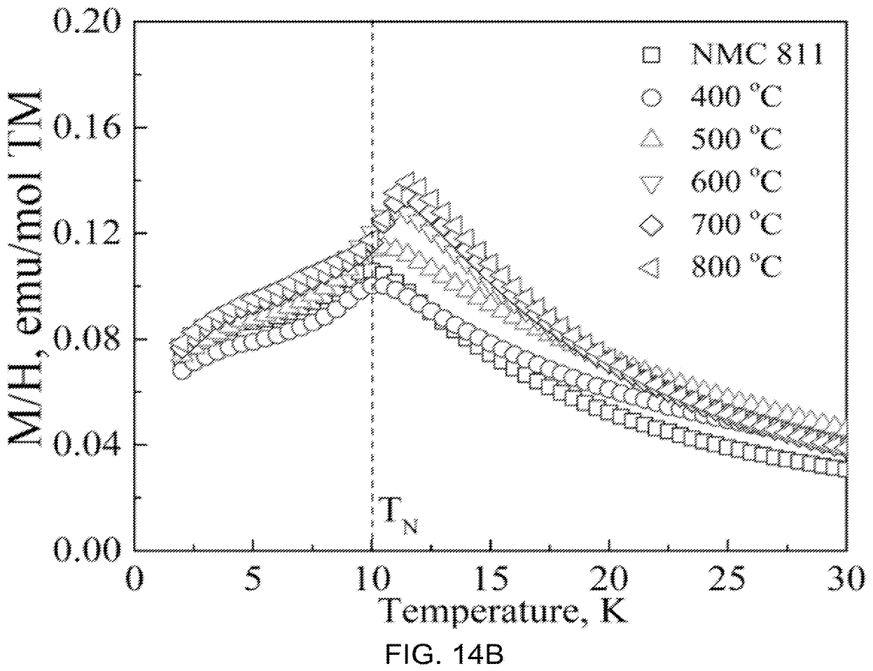

Valence information for pristine NMC 811 and Nb modified NMC 811 samples was investigated by magnetic susceptibility tests. FIG. 14A depicts field-cooled (FC) and zero-field-cooled (ZFC) susceptibilities of 0.7% Nb modified samples treated at various temperatures from 400 to 800° C. in comparison with that of NMC 811 sample. In NMC 811, the temperature dependence of the magnetic susceptibility follows the Curie-Weiss law at high temperatures, where FC and ZFC curves closely match each other. The Curie-Weiss law fitting parameters presented in Table 1, show excellent match between the experimental effective moment, and that calculated assuming 0.1 Co³⁺ (S=0), 0.1 Mn⁴⁺ (S=3/2), 0.1 Ni²⁺ (S=1), and 0.7 Ni³⁺ (S=½).

TABLE 1
Magnetic parameters of Nb modified NMC 811
and pure NMC 811 in different temperature.

| | | | | | | μₜₕₑₒᵣ |
|---|---|---|---|---|---|---|
| | C_{M}, emu | | χ₀, 10⁻⁴ | | | Ni2+ |
| | K/mol | | emu/mol | | μₑₓₚ, | Mn4+, |
| Sample | TM | Θ, K | TM | T_{f}, K | μ_{B} | μ_{B} |
| NMC 811 | 0.565(1) | 10.8(1) | 1.1 | 10.0 | 2.13 | 2.10 |
| 0.7% Nb-400° | 0.459 | 31.3 | −1.5 | 10.0 | 1.92 | 2.10 |
| C. | | | | | | |
| 0.7% Nb-500° | 0.532 | 17.6 | 1.7 | 10.5 | 2.06 | 2.10 |
| C. | | | | | | |
| 0.7% Nb-600° | 0.577 | 13.3(1) | 6.7 | 11.0 | 2.15 | 2.10 |
| C. | | | | | | |
| 0.7% Nb-700° | 0.518 | 17.4(1) | 13.1 | 11.5 | 2.04 | 2.10 |
| C. | | | | | | |
| 0.7% Nb-800° | 0.532 | 18.2(1) | 1.8 | 11.5 | 2.06 | 2.10 |
| C. | | | | | | |
| NMC-400° C. | 0.566 | 9.2 | 1.5 | 10.0 | 2.13 | 2.10 |
| NMC-600° C. | 0.563 | 7.1 | 0.9 | 9.5 | 2.12 | 2.10 |
| NMC-800° C. | 0.588 | 3.6 | 0.07 | 9.5 | 2.17 | 2.10 |

At 10.0 K a magnetic transition is observed, below which FC and ZFC curves depart in NMC 811 samples. For Nb modified NMC 811 samples, the transition temperature does not change in samples heated at 400 and 500° C., while in the samples heated at higher temperatures (600° C., 700° C. and 800° C.), the magnetic transition shifts to 11.5 K (See e.g., FIG. 14B). The increase in the transition temperature at higher treatment temperatures further confirms lattice modification by Nb substitution, which should lead to the change in the transition metal oxidation states. However, the experimental effective magnetic moment shows no or little change in higher-temperature Nb-treated NMC 811, which may be explained by the low Nb substitution level (0.7%).

### Thermal Stability Study

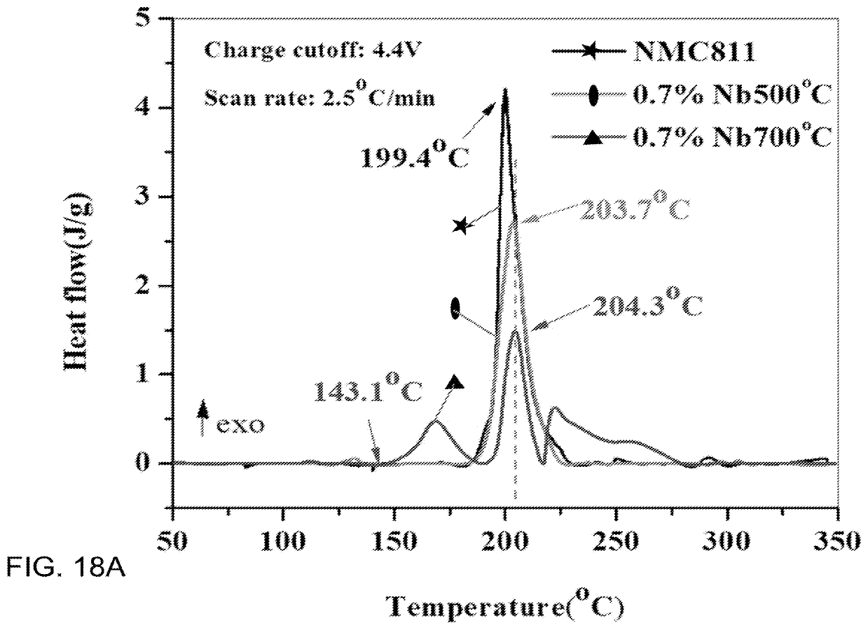

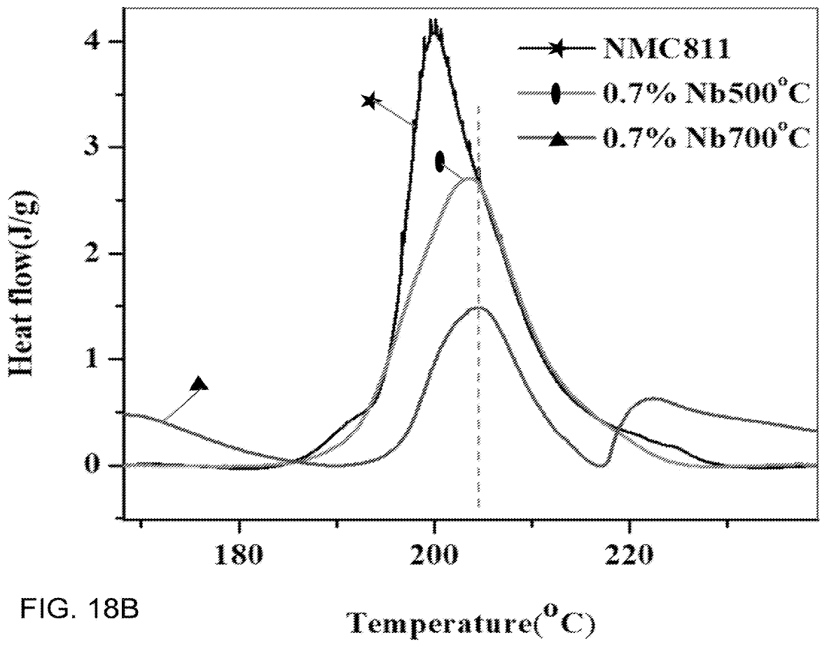

FIGS. 18A and 18B depicts large exothermic peaks shifts from 199.4° C. (NMC 811) to 203.7° C. (Nb modified NMC 811 heated at 500° C.) and 204.3° C. (Nb modified NMC 811 heated at 700° C.) although an additional peak starts from 143.1° C. for the 700° C. sample. The heat release amounts are 203.9 J/g (NMC 811) vs. 174.6 J/g (Nb modified NMC 811 heated at 500° C.) vs. 161.72 J/g (three peaks: 28.60+58.89+78.23 J/g in 700° C. sample).

Nickel-rich layered metal oxide LiNi_{1-y-z}Co_{y}Mn_{z}O₂ (1-y-z≥0.8) materials are the most promising cathodes for next generation lithium-ion batteries in electric vehicles. However, they lose more than 10% of their capacity on the 1^{st} cycle and interfacial/structural instability causes capacity fading. Coating and substitution are direct and effective solutions to solve these challenges. As described herein, Nb coating and Nb substitution on LiNi_{0.8}Co_{0.1}Mn_{0.1}O₂ (NMC811) is easily produced through a scalable wet chemistry method followed by sintering from 400 to 800° C. A Li-free Nb oxide treatment is found to remove surface impurities forming a LiNbO₃/Li₃NbO₄ surface coating, reducing the 1^{st} capacity loss and improving the rate performance. Nb substitution stabilizes the structure, providing excellent long cycling stability with a 93.2% capacity retention after 250 cycles.

The layered mixed metal oxides, such as LiNi_{0.8}Mn_{0.1}Co_{0.1}O₂, are the dominant cathodes used in Li-ion batteries for electric vehicles and grid storage. However, they lose 10-18% of their capacity on the first charge/discharge cycle, as described in thisjournal. (See e.g., Zhou, H.; Xin, F.; Pei, B.; Whittingham, M. S. What limits the capacity of layered oxide cathodes in lithium batteries? ACS Energy Letters 2019, 4, 1902). If the ultimate capacity of these materials is to be realized, then this capacity must be retained. This lost capacity is at potentials below 4 volts well within the stability limit of the electrolyte unlike that at very low lithium contents attainable only above 4.4 V. In addition, these very high Ni content materials are very sensitive to the environment (See e.g., Faenza, N. V.; Bruce, L.; Lebens-Higgins, Z. W.; Plitz, I.; Pereira, N.; Piper, L. F.; Amatucci, G. G. Growth of Ambient Induced Surface Impurity Species on Layered Positive Electrode Materials and Impact on Electrochemical Performance. J. Electrochem. Soc. 2017, 164 (14), A3727), which is detrimental to their electrochemical behavior (See e.g., Pereira, N.; Matthias, C.; Bell, K.; Badway, F.; Plitz, I.; Al-Sharab, J.; Cosandey, F.; Shah, P.; Isaacs, N.; Amatucci, G. Stoichiometric, Morphological, and Electrochemical Impact of the Phase Stability of LiₓCoO₂. J. Electrochem. Soc. 2004, 152 (1), A114), so they need protection from moisture and CO₂ prior to cell fabrication. Raising the temperature to 45° C. essentially eliminated the first cycle loss (See e.g., Zhou, H.; Xin, F.; Pei, B.; Whittingham, M. S. What limits the capacity of layered oxide cathodes in lithium batteries? ACS Energy Letters 2019, 4, 1902), so it should be possible to mimic this small energy kT by modifying the NMC lattice through surface or lattice modification. Here, the use of a lithium-free NbO_{y} treatment that both reduces the 1^{st} cycle loss and stabilizes the surface is reported. Depending on the temperature of treatment, the Nb is retained in the surface region or diffuses into the bulk of the structure. The latter stabilizes the lattice resulting in improved capacity retention on extended cycling.

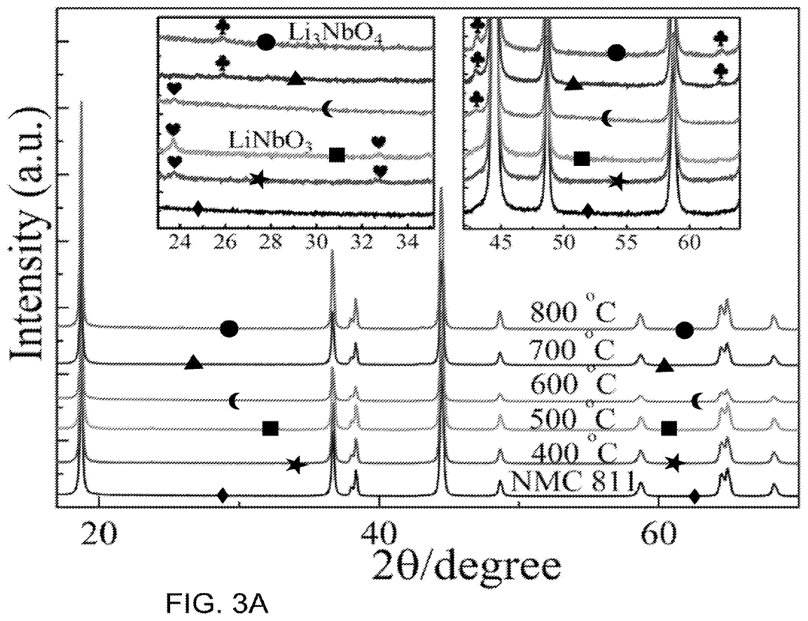

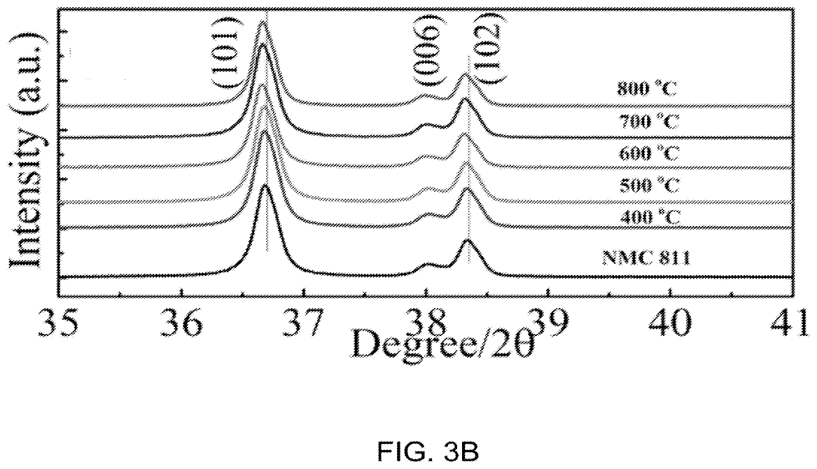

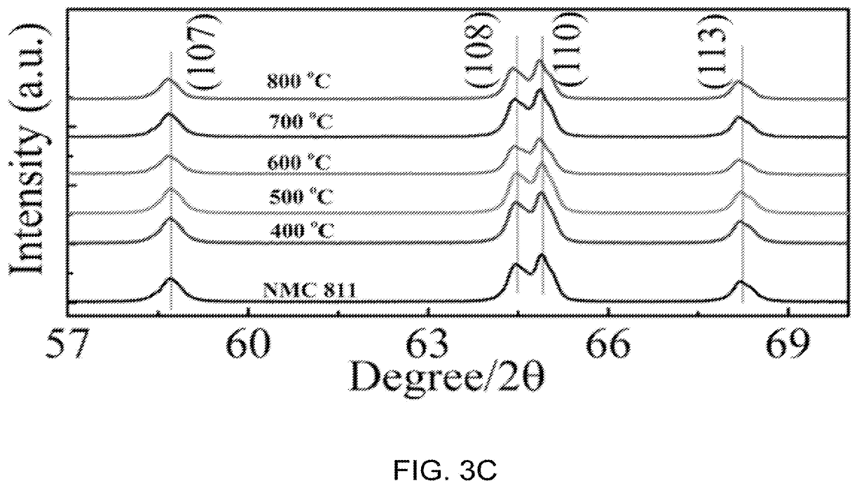

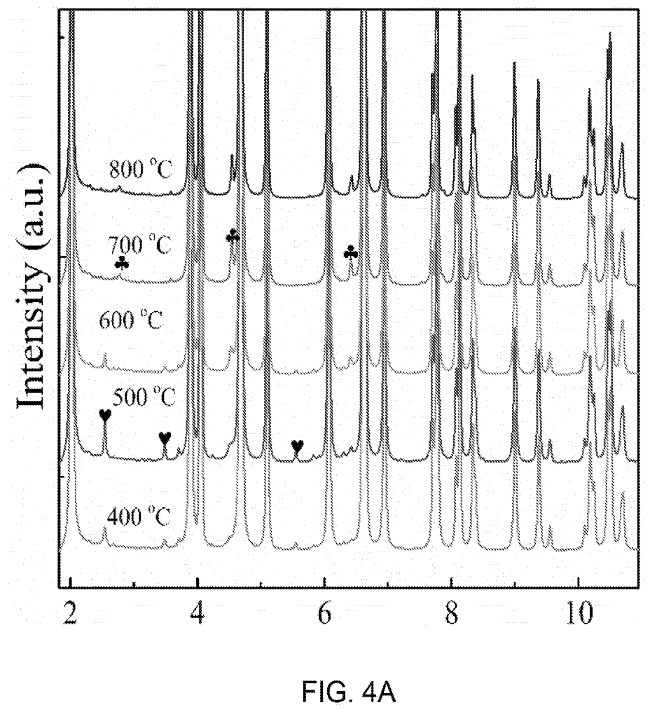

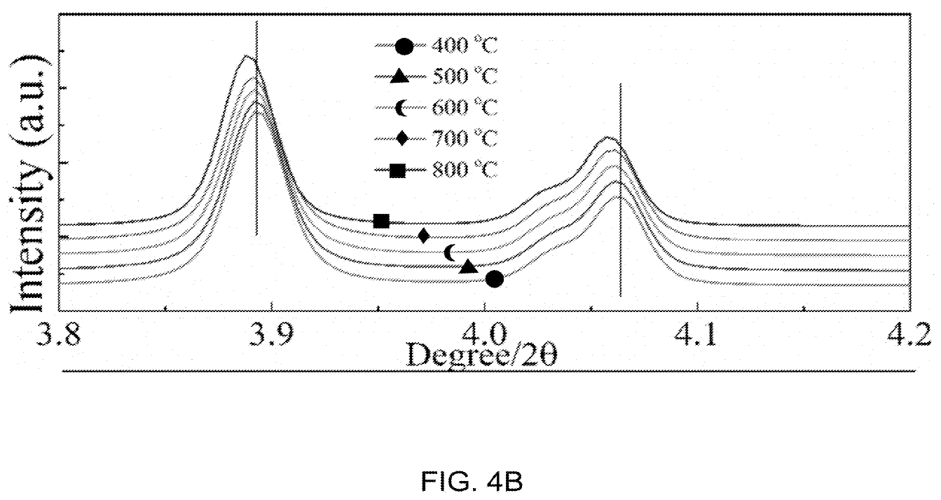

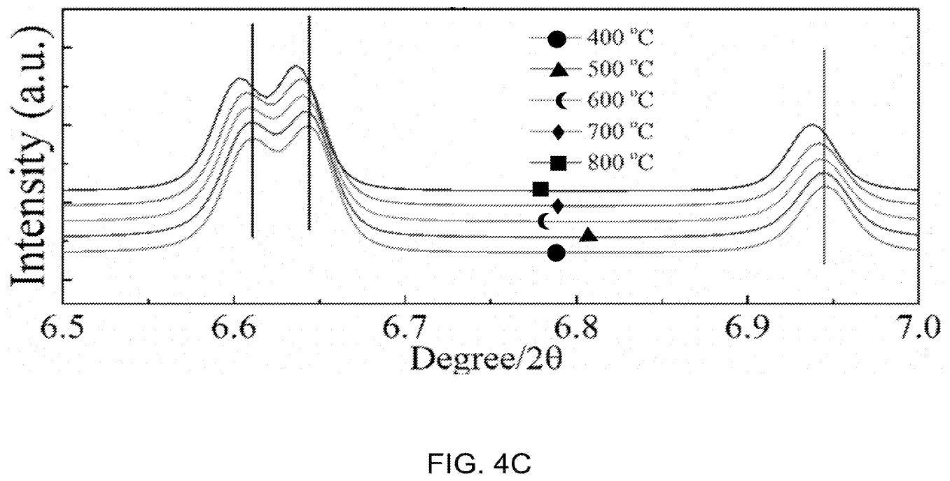

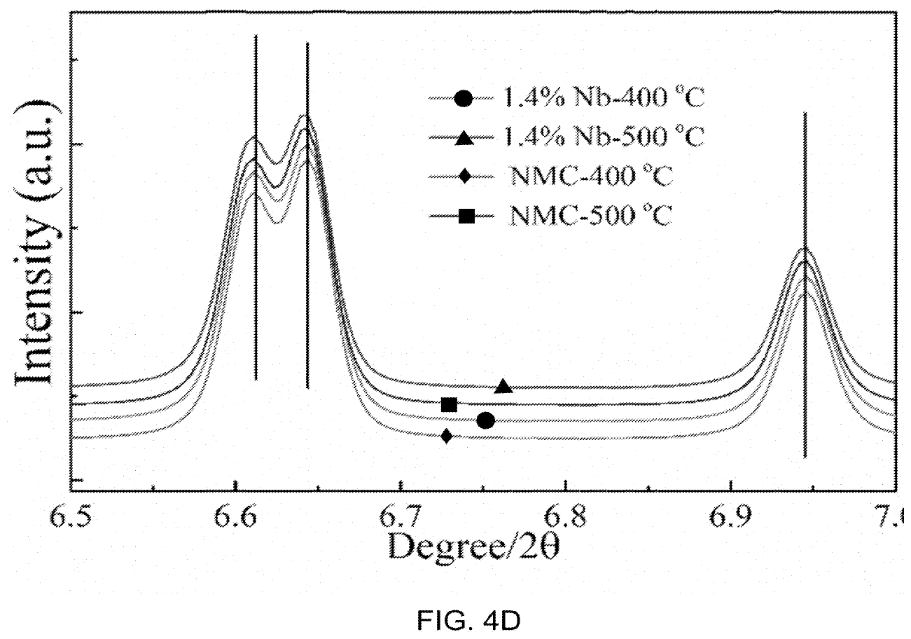

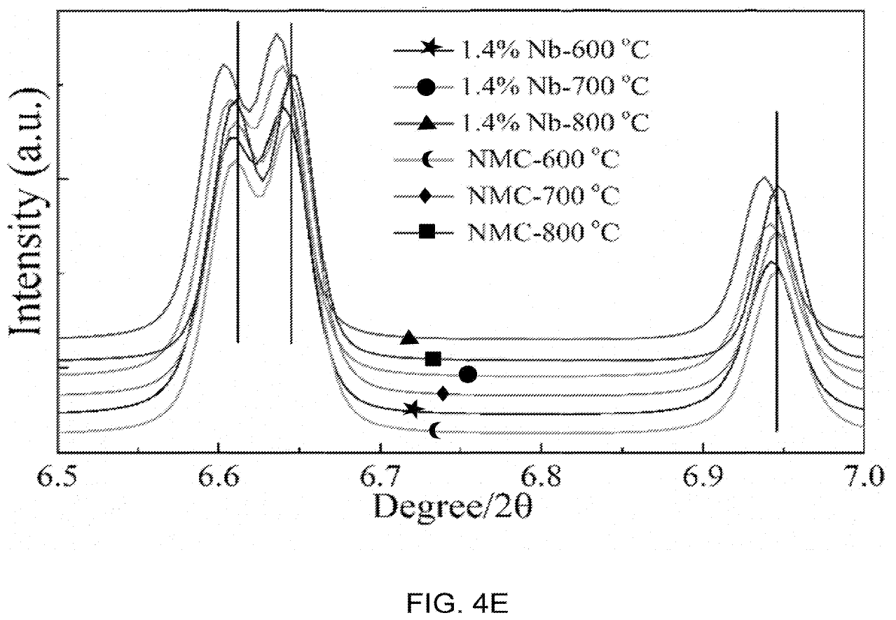

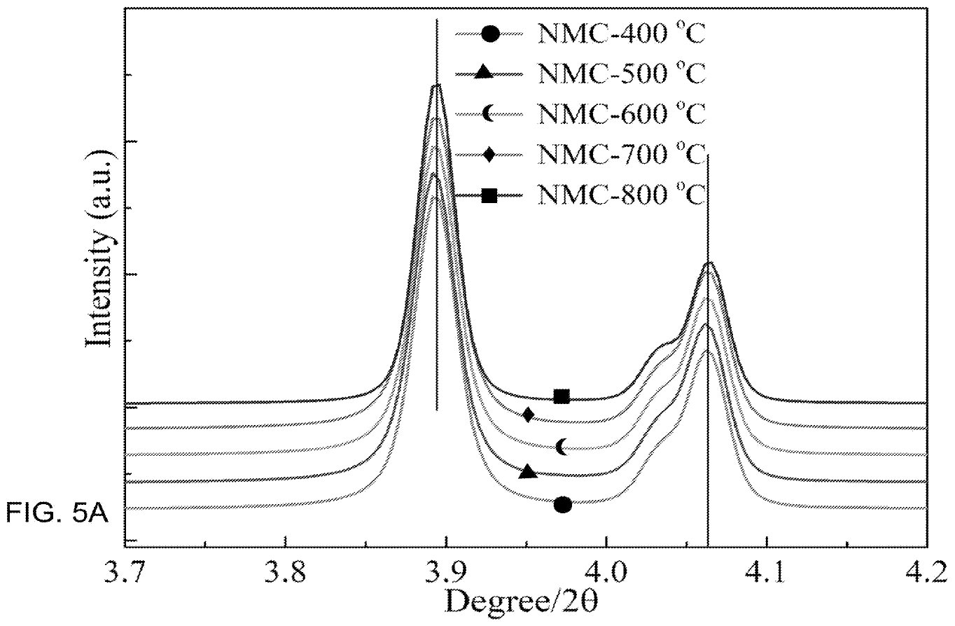

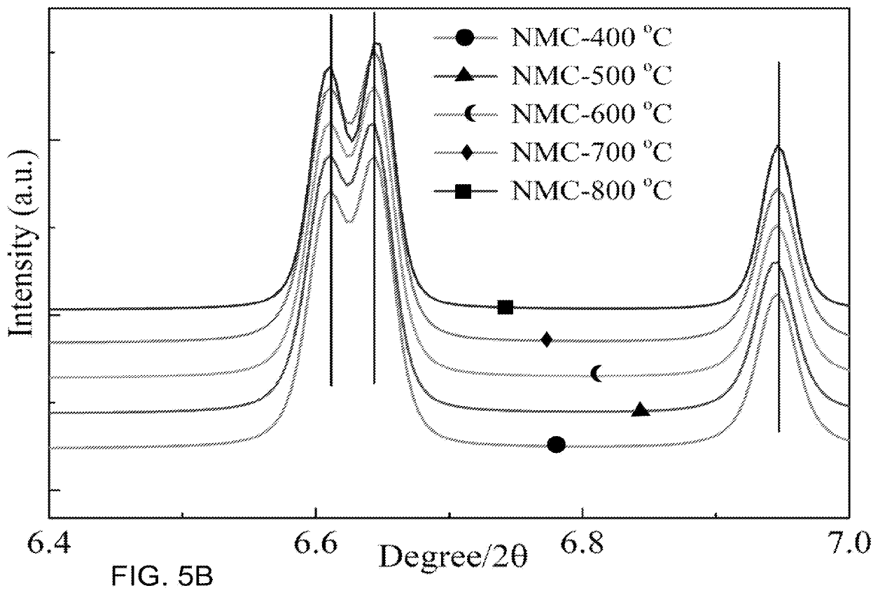

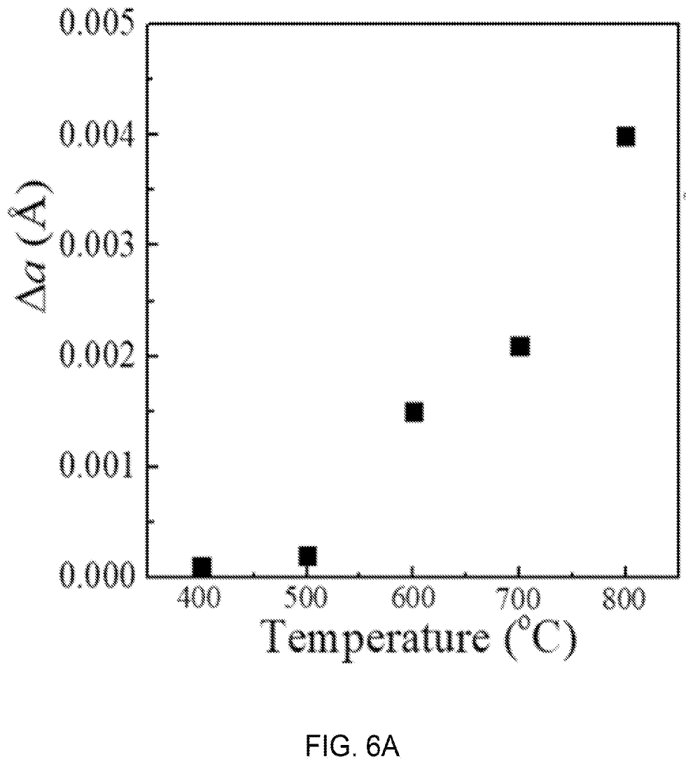

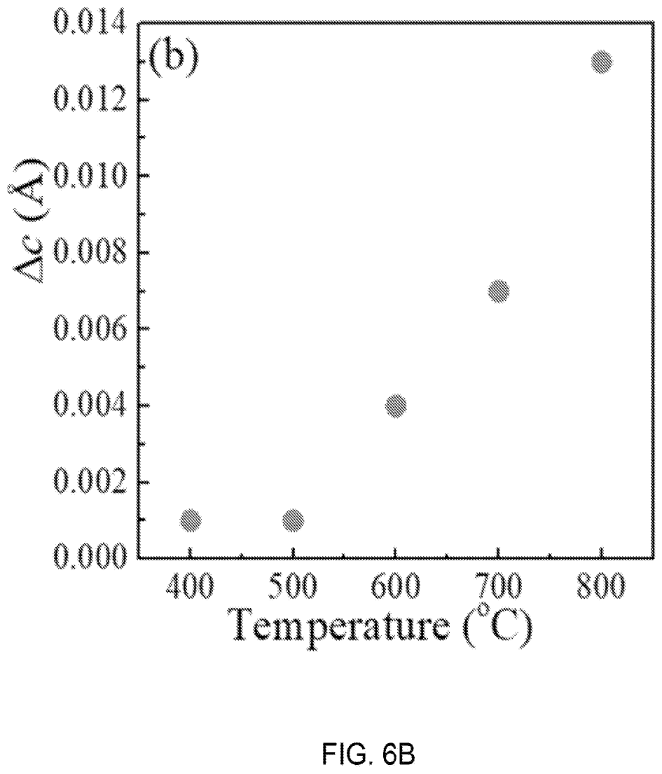

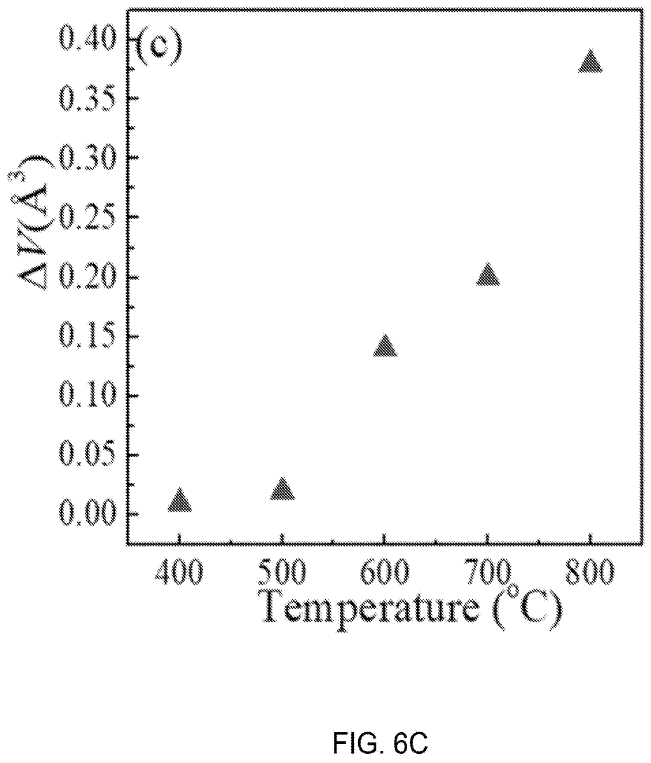

NMC 811, stirred with a niobium ethoxide solution overnight, was heated from 400 to 800° C. in pure oxygen for 3 hours. The XRD patterns of the 0.7% (Molar ratio) Nb modified NMC 811 are shown in FIG. 3A. All exhibit similar sharp diffraction peaks correlating with the hexagonal NaFeO₂ structure in R3̅m space group. Some LiNbO₃ impurities can be found at the lower temperatures, 400 to 500° C., which transformed into Li₃NbO₄ at the higher temperatures, 600 to 800° C. The clear splitting of the 006/102 and 108/110 reflections and a c/a value of about 4.94 indicate that the Nb did not affect the highly ordered layered structure. Slight peak shifted to lower 26 degrees with increasing temperature are observed (FIGS. 3B and 3C), indicating some Nb⁵⁺ penetrates into the NMC structure, which has larger radius (0.64 Å) than that of Co³⁺ (0.545 Å), Mn⁴⁺ (0.53 Å) and Ni³⁺ (0.56 Å). To confirm these peak shifts, a higher level Nb modified samples (1.4% Nb) were studied by the synchrotron diffraction. FIGS. 4A-4C depict clear evolution of LiNbO₃/Li₃NbO₄ and peak shift. In addition, to remove any possible heating effect on the structure, the pristine NMC 811 was also heated at the same conditions as the Nb modified samples. The diffraction peaks stay the same when the pristine NMC 811 is heated from 400 to 800° C. (See e.g., FIGS. 5A and 5B). Comparing the peak positions in FIGS. 4D and 4E refined lattice parameters of Nb modified samples with those of pristine NMC 811 that were heated at the same temperatures (Table 2, Table 3, and FIGS. 6A-6C) clearly shows the same lattice parameters after heating at 400 and 500° C.

TABLE 2
Refined lattice parameters for 1.4% Nb modified
NMC 811 heated from 400 to 800° C.

| T, ° C. | a, Å | c, Å | V, Å³ | c/a | R_{wp}, % |
|---|---|---|---|---|---|
| 400 | 2.8746(1) | 14.198(1) | 101.60(1) | 4.939 | 9.2 |
| 500 | 2.8752(1) | 14.199(1) | 101.66(1) | 4.938 | 10 |
| 600 | 2.8759(1) | 14.202(1) | 101.73(1) | 4.938 | 9.5 |
| 700 | 2.8763(1) | 14.204(1) | 101.77(1) | 4.938 | 9.7 |
| 800 | 2.8778(1) | 14.210(1) | 101.92(1) | 4.938 | 8.7 |

TABLE 3
Refined lattice parameters for commercial
NMC 811 heated from 400 to 800° C.

| T, ° C. | a, Å | c, Å | V, Å³ | c/a | R_{wp}, % |
|---|---|---|---|---|---|
| 400 | 2.8745(1) | 14.197(1) | 101.59(1) | 4.939 | 8.9 |
| 500 | 2.8750(1) | 14.198(1) | 101.64(1) | 4.938 | 9.3 |
| 600 | 2.8744(1) | 14.198(1) | 101.59(1) | 4.939 | 9.2 |
| 700 | 2.8742(1) | 14.197(1) | 101.57(1) | 4.939 | 8.9 |
| 800 | 2.8738(1) | 14.197(1) | 101.54(1) | 4.940 | 8.8 |

But the parameters (a, c V) gradually increase for temperature above that, indicating Nb substitution into NMC 811 starting at ˜600° C. and more substitution with increased temperature.

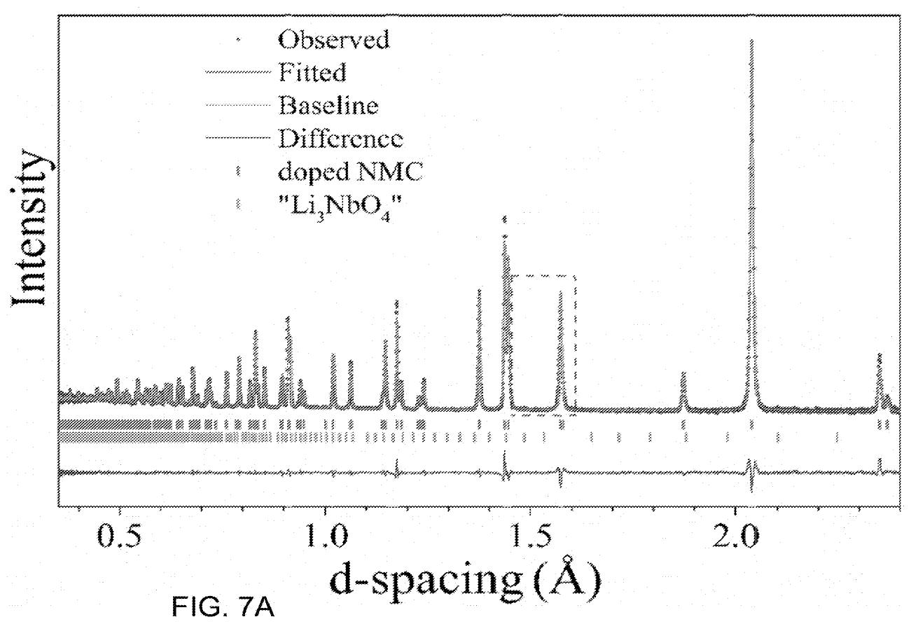

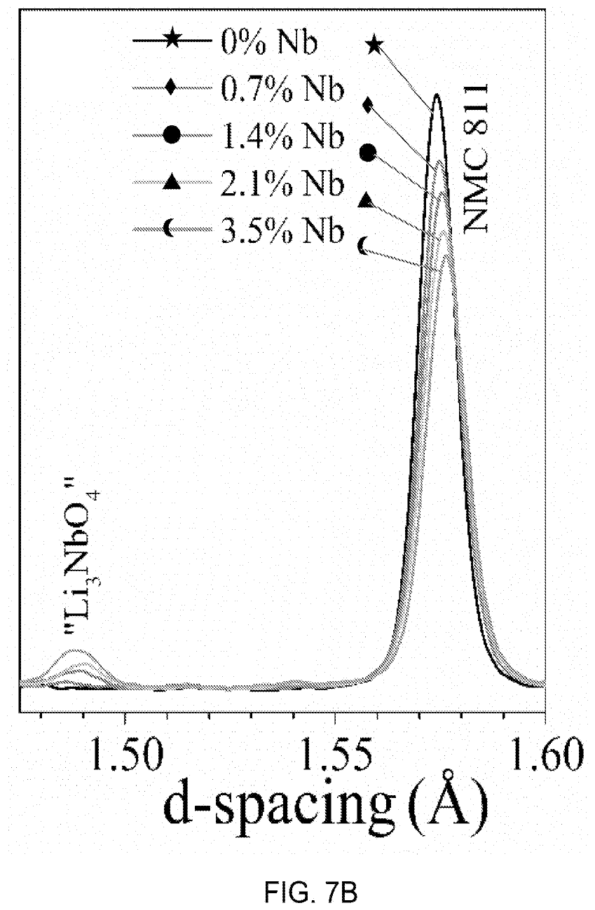

Neutron powder diffraction (See e.g., FIGS. 7A and 7B) was used to reveal the possible Nb site occupancy due to its capabilities of deep penetration in materials and high sensitivity of differentiating transition-metal (TM) elements and detecting light elements. (See e.g., Chen, Y.; Cheng, Y.; Li, J.; Feygenson, M.; Heller, W. T.; Liang, C.; An, K. Lattice-Cell Orientation Disorder in Complex Spinel Oxides. Adv. Energy Mater. 2017, 7 (4), 1601950, and Chen, Y.; Rangasamy, E.; Liang, C.; An, K. Origin of High Li+ Conduction in doped Li7La3Zr2O12 Garnets. Chem. Mater. 2015, 27 (16), 5491). For Nb in NMC 811, three possible sites were considered for Nb occupancy: (1) Nb occupies Li sites due to Li loss at high heating temperature. The smaller radius of Nb⁵⁺ (0.64 nm) vs. Li⁺ (0.76 nm) would therefore suggest a lattice contraction. However, FIGS. 7A and 7B depict a lattice expansion. It also doesn't match the volume expansion in XRD results. (2) Nb occupies Li sites with the reduction of some transition metal oxidation state. Then the transition metal radius (Table 4) will increase when they were reduced, which may enlarge the lattice parameters.

TABLE 4
The neutron coherent scattering lengths and the ion radii
of selected elements. (LS—low spin; HS—high spin)

| | Neutron coherent | Ion radii at 6- |
|---|---|---|
| Elements | scattering length (fm) | coordination (Å) |
| Ni | 10.3 | 0.48(Ni⁴⁺); |
| | | 0.6 (Ni³⁺, HS); 0.56 (Ni³⁺, LS); |
| | | 0.69(Ni²⁺); |
| Mr | −3.73 | 0.53 (Mn⁴⁺); |
| | | 0.645 (Mn³⁺, HS); 0.58 (Mn³⁺, LS); |
| | | 0.83 (Mn²⁺, HS); |
| | | 0.67 (Mn²⁺, LS) |
| Co | 2.49 | 0.53 (Co⁴⁺); |
| | | 0.61 (Co³⁺, HS); 0.545 (Co³⁺, LS); |
| | | 0.745 (Co²⁺, HS); 0.65 (Co²⁺, LS) |
| Nb | 7.054 | 0.64 (Nb⁵⁺) |
| Li | −1.9 | 0.76 (Li⁺) |

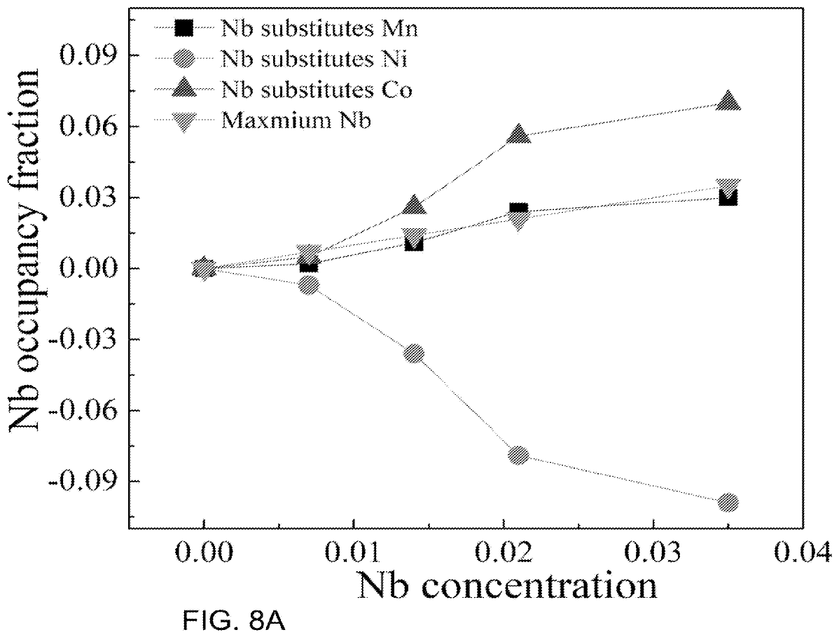

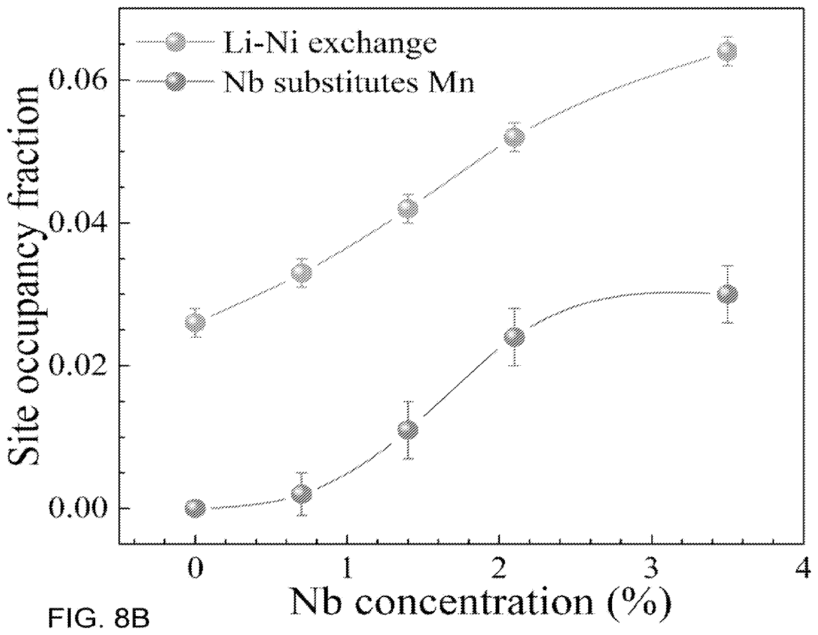

However, the large mismatches of both the valence and the ionic radii of Nb⁵⁺ and Li⁺ reduces the possibility of the Nb at the Li site. If any element is likely to be found on the Li site it is Ni²⁺, as it is closer in size. (3) Nb occupies the transition metal site. Refinement of the NMC phase agrees that the Nb most possibly substitutes on the TM site in NMC 811 (see e.g., FIG. 8A). To keep charge balance, then one of the other transition metals such as Ni will be reduced: Ni³⁺→Ni²⁺. Enriching the Ni²⁺ content promotes its migration to Li site and then increases the Li—Ni exchange, which is also supported by the neutron diffraction results (see e.g., FIG. 8B) Another evidence for Nb occupying the TM site is given by the atom mixing in Nb-site of the Li₃NbO₄ precipitate. The neutron diffraction suggests that the average scattering length at Nb-site of Li₃NbO₄ is significantly lowered, probably due to the substitution by an atom that has a smaller scattering length (see e.g., Table 4); refinement agrees with a model of 48% of Nb replaced by Mn in Li₃NbO₄. Therefore, Nb most probably occupies the transition metal site, displacing some of the Mn.

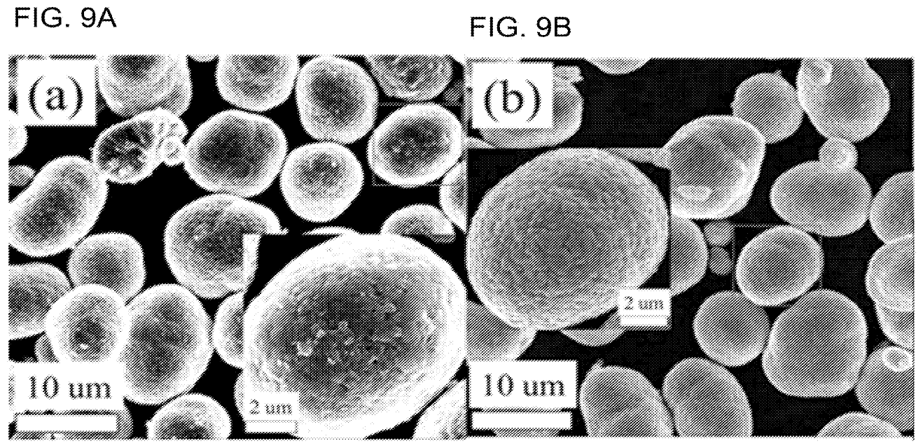

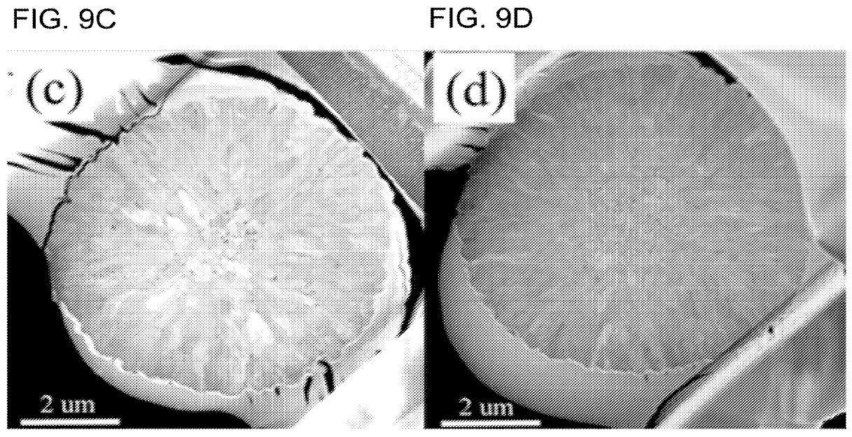

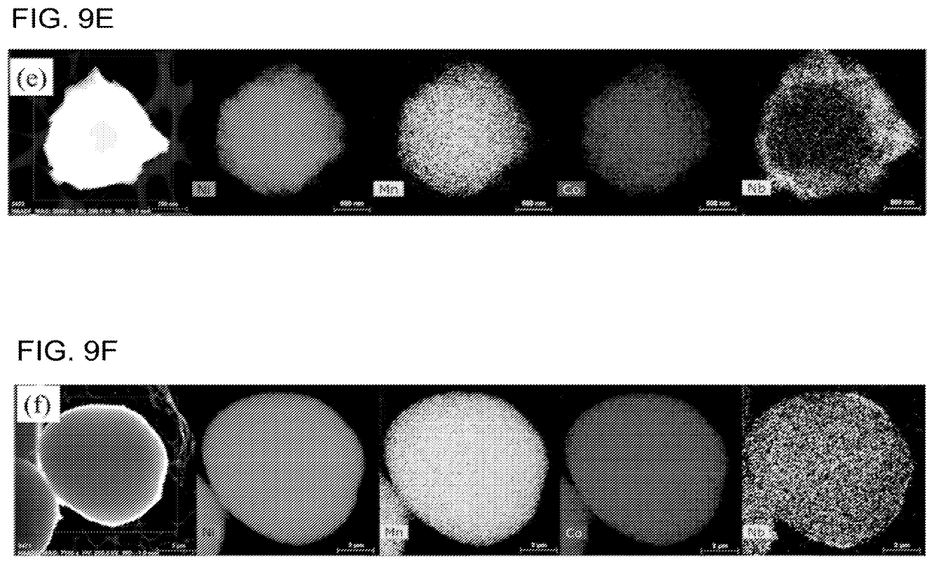

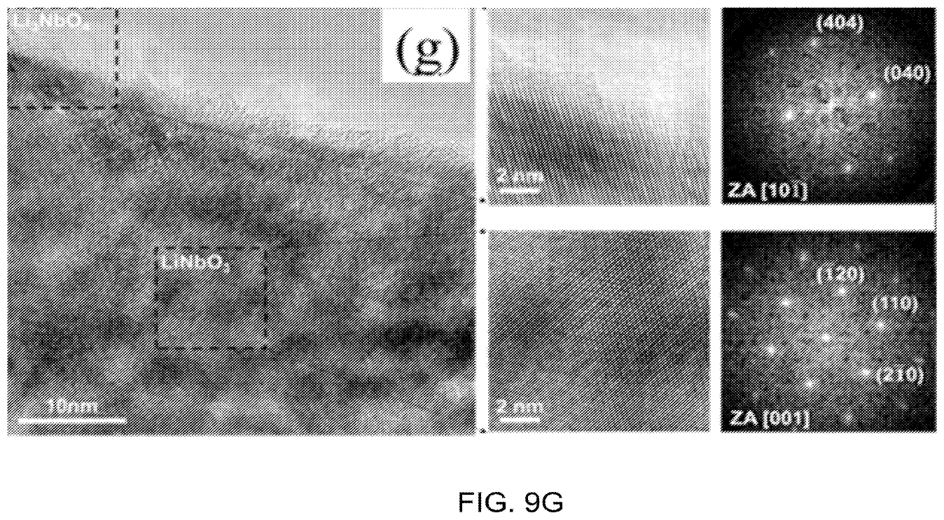

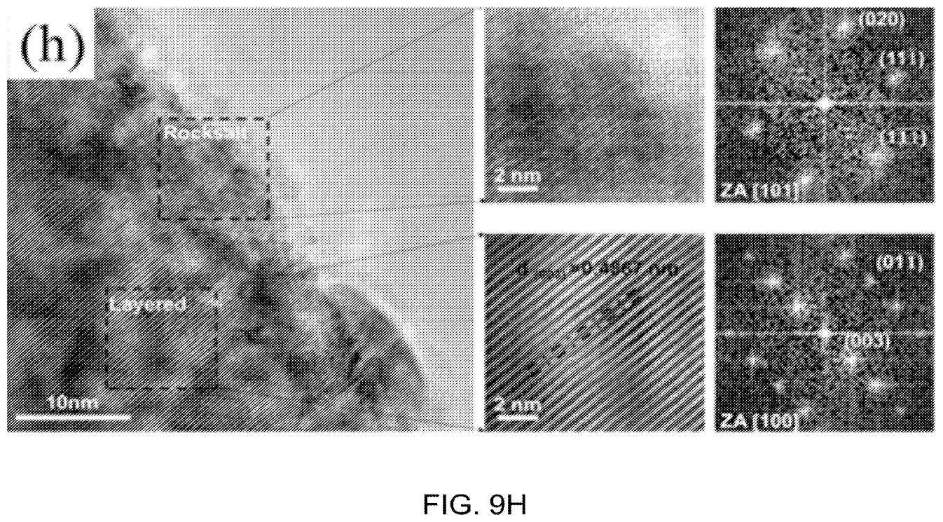

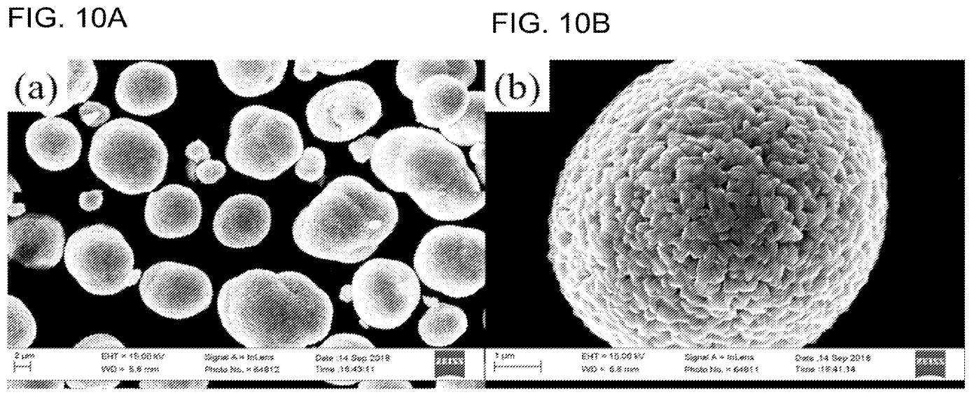

The morphology and composition of Nb modified NMC 811 sintered from 400 to 800° C. were characterized by SEM and TEM technique. NMC811-0.7Nb-500° C. and NMC811-0.7Nb-700° C. are the representative samples for the low (400° C., 500° C.) and high (600, 700° C. and 800° C.) temperature. FIG. 9A (NMC811-0.7Nb-500° C.), FIG. 9B (NMC811-0.7Nb-700° C.), FIGS. 10A and 10B (Pure NMC 811) shows their morphology, displaying same particle size and shape. Compared with NMC811-0.7Nb-700° C., the surface of NMC811-0.7Nb-500° C. is blurred (see e.g., FIG. 9A, inset), which is different from the clear boundary of the primary particles of NMC 811. HAADF STEM images in FIG. 9C and FIG. 9D show similar tightly packed primary particles in the 500° C. and 700° C. samples, contributing a tap density of 2.3 g/cm³. As evidenced by the EDS images shown in FIG. 9E, there is a nanosized coating layer surrounding the surface of NMC811-0.7Nb-500° C. from tens of nanometers to a few hundred nanometers. The main element of this surface coating layer is Nb. In addition to the Nb coating layer, some of Nb also diffuses into the upper layer of parent material NMC 811. Ni, Co, Mn, Nb were homogeneously distributed in the particles of NMC811-0.7Nb-700° C. (See e.g., FIG. 9F), giving a direct evidence that Nb has diffused into NMC 811 at the higher temperatures. The High-Resolution TEM (HR-TEM) images in FIG. 9G further reveal that the coating layer has clear lattice fringes with interplanar distance of =3.74, =2.57, =2.11 Å, respectively, associated with the (110) and (210) planes of crystalline LiNbO₃, (040) plane of crystalline Li₃NbO₄, which was further evidenced by the corresponding fast Fourier transform (FFT) diffraction, suggesting that a Nb coating layer is effectively formed at the lower temperatures. For NMC811-0.7Nb-700° C., we only found some rock-salt coating layers shown in FIG. 9H, which may originate in the complicated surface of the Nb substituted Ni-rich layered oxide materials.

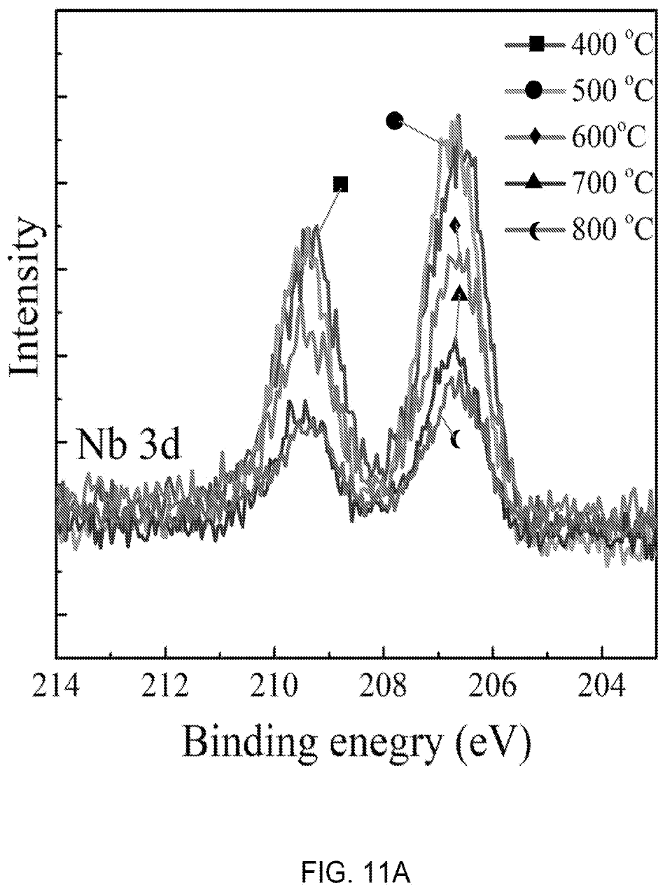

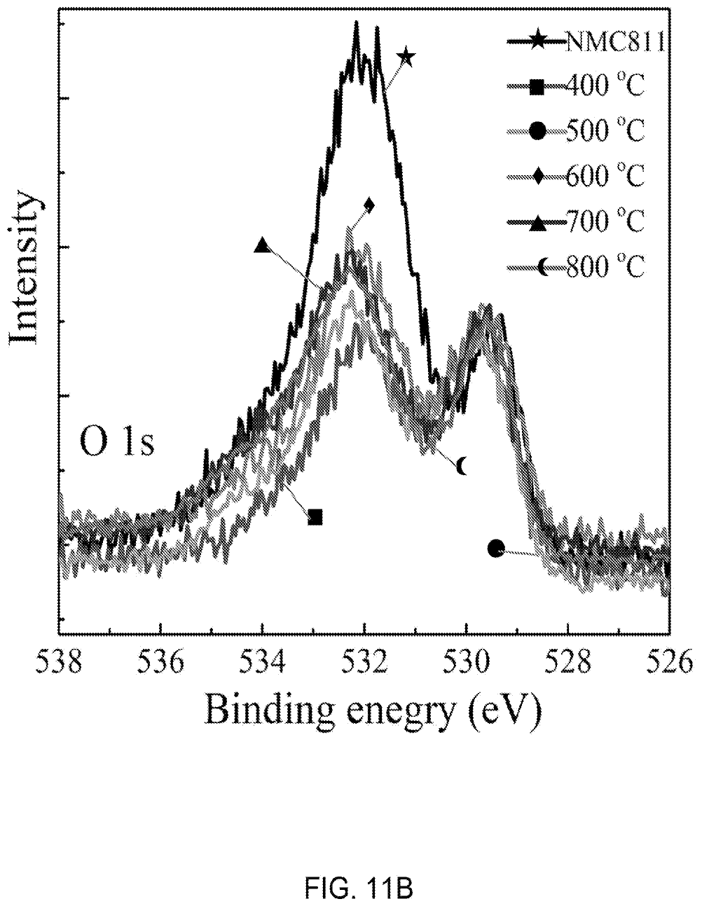

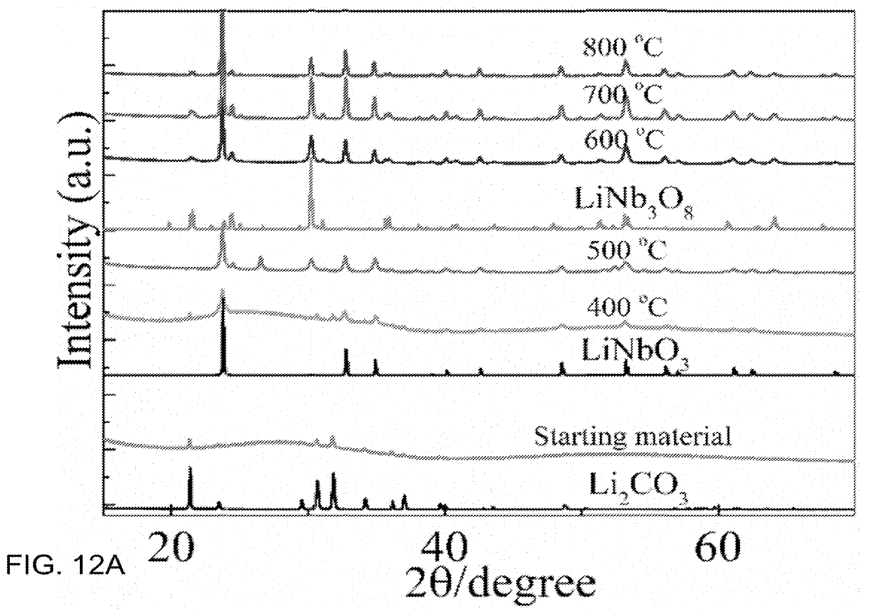

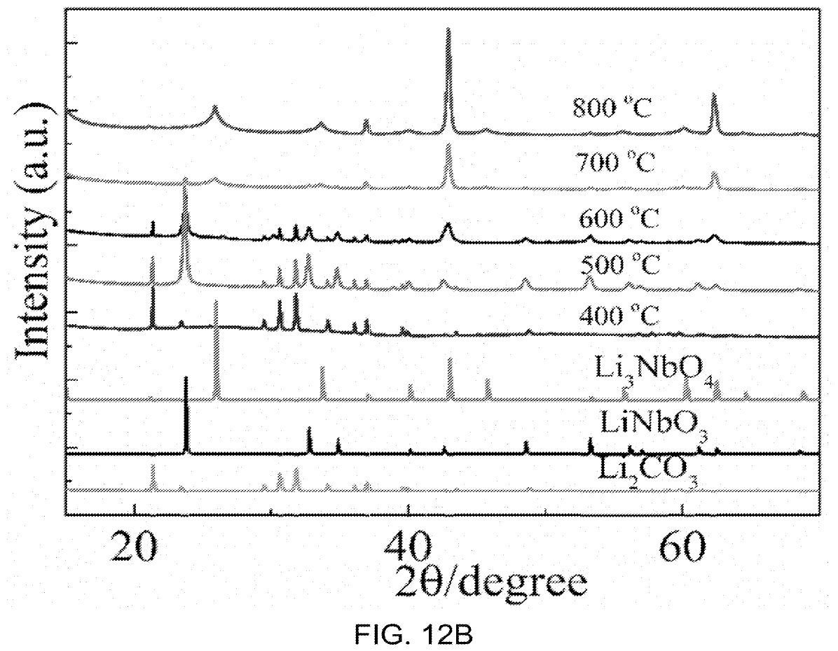

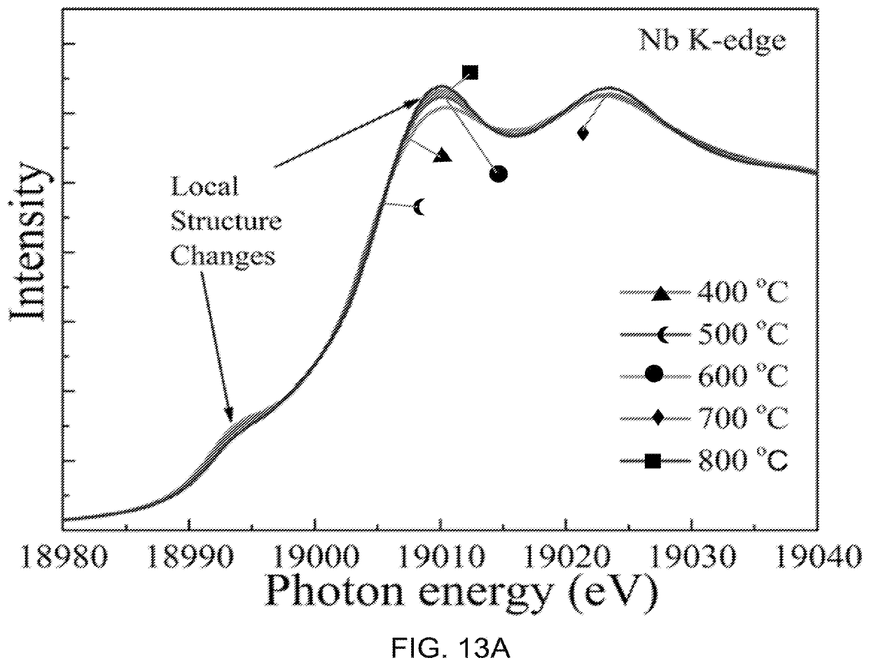

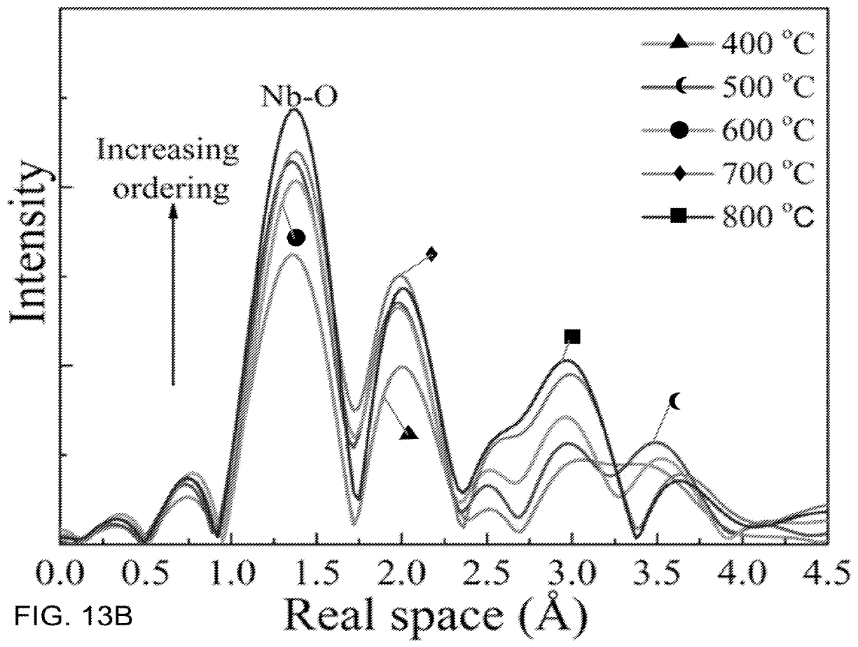

An XPS study confirmed the Nb⁵⁺ oxidation state for the 0.7% Nb modified NMC 811 (See e.g., FIG. 11A). In addition, it shows the highest Nb concentration at the lowest heating temperature, while Nb signal is incrementally weaker for higher temperatures due to more Nb diffusing into the bulk of the NMC 811, which matches the XRD results. The O 1s core regions (See FIG. 11B) shows a strong peak at around 532.5 eV for pristine NMC 811, which comes from a surface contamination layer, which is normal for Ni-rich NMC materials, due to their very sensitive surface reactivity. Li₂CO₃ is reported to be the main species in this layer. (See e.g., Faenza, N. V.; Bruce, L.; Lebens-Higgins, Z. W.; Plitz, I.; Pereira, N.; Piper, L. F.; Amatucci, G. G. Growth of Ambient Induced Surface Impurity Species on Layered Positive Electrode Materials and Impact on Electrochemical Performance. J. Electrochem. Soc. 2017, 164 (14), A3727). The Nb modified NMC heated from 400 to 800° C. shows significantly reduced Li₂CO₃ on the surface. This may be attributed to reaction between the Li-free Nb compound and Li₂CO₃. FIGS. 12A and 12B show that the Nb precursor easily reacts with Li₂CO₃ to form LiNbO₃ at lower temperature and Li₃NbO₄ at higher temperature, which coincide well with the XRD observations. However, one cannot exclude Nb precursor takes some Li from NMC 811 to form Li—Nb—O compound on the surface, especially at the higher temperatures. Further, Nb K-edge of XANES in FIG. 13A shows that the pre-edge diminished and sharp Nb 5p transitions at ˜19010 eV and ˜19025 eV was obtained, suggesting a more ordered environment at increasing temperatures as evidenced by EXAFS in FIG. 13B.

A magnetic susceptibility study (See e.g., FIGS. 14A and 14B and Table 5) shows Curie-Weiss behavior at high temperatures, consistent with 0.1 Co³⁺ (S=0), 0.1 Mn⁴⁺ (S=3/2), 0.1 Ni²⁺ (S=1), and 0.7 Ni³⁺ (S=½).

Table 5. Magnetic parameters of Nb modified NMC 811 and pure NMC 811 in different temperature. At 10.0 K a magnetic transition is observed for the initial and the Nb treated 400 and 500° C. materials, whereas for those materials heated at higher temperatures, the magnetic transition shifts to 11.5 K confirming lattice modification by Nb substitution.

TABLE 5

| | | | | | | μₜₕₑₒᵣ |
|---|---|---|---|---|---|---|
| | C_{M}, emu | | χ₀, 10⁻⁴ | | | Ni2+ |
| | K/mol | | emu/mol | | μₑₓₚ, | Mn4+, |
| Sample | TM | Θ, K | TM | T_{f}, K | μ_{B} | μ_{B} |
| NMC 811 | 0.565(1) | 10.8(1) | 1.1 | 10.0 | 2.13 | 2.10 |
| 0.7% Nb-400° | 0.459 | 31.3 | −1.5 | 10.0 | 1.92 | 2.10 |
| C. | | | | | | |
| 0.7% Nb-500° | 0.532 | 17.6 | 1.7 | 10.5 | 2.06 | 2.10 |
| C. | | | | | | |
| 0.7% Nb-600° | 0.577 | 13.3(1) | 6.7 | 11.0 | 2.15 | 2.10 |
| C. | | | | | | |
| 0.7% Nb-700° | 0.518 | 17.4(1) | 13.1 | 11.5 | 2.04 | 2.10 |
| C. | | | | | | |
| 0.7% Nb-800° | 0.532 | 18.2(1) | 1.8 | 11.5 | 2.06 | 2.10 |
| C. | | | | | | |
| NMC-400° C. | 0.566 | 9.2 | 1.5 | 10.0 | 2.13 | 2.10 |
| NMC-600° C. | 0.563 | 7.1 | 0.9 | 9.5 | 2.12 | 2.10 |
| NMC-800° C. | 0.588 | 3.6 | 0.07 | 9.5 | 2.17 | 2.10 |

The combination of XRD, ND patterns, refined lattice parameters, SEM, TEM, XPS and magnetic test, confirms that a Nb coating on the surface of NMC 811 is found at the lower temperature (400° C. and 500° C.), whereas Nb substitution at the higher temperatures (600° C., 700° C. and 800° C.). The main coating layer is LiNbO₃ and within the lattice Nb occupies the TM sites.

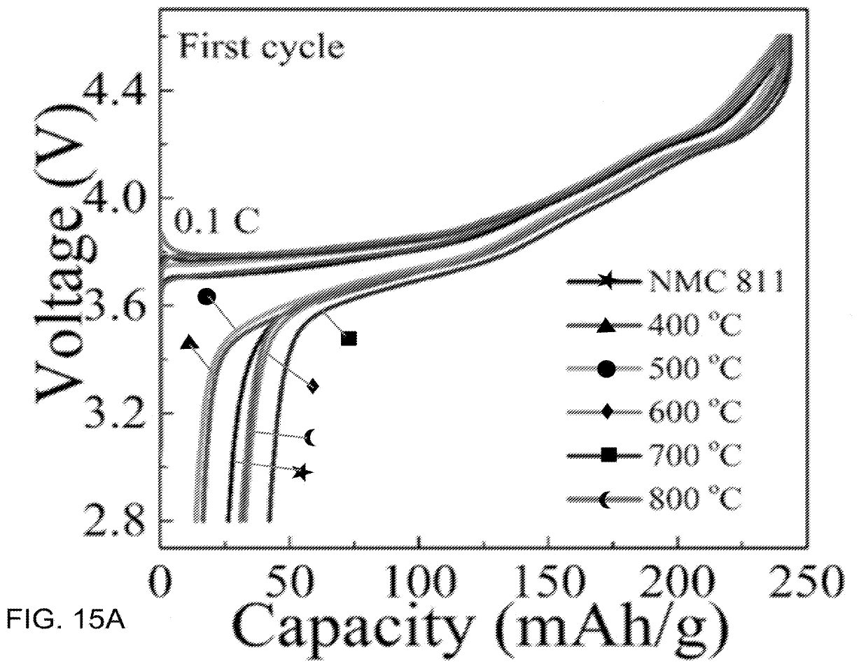

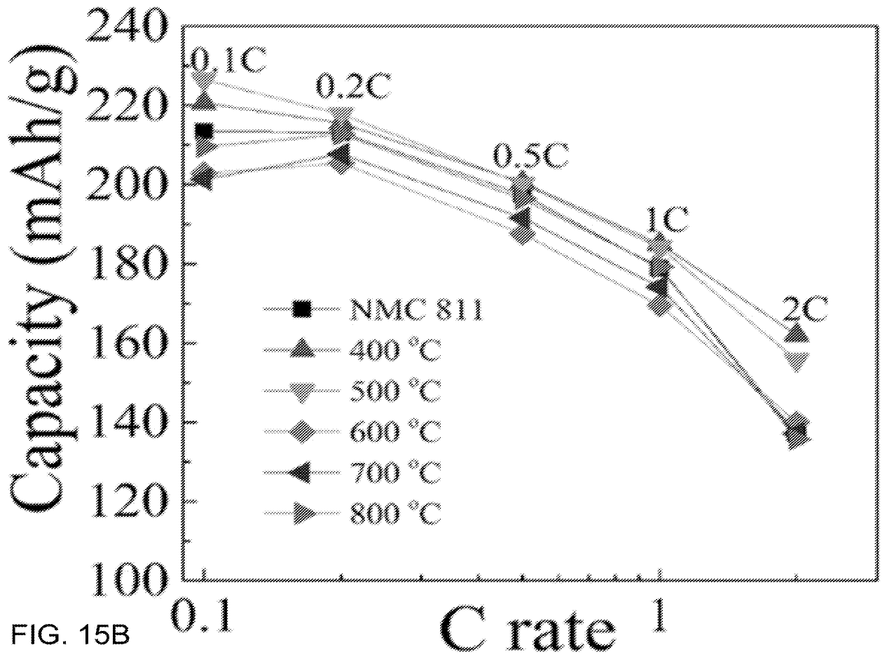

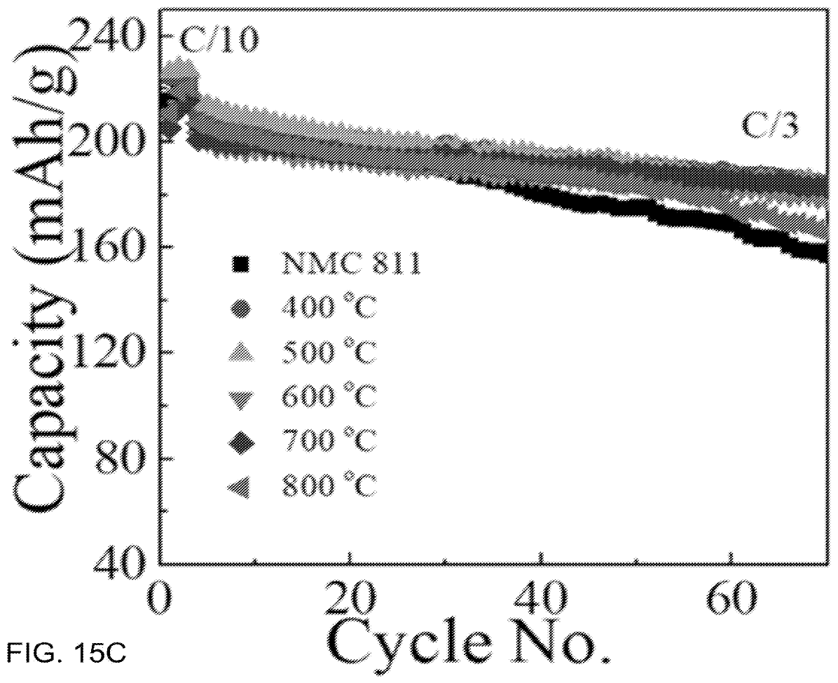

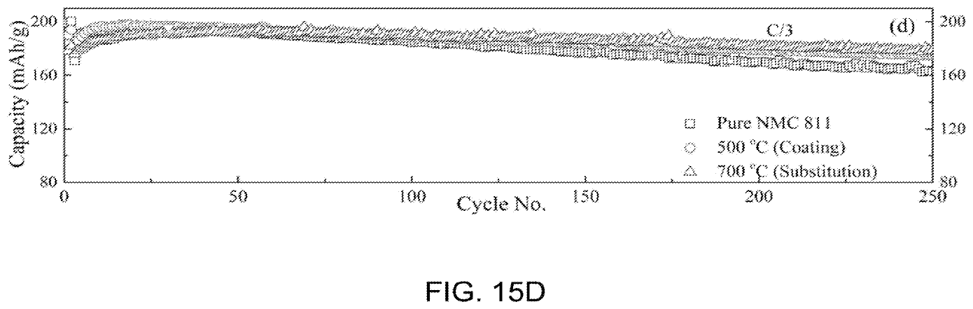

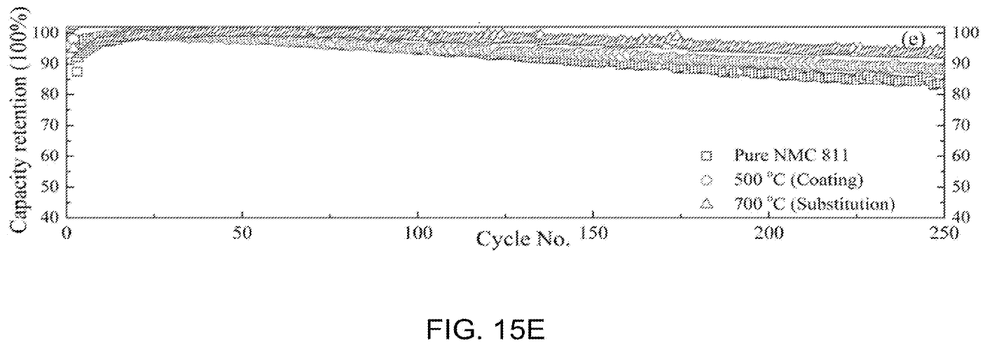

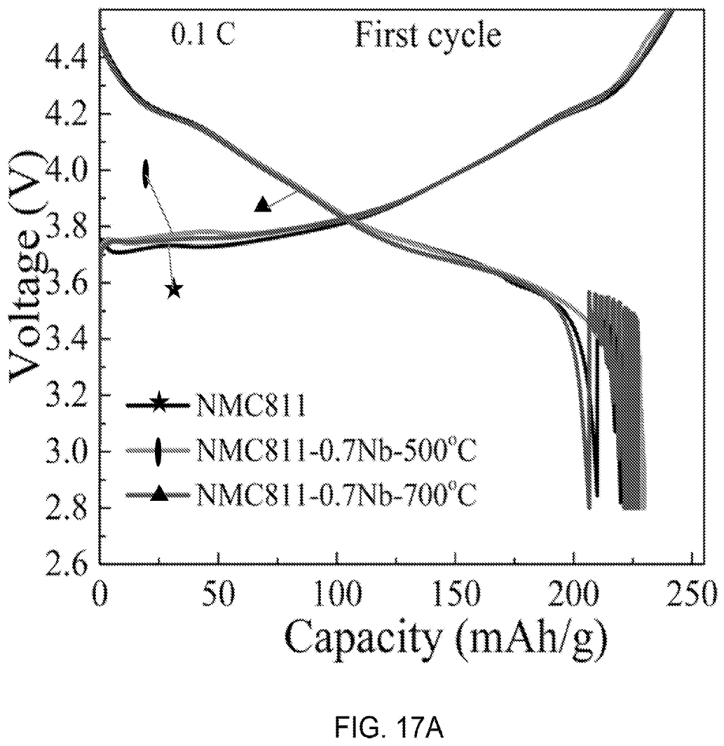

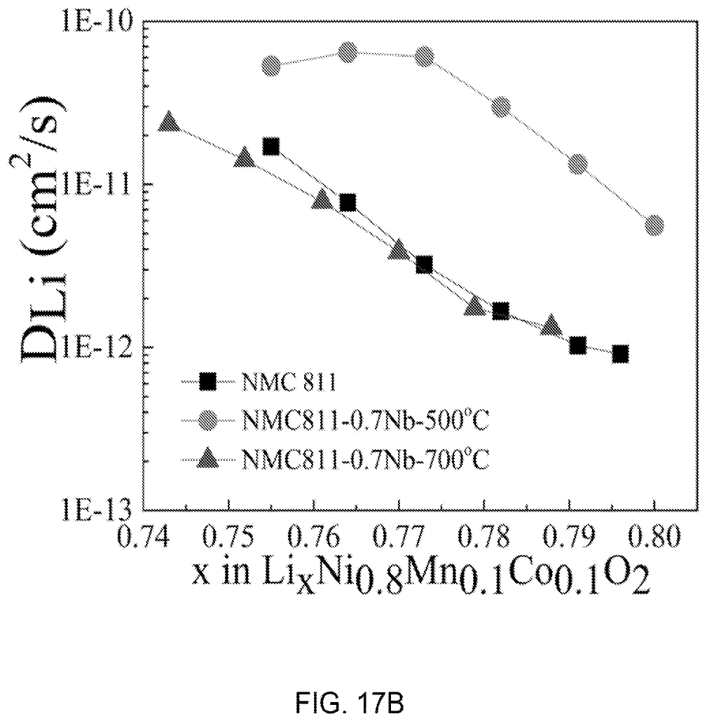

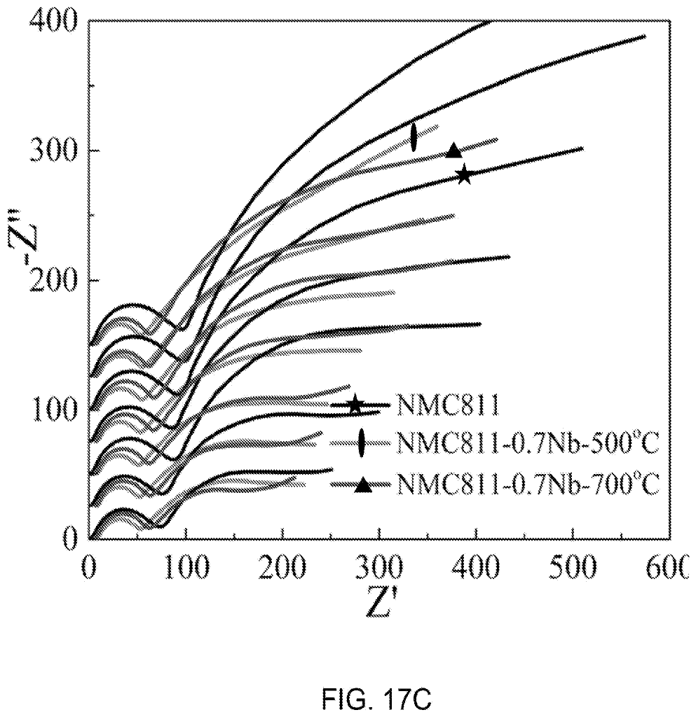

The electrochemical behavior of this Nb modified NMC 811 is shown in FIGS. 15A-15E. FIG. 15A shows that the charging capacities are similar for all the materials. However, the discharge capacity is significantly improved by surface coating (400° C. and 500° C.), where it increases from 216.3 mAh g⁻¹ (NMC 811) to 224.4 and 225.1 mAh g⁻¹ for the 400° C. and 500° C. materials. However, higher temperature treatment is detrimental: 207.4, 201.3 and 211.4 mAh g⁻¹ for 600° C., 700° C., and 800° C. respectively. The corresponding Coulombic efficiencies are 89.1%, 93.1%, 94.2%, 86.3%, 82.7%, 87.3%. The surface coated materials also exhibit the highest rate capability as shown in FIG. 15B, suggesting some positive modification of the surface. The 1^{st} cycle loss is probably due to the much-reduced lithium ion diffusion for x>0.7. (See e.g., Zhou, H.; Xin, F.; Pei, B.; Whittingham, M. S. What limits the capacity of layered oxide cathodes in lithium batteries? ACS Energy Letters 2019, 4, 1902). Galvanostatic Intermittent Titration (FIGS. 17A and 17B) shows that the lithium-ion diffusion coefficient was enhanced for the low temperature samples for x>0.7; in addition, the interfacial resistance was stable and smaller than that in pure NMC 811 (See e.g., FIG. 17C). Therefore, a lower interfacial resistance and a higher lithium-ion diffusion coefficient in Nb coated NMC 811 leads to faster kinetics. Nb coating layer can protect the surface of NMC 811. However, substituting Nb into the bulk lattice does not help the Li kinetics.

The capacity retention of these materials, at a C/3 rate for mass loading of 13-15 mg/cm² and calendaring density of 3.0 g/cm³ in the 2.8-4.6 V cycling regime are shown in FIG. 15C. The Nb treated materials were all superior to the untreated NMC, but charging to 4.6 V showed an unacceptable capacity loss for all of the materials over 70 cycles. Reducing the charging voltage to 4.4 V, but keeping all the other parameters the same, showed much improved capacity retention as indicated in FIGS. 15D and 15E. The Nb substituted material had a 93.2% capacity retention after 250 cycles, followed by the coated sample at 88.2% and the untreated 811 at 83.4%. The Nb substitution helps stabilize the bulk of the lattice against structural changes, whereas Nb coating increases the initial capacity. Without wishing to be bound by the present disclosure, the improved cycling stability by Nb lattice substitution may come from: (1) High dissociation energy of Nb—O strengthens metal-oxide bonds, corresponding, the interfacial resistance will be enhanced; (2) The reduced heat release (see e.g., FIGS. 18A and 18B) may indicate enhanced thermal stability for the whole system.

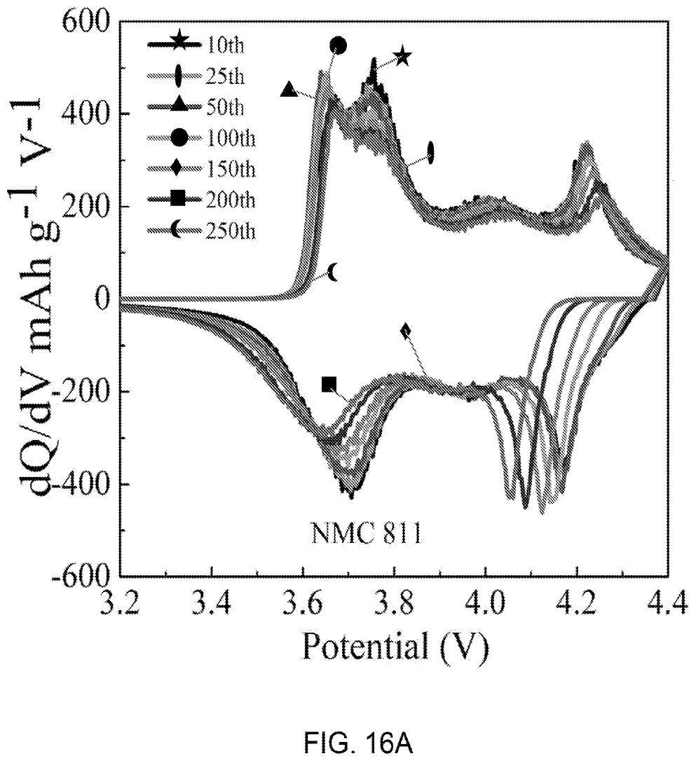

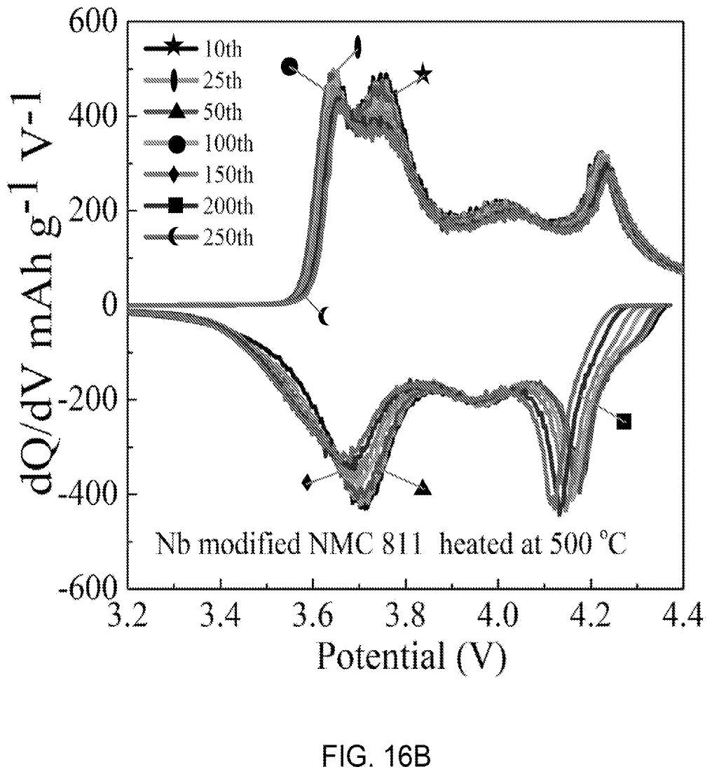

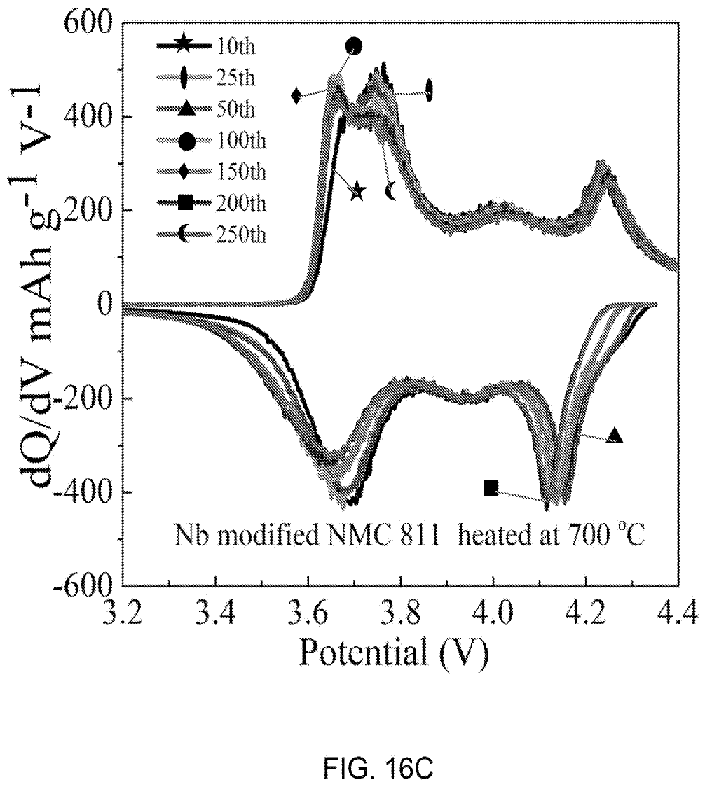

Further, a differential capacity (dQ/dV) study was carried out to determine the impact of the Nb treatment on the structural stability of the 811. The results are shown in FIGS. 16A-16C and shows some clear differences between the materials. For the untreated 811, the higher voltage peaks continuously shift on cycling suggesting an increase in impedance, whereas for the substituted material the changes are much less; the coated material falls in between. The change in the 4.2 peak might suggest an increased stabilization against the H2→H3 phase change with the contraction of the lattice. It is this large contraction that has been associated with capacity fade. (See e.g., Noh, H.-J.; Youn, S.; Yoon, C. S.; Sun, Y.-K. Comparison of the Structural and Electrochemical Properties of Layered Li[NixCoyMnz]O₂ (x=⅓, 0.5, 0.6, 0.7, 0.8 and 0.85) Cathode Material for Lithium-ion Batteries. J. Power Sources 2013, 233, 121, and Li, H.; Cormier, M.; Zhang, N.; Inglis, J.; Li, J.; Dahn, J. R. Is Cobalt Needed in Ni-Rich Positive Electrode Materials for Lithium Ion Batteries? J. Electrochem. Soc. 2019, 166, A429).

In summary, Nb coated and substituted NMC 811 were successfully synthesized and showed that Nb improved the electrochemical behavior of NMC 811. The Nb coating stabilizes the surface and decreases the 1^{st} cycle loss and improves the rate capability, whereas Nb substitution improves capacity retention on extended cycling by stabilizing the lattice. In embodiments, the coating includes or consists of LiNbO₃/Li₃NbO₄ surface species. On substitution, Nb resides on the transition metal sites ejecting some Mn into the niobate surface layer. The improvement of electrochemical performance and structure stability makes Nb modified NMC 811 a potential cathode material for the application in high energy density electric vehicles. Further, combining coating and substitution may be a better way to the whole electrode.

Referring now to FIGS. 17A to 17C, FIG. 17A depicts GITT curves in lower voltage range of discharge process; FIG. 17B depicts calculated lithium-ion diffusion coefficients; and FIG. 17C depicts EIS of Nb modified NMC 811 at 500° C., 700° C. and pure NMC 811.

### Thermal Stability Study

Referring now to FIGS. 18A and 18B, FIGS. 18A and 18B depict large exothermic peaks shifts from 199.4° C. (NMC 811) to 203.7° C. (Nb modified NMC 811 heated at 500° C.) and 204.3° C. (Nb modified NMC 811 heated at 700° C.) although an additional peak starts from 143.1° C. for the 700° C. sample. The heat release amounts are 203.9 J/g (NMC 811) vs. 174.6 J/g (Nb modified NMC 811 heated at 500° C.) vs. 161.72 J/g (three peaks: 28.60+58.89+78.23 J/g in 700° C. sample).

### Example II

### Preparation of Electrode of the Present Disclosure

Nb modified NMC 811, heated from 400 to 800° C. and pristine NMC 811 samples were separately mixed with acetylene black and polyvinylidene fluoride (PVDF) powders with a weight ratio of 90:5:5 in 1-methyl-2-pyrrolidinone (NMP) solvent to form a slurry. Then the slurry was cast onto an aluminum (Al) foil using doctor blade and dried in vacuum oven at 80° C. for overnight. The average mass loading of the electrode was 13-15 mg/cm² and was calendared to 3.0 g/cm³. All of this was done in our dry room (Temperature: 20-21° C.; Dew point: <−50).

More details: The weight ratio of active material for the electrode (Nb modified NMC 811° C. heated at 400° C. or Nb modified NMC 811° C. heated at 500° C. or Nb modified NMC 811° C. heated at 600° C. or Nb modified NMC 811° C. heated at 700° C. or Nb modified NMC 811° C. heated at 800° C.) is between 90% to 96%. The weight ratio of conductive carbon (acetylene black) for the electrode is between 2% to 5%; and binder (polyvinylidene fluoride (PVDF)) in the electrode is between 2% to 5%.

The details for the slurry making process: PVDF (binder) was firstly added to 1-methyl-2-pyrrolidinone (NMP) solvent, and mixed 5 to 10 mins using a mixer machine, then acetylene black (conductive carbon) was added to the mixture and mixed 5 to 10 mins using the mixer machine. Finally active material of the present disclosure (Nb modified NMC 811) and mixed 5 to 10 mins.

### Example III

Surface coating is commonly employed by industries to improve the cycling and thermal stability of high-nickel (Ni) transition metal (TM) layered cathodes for their practical use in lithium-ion batteries. Niobium (Nb) coating/substitution has been shown above as effective in stabilizing LiNi_{0.8}Mn_{0.1}Co_{0.1}O₂ (NMC811) cathodes, further, electrochemical performance of the final products varies depending on the post processing. In this follow-up example, in situ synchrotron X-ray diffraction is used to investigate the kinetic processes and involved structural evolution in Nb-coated NMC811 upon heat treatment. Quantitative structure analysis reveals thermo-driven concurrent changes in the bulk and surface, in particular, the phase evolution of the coating layer and Nb/TM inter-diffusion that facilitates Nb penetration into the bulk and particle growth at the elevated temperatures. Findings from this study highlight the new opportunities for intended control of the structure and surface properties of high-Ni cathodes through surface coating in conjunction with post processing. (See e.g., Xin F, Zhou H, Bai J, Wang F, Whittingham MS. Conditioning the Surface and Bulk of High-Nickel Cathodes with a Nb Coating: An In Situ X-ray Study. J Phys Chem Lett. 2021 Aug. 26; 12(33):7908-7913. doi: 10.1021/acs.jpclett.1c01785. Epub 2021 Aug. 12. PMID: 34383509) (herein incorporated entirely by reference including all supporting information and color figures).

The general process conditions and certain embodiments of the present disclosure are depicted in FIG. 29. Here it is shown that Nb oxide coatings can react with surface Li-residuals on high-Ni NMC (LiNi_{0.8}Co_{0.1}Mn_{0.1}O₂; 811), with the processes strongly dependent on sintering temperature. At low temperatures, LiₓNbO_{y} phases, such as LiNbO₃/Li₃NbO₄ were formed at particle surface and are beneficial to performance by reducing the 1^{st}-cycle capacity loss; at further elevated temperatures Nb element was found to penetrate deeply into the bulk, leading to improved cycling performance.

The transition metal (TM) layered oxides have been the most used cathode materials in lithium-ion batteries (LIBs) since LiCoO₂ was initially reported by Goodenough (See e.g., Mizushima, K.; Jones, P.; Wiseman, P.; Goodenough, J. B. LiₓCoO₂ (0<x<−1): A New Cathode Material for Batteries of High Energy Density. Mater. Res. Bull. 1980, 15, 783-789) and then commercialized in 1991 by Sony Company. (See e.g., Nagaura, T. Lithium Ion Rechargeable Battery. Progress in Batteries & Solar Cells 1990, 9, 209). Even today, LiCoO₂ dominates the portable electronics market due to its good cycling stability, rate capability and high tap density. However, it is not suitable for use in electric vehicles (EVs) predominantly because of the high price of Co. So much of the Co has been replaced by other transition metals as in LiNi_{1-y-z}Mn_{y}Co_{z}O₂ (NMC) and LiNi_{1-y-z}Co_{y}Al_{z}O₂ (NCA). Amongst these, the high Ni materials, where y+z≤50.2 are attracting the most attention due to their higher energy densities and lower cost. (See e.g., Li, W.; Erickson, E. M.; Manthiram, A. High-nickel Layered Oxide Cathodes for Lithium-based Automotive Batteries. Nat. Energy 2020, 5, 26-34, Choi, J. U.; Voronina, N.; Sun, Y. K.; Myung, S. T. Recent Progress and Perspective of Advanced High-Energy Co-Less Ni-Rich Cathodes for Li-lon Batteries: Yesterday, Today, and Tomorrow. Adv. Energy Mater. 2020, 10, 2002027, Xin, F.; Whittingham, M. S. Challenges and Development of Tin-Based Anode with High Volumetric Capacity for Li-lon Batteries. Electrochem. Energ. Rev. 2020, 3, 643-655, Xu, G. L.; Liu, X.; Daali, A.; Amine, R.; Chen, Z.; Amine, K. Challenges and Strategies to Advance High-Energy Nickel-Rich Layered Lithium Transition Metal Oxide Cathodes for Harsh Operation. Adv. Funct. Mater. 2020, 30, 2004748, Zhou, H.; Xin, F.; Pei, B.; Whittingham, M. S. What Limits the Capacity of Layered Oxide Cathodes in Lithium Batteries? ACS Energy Lett. 2019, 4, 1902-1906).

However, they face multiple challenges, such as Li/Ni cationic mixing, decreased thermal stability, and the formation of surface impurities on air exposure, such as Li₂CO₃. There have been several approaches to mitigate these issues, in particular coating and doping/substitution or Ni concentration gradient. Surface coating using Al₂O₃, ZrO₂, Li₃PO₄, Li₂ZrO₃, Li—Nb—O has been shown effective in suppressing the dissolution of transition metal ions, alleviating the side reactions between the electrolyte and electrode and reducing the first cycle loss. (See e.g., Wise, A. M.; Ban, C.; Weker, J. N.; Misra, S.; Cavanagh, A. S.; Wu, Z.; Li, Z.; Whittingham, M. S.; Xu, K.; George, S. M.; Toney, M. F. Effect of Al₂O₃Coating on Stabilizing LiNi_{0.4}Mn_{0.4}Co_{0.2}O₂ Cathodes. Chem. Mater. 2015, 27, 6146-6154, Ho, V.-C.; Jeong, S.; Yim, T.; Mun, J. Crucial Role of Thioacetamide for ZrO₂ Coating on the Fragile Surface of Ni-rich Layered Cathode in Lithium Ion Batteries. J. Power Sources 2020, 450, 227625, Jo, C.-H.; Cho, D.-H.; Noh, H.-J.; Yashiro, H.; Sun, Y.-K.; Myung, S. T. An Effective Method to Reduce Residual Lithium Compounds on Ni-rich Li[Ni_{0.6}Co_{0.2}Mn_{0.2}]O₂ Active Material using a Phosphoric Acid Derived Li₃PO₄ Nanolayer. Nano Res. 2014, 8, 1464-1479, Song, B.; Li, W.; Oh, S. M.; Manthiram, A. Long-Life Nickel-Rich Layered Oxide Cathodes with a Uniform Li₂ZrO₃ Surface Coating for Lithium-Ion Batteries. ACS Appl. Mat. Interfaces 2017, 9, 9718-9725, and Xin, F.; Zhou, H.; Chen, X.; Zuba, M.; Chernova, N.; Zhou, G.; Whittingham, M. S. Li—Nb—O Coating/Substitution Enhances the Electrochemical Performance of the LiNi_{0.8}Mn_{0.1}Co_{0.1}O₂ (NMC 811) Cathode. ACS Appl. Mat. Interfaces 2019, 11, 34889-34894). Cation substitution like Al³⁺,¹³ Zr⁴⁺,¹⁴ Nb⁵⁺,¹⁵⁻¹⁶ Mg²⁺,¹⁷ W⁶⁺,¹⁶ is applied to the bulk for improving the conductivity and stability of the lattice, thereby enhancing capacity retention on extended cycling.

Nb oxide coatings can react with surface Li-residuals on high-Ni NMC (LiNi_{0.8}Co_{0.1}Mn_{0.1}O₂; 811), with the processes strongly dependent on sintering temperature. At low temperatures, LiₓNbO_{y} phases, such as LiNbO₃/Li₃NbO₄ were formed at particle surface and are beneficial to performance by reducing the 1st-cycle capacity loss; at further elevated temperatures Nb element was found to penetrate deeply into the bulk, leading to improved cycling performance. (See e.g., Xin, F.; Zhou, H.; Zong, Y.; Zuba, M.; Chen, Y.; Chernova, N. A.; Bai, J.; Pei, B.; Goel, A.; Rana, J. What is the Role of Nb in Nickel-Rich Layered Oxide Cathodes for Lithium-Ion Batteries? ACS Energy Lett. 2021, 6, 1377-1382). It is interesting to understand how the interaction between the Nb coating and the parent NMC811 particles occurs and how the Nb distribution and chemical states are impacted by the sintering conditions (i.e., temperature/duration), giving rise to different structural/electrochemical properties of NMC811.

In situ X-ray diffraction (XRD) has been proven powerful for real-time tracking of the reaction and processes during material synthesis/processing, through probing the structural evolution of the involved intermediates. (See e.g., Bai, J.; Hong, J.; Chen, H.; Graetz, J.; Wang, F. Solvothermal Synthesis of LiMn₁₋ₓFeₓPO₄ Cathode Materials: A Study of Reaction Mechanisms by Time-Resolved in Situ Synchrotron X-ray Diffraction. J. Phys. Chem. C 2015, 119, 2266-2276, and Wang, D.; Kou, R.; Ren, Y.; Sun, C. J.; Zhao, H.; Zhang, M. J.; Li, Y.; Huq, A.; Ko, J. P.; Pan, F. Synthetic control of kinetic reaction pathway and cationic ordering in high-Ni layered oxide cathodes. Adv. Mater. 2017, 29, 1606715).

However, when small concentration of the coated materials is present, only 0.7% in Example I, it is technically challenging to identify their re-distribution during the sintering process. Here, high flux and high energy synchrotron X-ray is used for the in situ XRD studies, on a NMC811 system intentionally coated with high concentration of Nb (1.4%) to improve the detectability of Nb distribution. (See e.g., Zhang, M. J.; Hu, X.; Li, M.; Duan, Y.; Yang, L.; Yin, C.; Ge, M.; Xiao, X.; Lee, W. K.; Ko, J. Y. P. Cooling Induced Surface Reconstruction during Synthesis of High-Ni Layered Oxides. Adv. Energy Mater. 2019, 9, 1901915). Through quantitative analysis of the chemical and structural evolution, the concurrent conditioning of the surface and bulk of NMC811 are revealed, arising from the interplay between the thermo-driven transformation of the Nb-containing phases at the particle surface and the Nb/TM inter-diffusion in the bulk.

### Structural Evolution of the Nb-Coating Layer

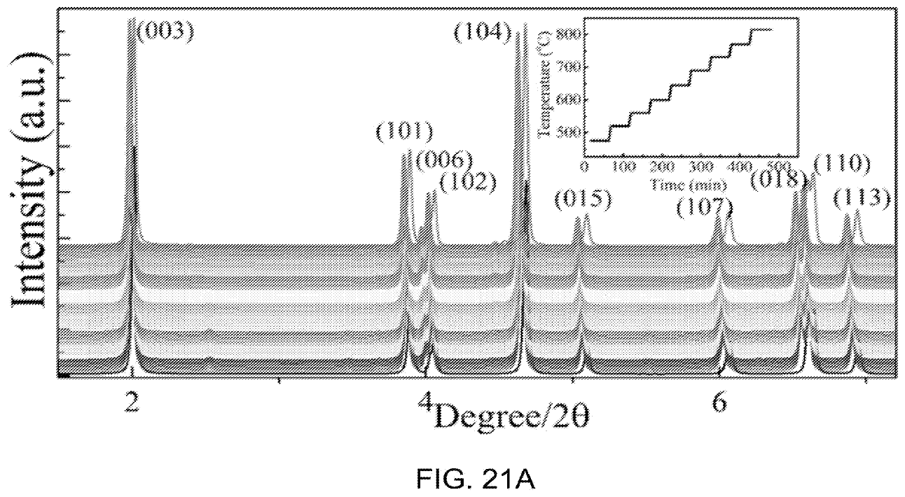

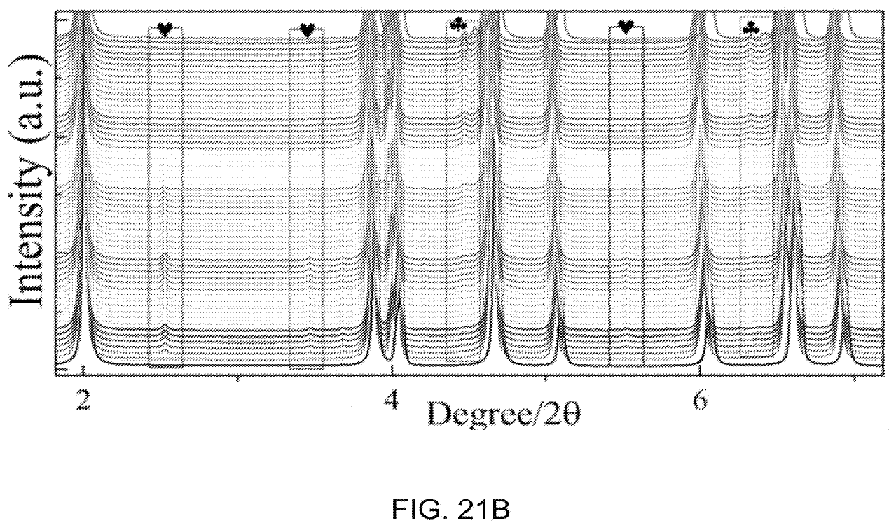

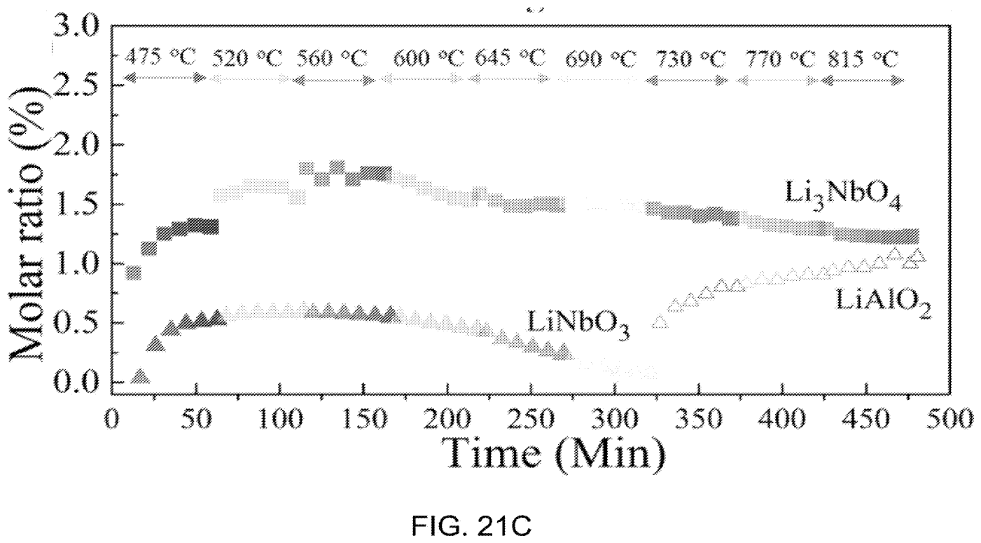

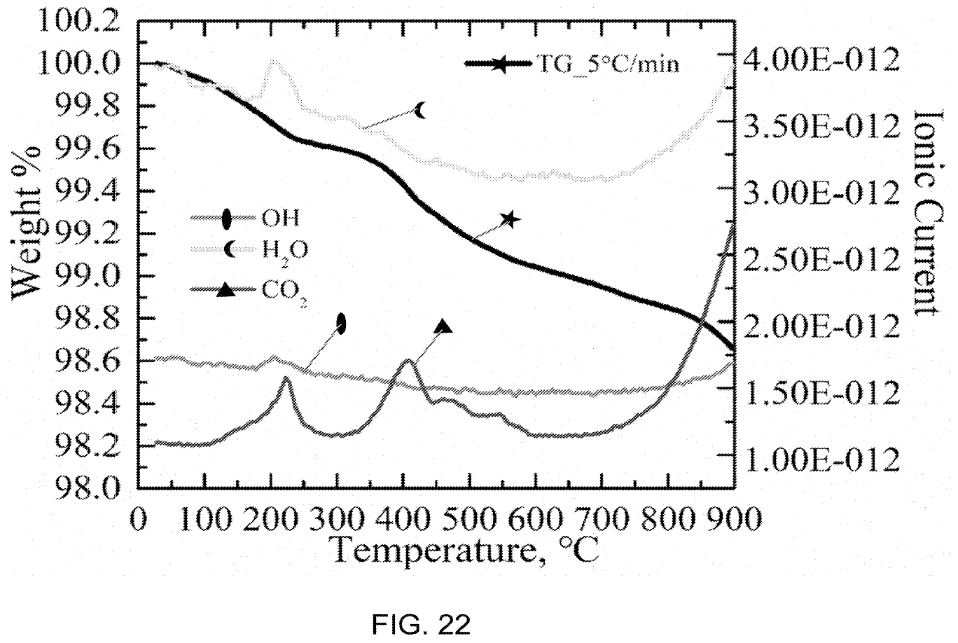

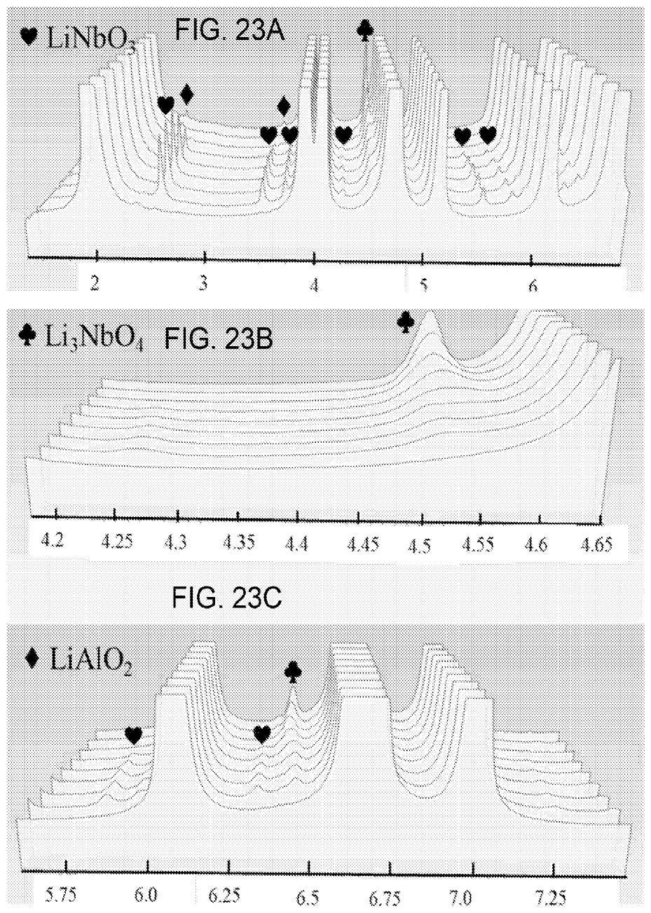

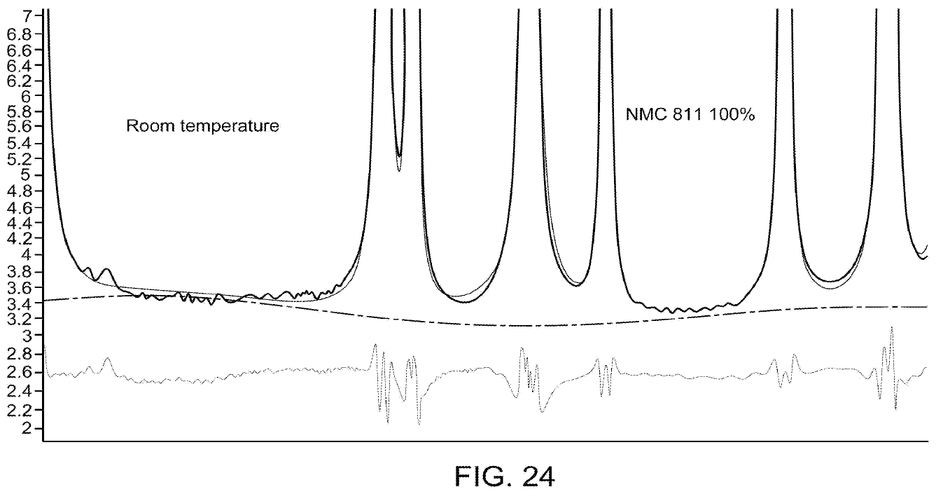

The reaction in the 1.4% Nb coated NMC 811 was tracked in real time by time and temperature-resolved in situ synchrotron XRD, with 50-min hold at each of the destination temperatures during the heating process. XRD patterns were recorded during heating from room temperature to 475° C., 520° C., 560° C., 600° C., 645° C., 690° C., 730° C., 770° C., 815° C. and final cooling down, as presented in FIG. 21A. Structural evolution of all the involved phases is revealed, both in the bulk of the layered NMC 811 and those Nb-containing minor phases, LiNbO₃ and Li₃NbO₄. Those Nb compounds most possibly came from the reaction of the coating with surface Li residual, according to TGA-MS (ee e.g., FIG. 22) and our previous results in Example 1. Sharp peaks associated with LiNbO₃ were observed quickly at low temperatures, with the amount reaching maximum at around 520° C. (FIG. 21B), and by ˜690° C. LiNbO₃ decomposed quickly (See e.g., FIG. 21B and FIGS. 23A-23C). The peaks associated with Li₃NbO₄ were initially broad and barely observable at low temperatures, and then became stronger and sharper, indicating enhanced crystallinity.

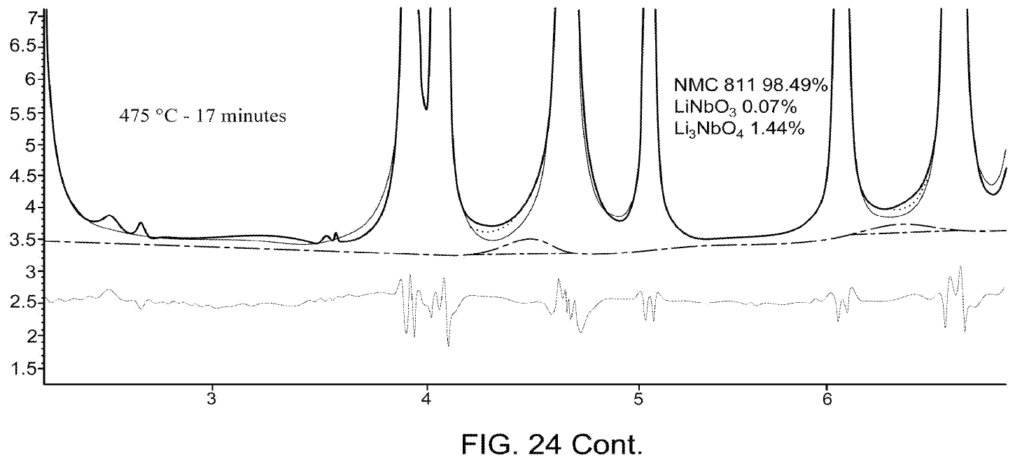

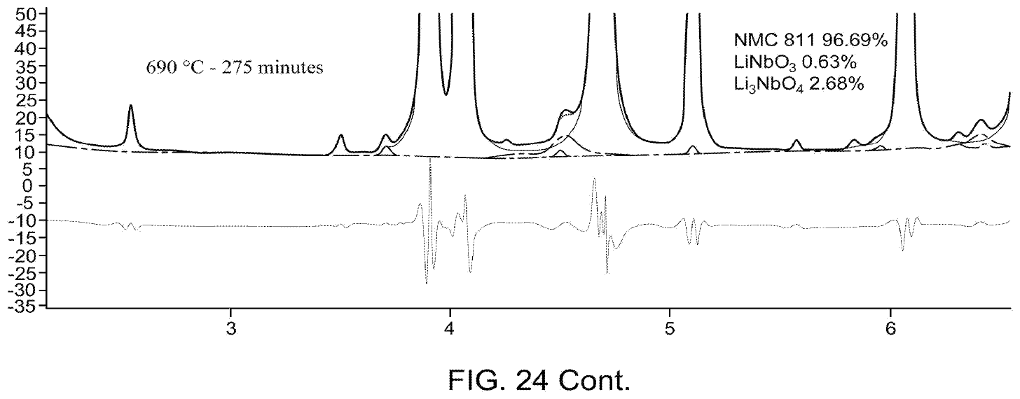

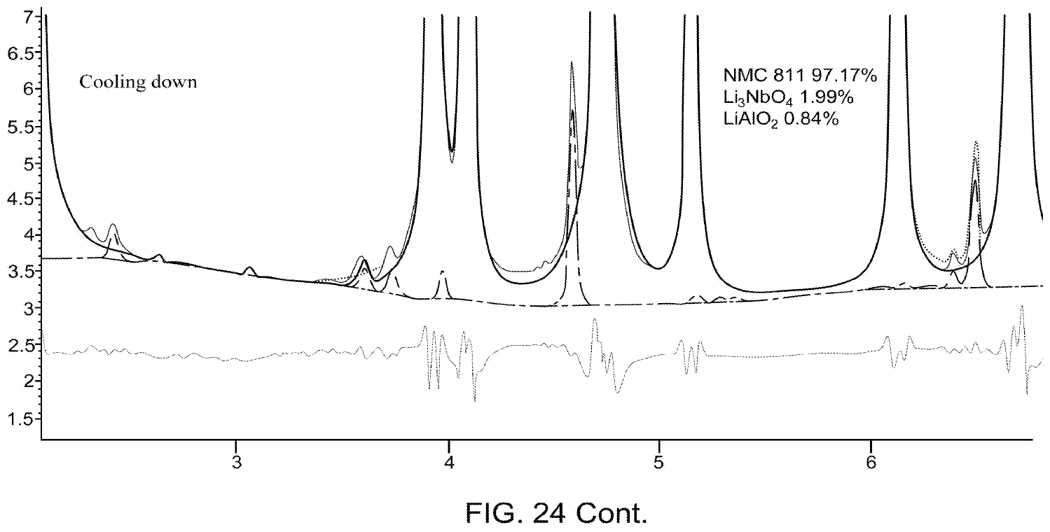

Further quantitative analysis is performed on the evolution of Nb-containing phases, with the main results presented in FIG. 21C (See details on the fitting process in FIG. 24). It is interesting that the phase concentration of Li₃NbO₄ was actually higher than LiNbO₃, and did not change much during the heating. While the concentration of LiNbO₃ dropped with temperatures, fastest at around 645° C., and reached zero by 690° C.

### Structural Evolution of the Parent NMC811

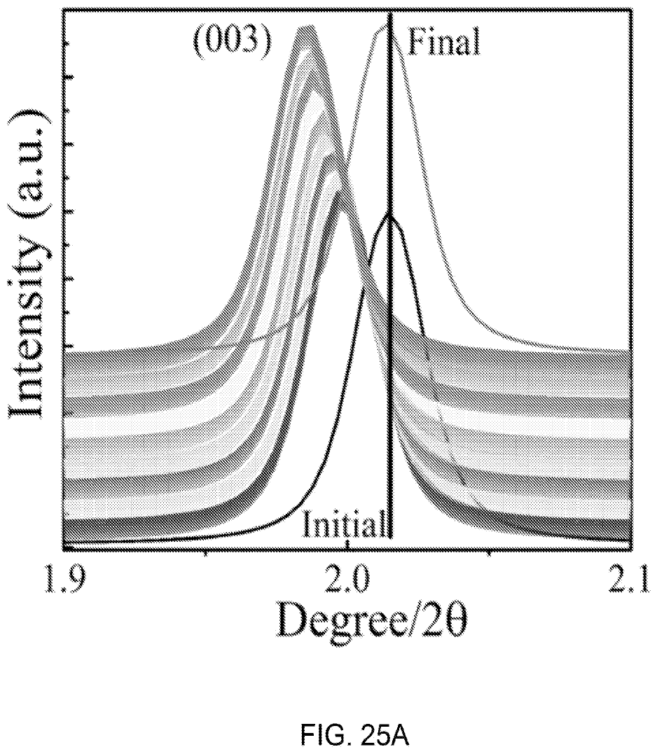

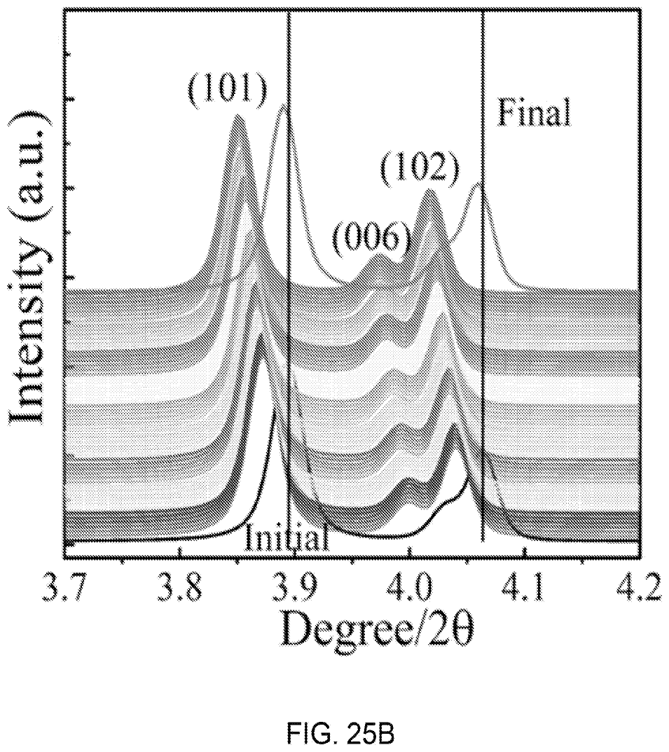

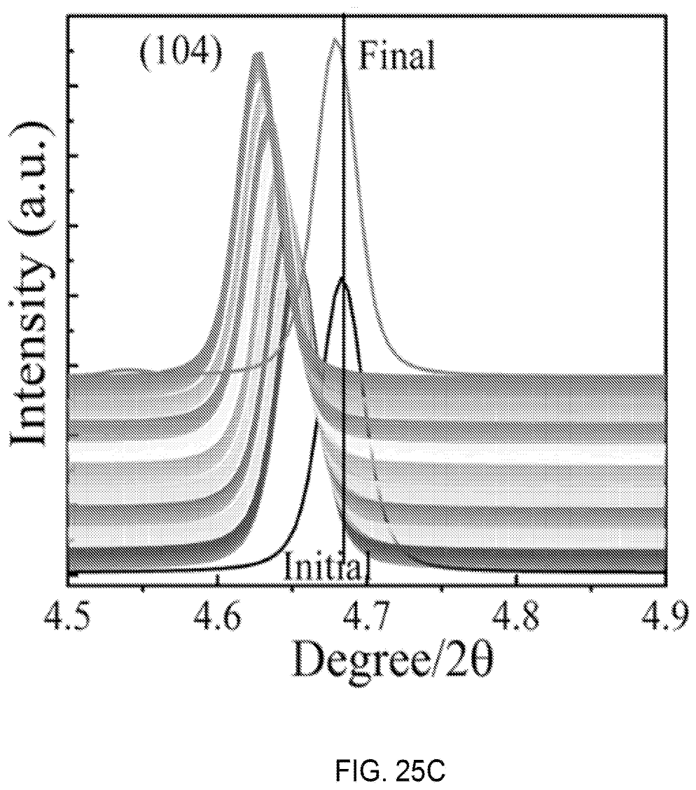

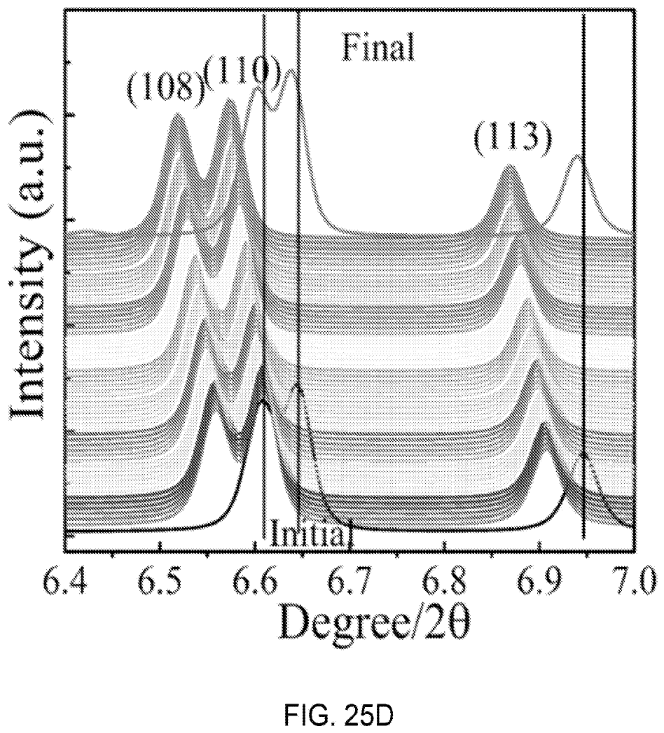

In contrast to significant change of the surface coating layer induced by heating, the change in the bulk is hardly observable from the XRD patterns (as given in FIGS. 21A and 21B). With the zoom-in view of the characteristic peaks as given in FIGS. 25A-D, blue shift becomes more obvious. It should be noted that thermal-driven lattice expansion is dominant, leading to the blue shift of the peaks. Upon cooling down to room temperature, all the peaks shifted mostly back. However, subtle change can still be observed in the patterns taken at the initial and final states, both at room temperature (without temperature effect), and is ascribed to Nb substitution effect (as illustrated by the vertical straight line). For example, the (003) peak shifted to the left (see e.g., FIG. 25A). Similar changes were also found in other peaks (101, 102, 104, 110, . . . ; See e.g., FIGS. 25B-25D), indicating lattice expansion both in a and c (Table 6) as a result of Nb diffusion into the bulk structure (and substitution of TMs).

TABLE 6
Refined lattice parameters for the initial and final states
(Before heating and cooling down to room temperature)

| T, ° C. | a, Å | c, Å | V, Å³ | Rwp, % |
|---|---|---|---|---|
| Initial (Room temperature) | 2.874 (1) | 14.20 (1) | 101.66 (1) | 4.1 |
| Final (Cooling down) | 2.877 (1) | 14.22 (1) | 101.92 (1) | 4.0 |

### Kinetics of Structural Change in the Bulk

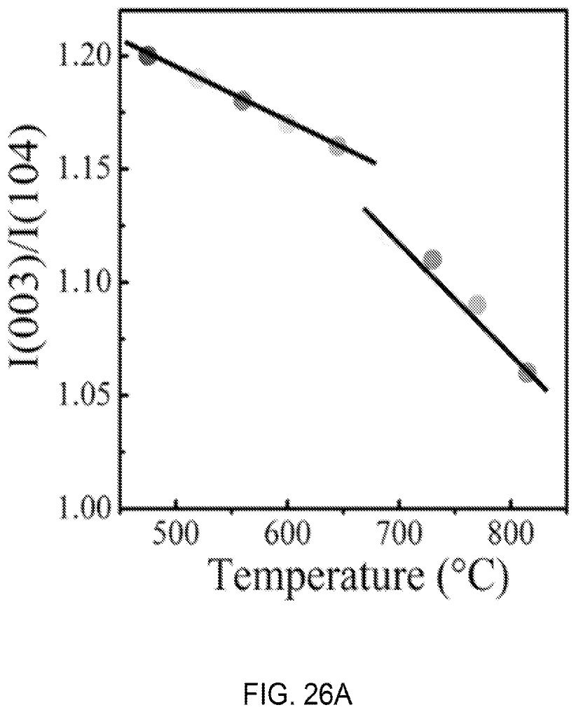

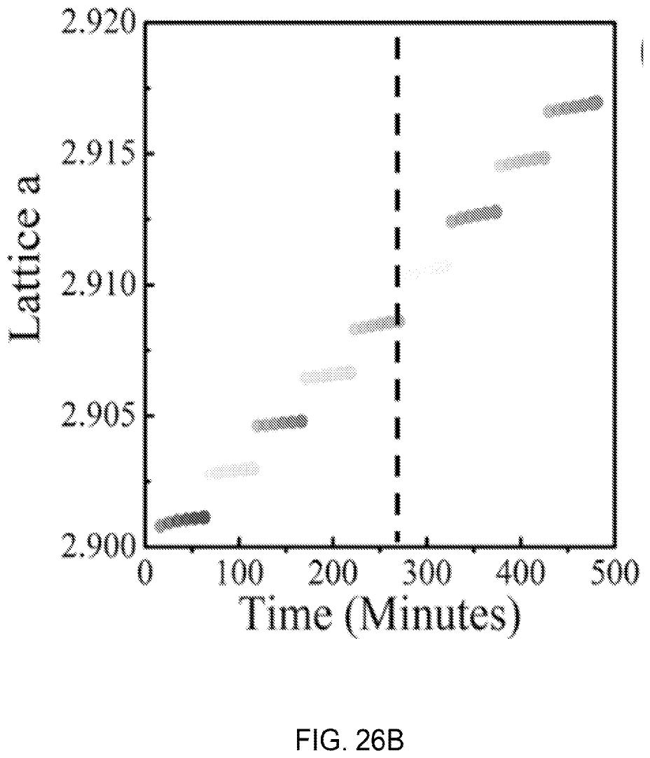

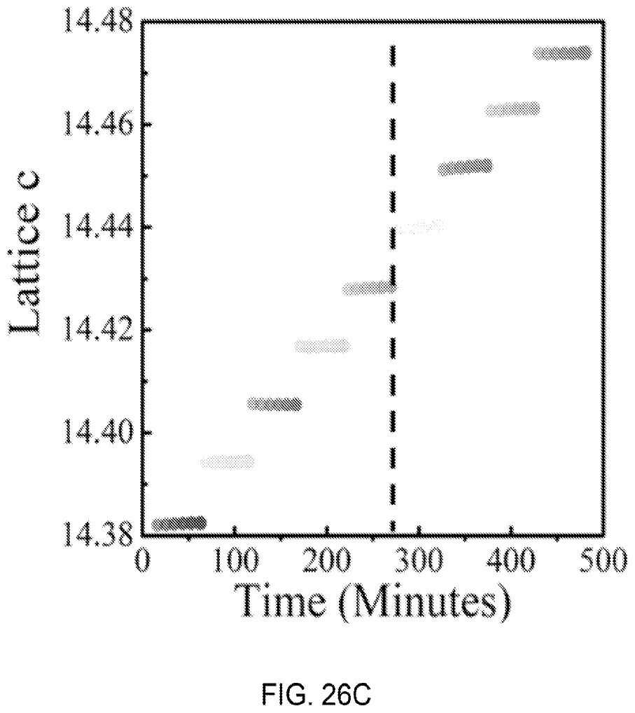

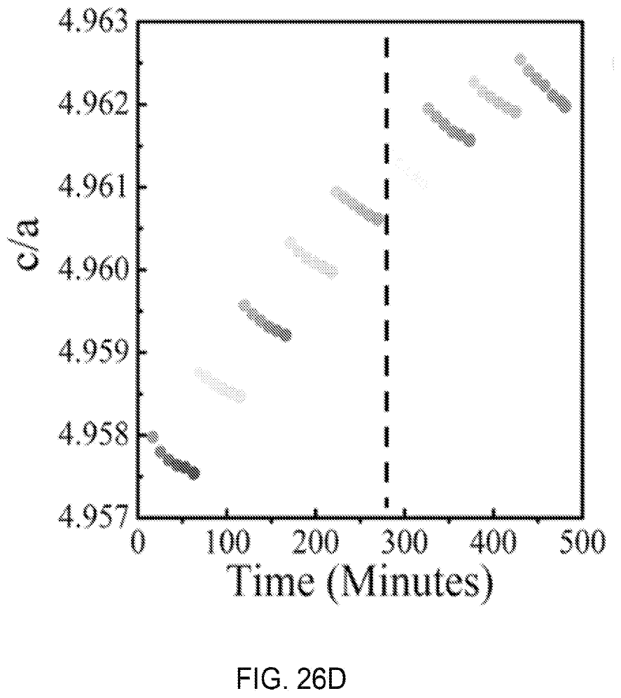

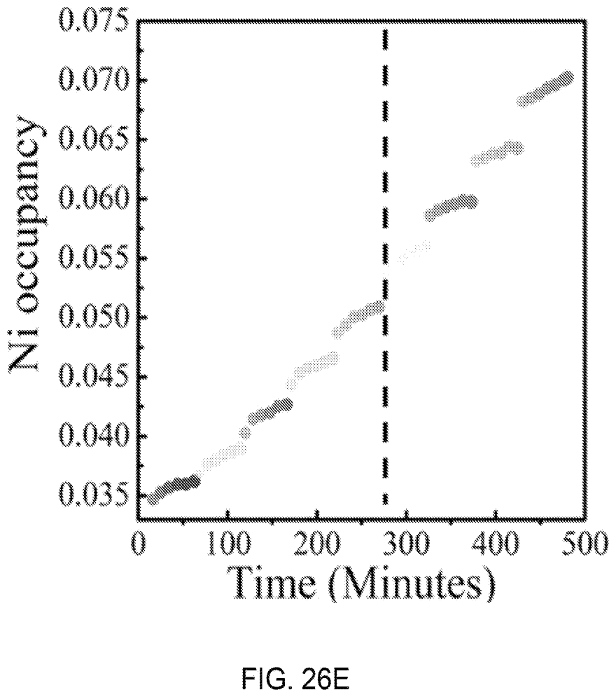

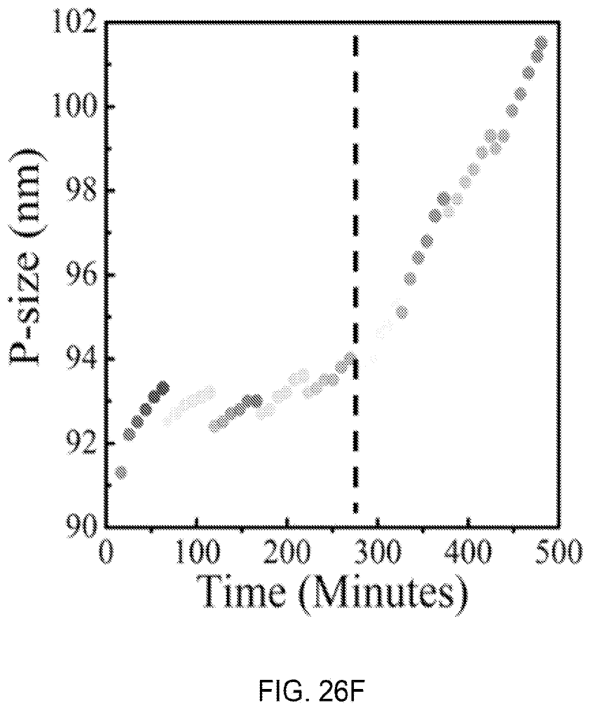

Nb substitution into the TM sites consequently caused cationic disordering, evidenced by the reduced peak intensity ratio, I(003)/I(104) in FIG. 26A. This can be explained by charge compensation since the valence for Nb is 5+, then other element should be reduced. Most possibly, some Ni³⁺ was reduced to Ni²⁺ and subsequently migrated to Li sites. There is a sudden drop of the intensity ratio, I(003)/I(104) by 690° C., followed by the faster-paced decrease compared to that at low temperatures (illustrated by the slops of the linear fitting curves).

More specifically, FIGS. 26A-F depict quantitative analysis of the kinetics of structural change in the Bulk. FIG. 26A depicts intensity ratio of the characteristic peaks, I(003)/I(104); FIGS. 26(B-D) depict evolution of the lattice parameters a, c and their ratio c/a during holding (for ˜50 minutes) at destination temperatures (475, 520, 560, 600, 645, 690, 730, 770, 815° C.); FIG. 26e Ni occupancy on Li site; FIG. 26F depicts Particle size (P-size).

Rietveld refinements were made to the XRD patterns taken during holding at each of the destination temperatures (475, 520, 560, 600, 645, 690, 730, 770, 815° C.), to obtain the changes in the lattice, cationic ordering and particle size, with the main results provided in FIGS. 26B-26F. The lattice parameter a increased throughout the heating process, with a much larger amplitude at temperatures above 690° C. (corresponding to ˜260 min; See e.g., FIG. 26B), the same with c (See FIG. 26C). Due to relatively larger changes in a, the ratio c/a decreased during holding (FIG. 26D). The faster change of a and c at temperatures above 690° C. appears to be correlated with the cationic disordering, as indicated by the sudden drop of the intensity ratio I(003)/I(104) at the same temperature range (FIG. 26A) as well as the rapid increase of the Ni occupancy on Li site (FIG. 26E). It should be noted that big change both in the ratio I(003)/I(104) and Ni occupancy on Li site occurred at 815° C. is mostly due to the structural degradation, associated with Li/O loss at such a high temperature. Besides structural change, fast particle growth was observed as temperature increased beyond 690° C. (FIG. 26F). As the particle growth involves the migration of the TM ions from the bulk to the surface (See e.g., Hua, W.; Wang, K.; Knapp, M.; Schwarz, B. r.; Wang, S.; Liu, H.; Lai, J.; Miller, M.; Schökel, A.; Missyul, A. Chemical and Structural Evolution during the Synthesis of Layered Li (Ni, Co, Mn) O₂ Oxides. Chem. Mater. 2020, 32, 4984-4997, and Wang, S.; Hua, W.; Missyul, A.; Darma, M. S. D.; Tayal, A.; Indris, S.; Ehrenberg, H.; Liu, L.; Knapp, M. Kinetic Control of Long-Range Cationic Ordering in the Synthesis of Layered Ni-Rich Oxides. Adv. Funct. Mater. 2021, 31, 2009949) in an opposite way of Nb diffusion, the thermo-driven Mn/Nb inter-diffusion may have facilitated the Nb penetration into the bulk.

Interplay between the Processes at Particle Surface and in the Bulk

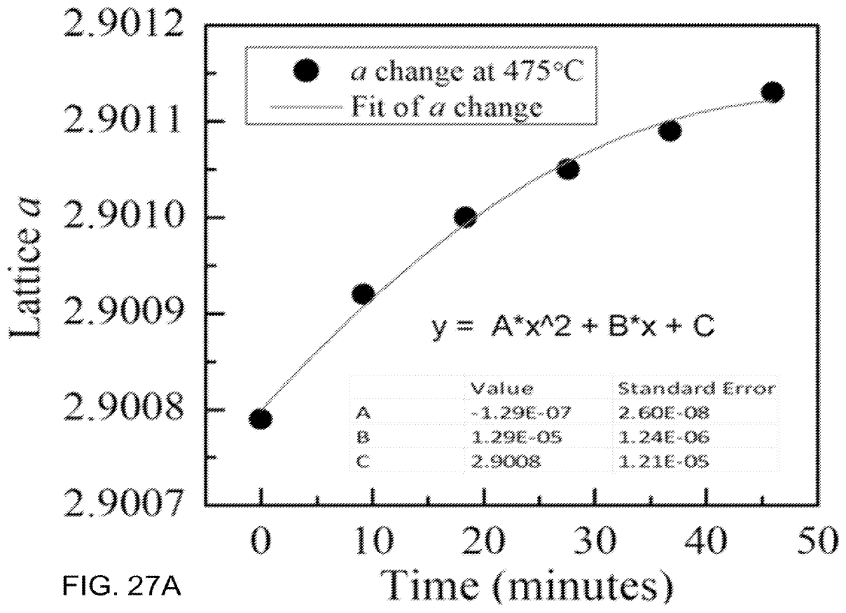

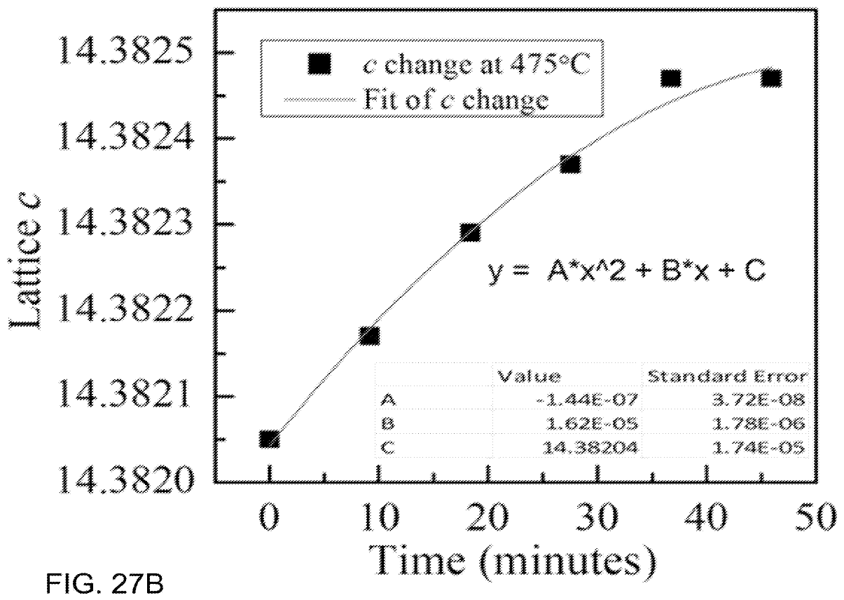

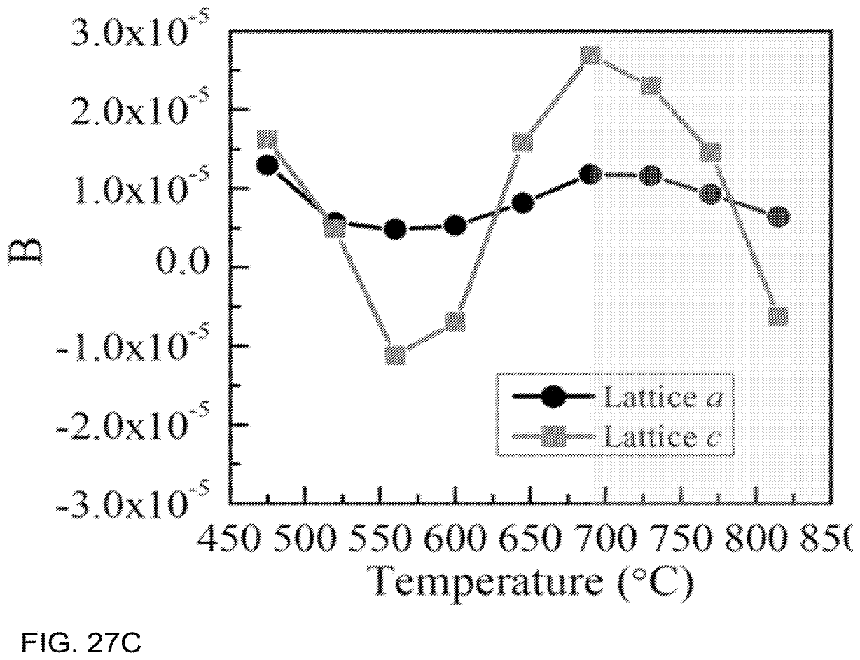

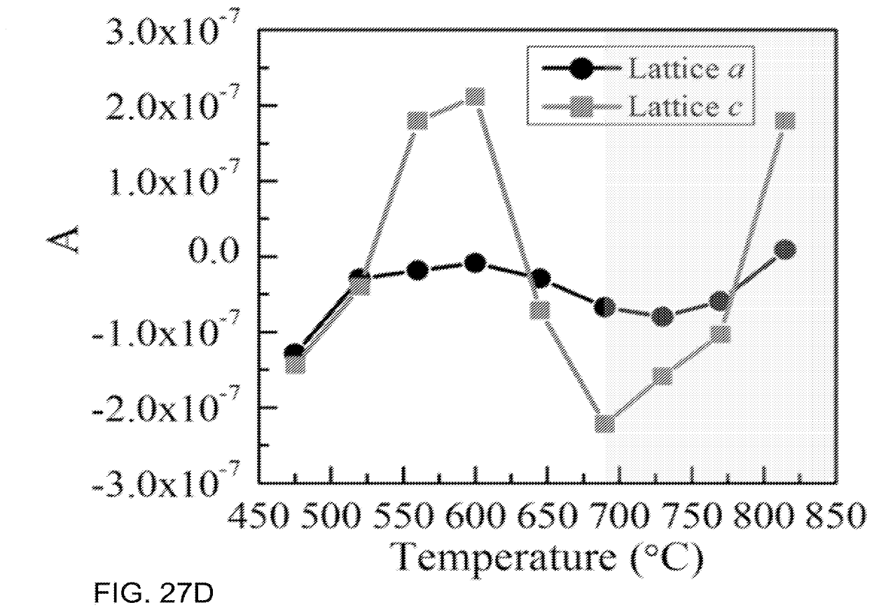

For better understanding the kinetics of the structural change and the associated Nb substitution, non-linear fitting, using y=Ax²+Bx+C, was made to the lattice changes during holding at each of the destination temperatures, as exampled in FIGS. 27A and 27B. Clearly, a and c behave differently, which is better shown by the extracted A, B values for the different temperatures as given in FIGS. 27C and 27D. Overall, the change in A, B for lattice a is less pronounced compared to that for lattice c although the change in a is larger than c, causing the decreasing c/a with holding (FIG. 26D). And interestingly, the B values, representing the rate of changes in lattice parameters a and c, reached maximum at 690° C. in both cases, suggesting the highest diffusivity of Nb at the temperature. Further studies are needed for better understanding the behaviors of a and c and its correlation to local cationic migration/ordering, but phenomenologically, the thermo-driven TM/Nb inter-diffusion may have played an important role. On the other hand, the Nb diffusivity itself is also affected by the concentration gradient and so the availability of Nb ions at particle surface. Because of the fast decomposition of LiNbO₃ at temperature above 690° C., without quick transformation into Li₃NbO₄, Nb should be made more available at the surface region, which may also explain the accelerated Nb penetration and, consequently, the fast change in the lattices a and c (shown the peak value of B at around 690° C.). As the temperature further increased, the B value gradually decreased, with the reduction of the Nb source.

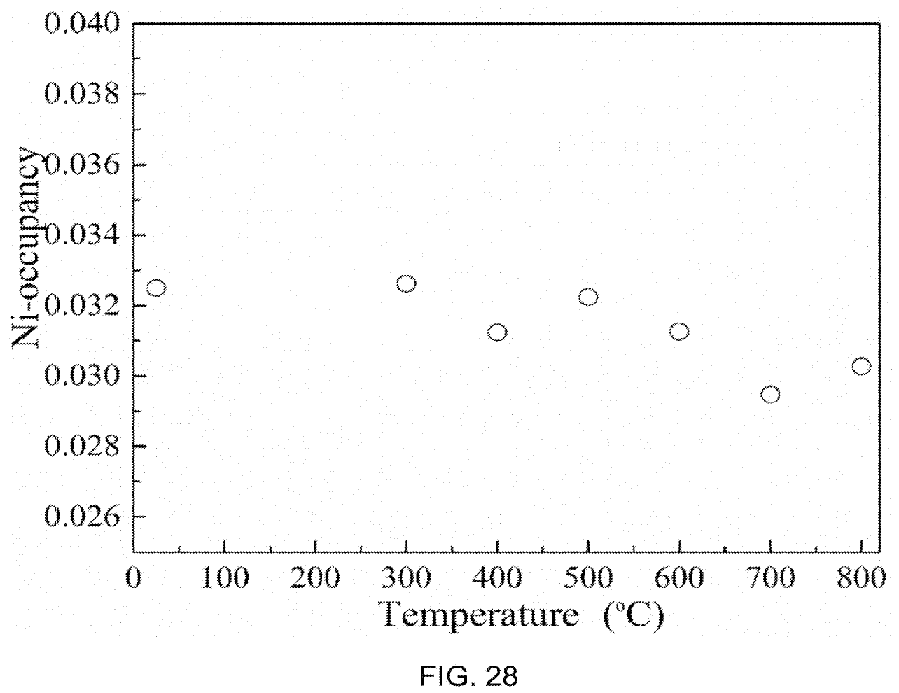

Besides the Nb substitution, the structural change in NMC811 may also be induced by heat treatment itself. Our previous studies showed that the lattice parameters a, c and V were almost constant with increasing temperature, combined with overall constant Ni occupancy in NMC811 (See e.g. FIG. 28, with small fluctuation) (See e.g., Xin, F.; Zhou, H.; Zong, Y.; Zuba, M.; Chen, Y.; Chernova, N. A.; Bai, J.; Pei, B.; Goel, A.; Rana, J. What is the Role of Nb in Nickel-Rich Layered Oxide Cathodes for Lithium-Ion Batteries? ACS Energy Lett. 2021, 6, 1377-1382), indicating that the structural change mainly comes from Nb modification.

In summary, the thermo-driven reactions and processes occurred in Nb-coated NMC811 were investigated to elucidate the role of Nb coating in conditioning the surface and bulk of the parent NMC811 particles. Through in situ synchrotron XRD measurements coupled with quantitative structure analysis, the kinetic processes during the heat treatment was revealed, involving initial formation of LiNbO₃/Li₃NbO₄ phase and their dynamic evolution with temperature, accompanied by structural change in the bulk. As high temperature (above 690° C.), the fast decomposition of LiNbO₃ and thermo-driven Nb/TM inter-diffusion accelerated Nb penetration into the bulk and, consequently, the rapid lattice expansion, cationic disordering (i.e., Li⁺/Ni²⁺ mixing), along with fast particle growth. Those observations, only becoming accessible by in situ observation, provide important insights into the kinetic processes governing structural/chemical changes, occurred concomitantly in the bulk and surface of the NMC811 particles. The findings facilitate optimization of the coating and heating processes in tuning the structural and electrochemical properties of high-Ni cathode materials.

### Experimental Section

Sample Preparation. NMC811 materials and niobium ethoxide were purchased from the Ecopro Company and Sigma Aldrich, separately. For the preparation process, NMC 811 was mixed with niobium ethoxide solution in a flask and stirred overnight. Typically, 2 g NMC 811 was added into 4 mL niobium ethoxide solution (0.096 g niobium ethoxide was dissolved in 4 mL ethanol). After stirring overnight, the ethanol was evaporated at 80° C. to get Nb-coated NMC811.

In situ Synchrotron Characterization. The in situ synchrotron XRD experiments were performed at sector 28-ID-1 of the National Synchrotron Light Source II (NSLS-II) at Brookhaven National Laboratory. The wavelength of the X-ray was 0.16625 Å. The produced ultrahigh flux allows us to track the fast reaction kinetics and detection of the minor phases, besides the main crystalline phases. For in situ experiments, the material was pressed into a pellet (1 mm thick and 7 mm in diameter), then loaded into in a furnace (Linkam TS 1500) vertically, with a window perpendicular to the X-ray beam. A 2D X-ray detector was applied to collect the XRD patterns from the pellet during heating in the air. At each of the destination temperatures, the sample was held at constant temperature for about 60 minutes. Here we need to mention that the use of air is likely to increase Ni/Li disordering but does not influence the kinetics process. Quantitative structural analysis was made by Rietveld refinement of individual ex situ and in situ synchrotron XRD patterns, using the same structure models from neutron diffraction analysis. (See e.g., Xin, F.; Zhou, H.; Zong, Y.; Zuba, M.; Chen, Y.; Chernova, N. A.; Bai, J.; Pei, B.; Goel, A.; Rana, J. What is the Role of Nb in Nickel-Rich Layered Oxide Cathodes for Lithium-Ion Batteries? ACS Energy Lett. 2021, 6, 1377-1382) (This reference is entirely incorporated by reference herein, including Supporting information, and all color Figures).

The entire disclosure of all applications, patents, and publications cited herein are herein incorporated by reference in their entirety. While the foregoing is directed to embodiments of the present disclosure, other and further embodiments of the disclosure may be devised without departing from the basic scope thereof.

What is claimed is:

1. A process for making lithium-transition metal oxide compounds, comprising:
forming a slurry by mixing a niobium compound comprising one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and
removing the solvent from the slurry to form a modified lithium nickel manganese cobalt composition including niobium or a modified lithium nickel cobalt aluminum composition including niobium.

2. The process of claim 1, wherein the niobium compound is substantially free or devoid of lithium.

3. The process of claim 1, wherein the lithium nickel manganese cobalt oxide cathode powder is characterized as LiNiₓCo_{y}Mn_{1-x-y}O₂, wherein x is 0.8-1, y is 0-0.2, and 1-x-y is 0-0.2.

4. The process of claim 1, wherein the lithium nickel cobalt aluminum oxide cathode powder is characterized as LiNiₓCo_{y}Al_{1-x-y}O₂, wherein x is 0.8-1, y is 0-0.2, and 1-x-y is 0-0.2.

5. The process of claim 1, wherein the modified lithium nickel manganese cobalt composition including niobium or a modified lithium nickel cobalt aluminum composition including niobium each comprise 0-5 wt. % niobium, or 0.001-5 wt. % niobium.

6. The process of claim 1, wherein the modified lithium nickel manganese cobalt composition including niobium is characterized by a first formula LiNiₓCo_{y}Mn_{z}Nb_{w}O₂, wherein (x+y+z+w=1), and wherein x is 0.8-1.0, y is 0-0.2, z is −0.2, and w is 0-0.2, or a second formula Li_{w}Nb_{1-w}NiₓCo_{y}Mn_{1-x-y}O₂, wherein x is 0.8-1, y is 0-0.2, w is 0-0.2, and 1-x-y is 0-0.2.

7. (canceled)

8. The process of claim 1, wherein the solvent is one or more of methanol, ethanol, ethylene glycol, or tetraethylene glycol ethanol.

9. The process of claim 1, wherein the modified lithium nickel manganese cobalt composition including niobium or modified lithium nickel cobalt aluminum composition including niobium comprise niobium in a molar ratio of 0.7% to 1.4%.

10. The process of claim 1, further comprising sintering the modified lithium nickel manganese cobalt composition including niobium or modified lithium nickel cobalt aluminum composition including niobium in an atmosphere comprising oxygen at a temperature of at least 400 degrees Celsius, at least 500 degrees Celsius, at least 600 degrees Celsius, at least 700 degrees Celsius, at least 800 degrees Celsius, a temperature between 400 degrees Celsius and 800 degrees Celsius, a temperature between 400 degrees Celsius and 500 degrees Celsius, a temperature between 500 degrees Celsius and 600 degrees Celsius, a temperature between 600 degrees Celsius and 700 degrees Celsius, or a temperature between 700 degrees Celsius and 800 degrees Celsius.

11-46. (canceled)

47. A cathode comprising:
a niobium coated and/or substituted lithium nickel manganese cobalt composition or a niobium coated and/or substituted lithium nickel cobalt aluminum composition, wherein niobium is present in a molar ratio of 0.01% to 5.0%.

48. The cathode of claim 47, wherein the cathode is formed of lithium-ion cathode material formed by a process sequence comprising: mixing a niobium compound comprising one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and
removing the solvent to form a coated composition comprising a niobium containing coating disposed upon the lithium nickel manganese cobalt composition or the lithium nickel cobalt aluminum composition.

49. The cathode of claim 48, wherein the niobium compound is characterized as substantially lithium free or devoid of lithium.

50. An electrochemical cell, comprising: a cathode of any-ee claim 47.

51. A method of altering a high-Ni NMC material high-Ni NCA material, comprising:
providing a high-Ni NMC substrate or high-Ni NCA substrate, wherein the high-Ni NMC substrate or high-Ni NCA substrate comprises one or more lithium residuals exposed on a top surface, and coating the top surface with niobium oxide in an amount sufficient to contact the niobium oxide and the one or more lithium residuals.

52. The method of claim 51, wherein coating further comprises:
mixing a niobium compound comprising one or more of niobium ethoxide, niobium pentoxide, niobium dioxide, niobium monoxide, niobium chloride, niobium fluoride, ammonium niobium oxalate hydrate, or niobium oxalate, a lithium nickel manganese cobalt oxide cathode powder or a lithium nickel cobalt aluminum oxide cathode powder, and a solvent; and
removing the solvent to form a coated high-Ni NMC substrate or coated high-Ni NCA substrate.

53. The method of claim 52, wherein the niobium compound is characterized as substantially free of lithium.

54. The method of claim 52, further comprising sintering at a low temperature for a duration sufficient to form LiₓNbO_{y} phases at the top surface.

55. The method of claim 54, wherein the low temperature is 300 to 600 degrees Celsius.

56. The method of claim 52, wherein the high-NMC material is a cathode, and wherein LiₓNbO_{y} phases at the top surface reduces 1^{st}-cycle capacity loss.

57. The method of claim 52, further comprising sintering at a high temperature for a duration sufficient to penetrate an Nb⁵⁺ species into the substrate to provide improved cycling performance.

58. The method of claim 57, wherein the high temperature is 600 to 750 degrees Celsius.

59-66. (canceled)
